(19) United States
(12) Patent Application Publication
(10) Pub. No.: US 2026/0255145 A1
(43) Pub. Date: Aug. 27, 2026

(54) A METHOD FOR OPERATING A CELLULAR NETWORK

(71) Applicant: KONINKLIJKE PHILIPS N.V., EINDHOVEN (NL)

(72) Inventors: Oscar Garcia Morchon, Eindhoven (NL); Noureddine Sabah, Eindhoven (NL)

(21) Appl. No.: 19/105,050

(22) PCT Filed: Aug. 22, 2023
(86) PCT No.: PCT/EP2023/072972

§ 371 Date: Feb. 20, 2025

(30) Foreign Application Priority Data
Aug. 22, 2022 (EP) 22191358.5
Sep. 26, 2022 (EP) 22197820.8
Oct. 10, 2022 (EP) 22200566.2
Jan. 17, 2023 (EP) 23151921.6
Feb. 7, 2023 (EP) 23155238.1
Feb. 13, 2023 (EP) 23156350.3
Feb. 14, 2023 (EP) 23156620.9
Feb. 19, 2023 (EP) 23157431.0
Feb. 22, 2023 (EP) 23158064.8
Feb. 24, 2023 (EP) 23158374.1
Mar. 6, 2023 (EP) 23160121.2
Mar. 24, 2023 (EP) 23163937.8
Apr. 6, 2023 (EP) 23167130.6
Apr. 16, 2023 (EP) 23168150.3
Apr. 21, 2023 (EP) 23169126.2
May 11, 2023 (EP) 23172936.9
May 12, 2023 (EP) 23173187.8
May 15, 2023 (EP) 231373289.2
May 24, 2023 (EP) 23175183.5
Jun. 6, 2023 (EP) 23177579.2
Jul. 24, 2023 (EP) 23187217.7
Aug. 1, 2023 (EP) 23189055.9
Aug. 4, 2023 (EP) 23189688.7
Aug. 10, 2023 (EP) 23190736.1
Aug. 15, 2023 (EP) 23191447.4
Aug. 16, 2023 (EP) 23191589.3

(51) Int. Cl. H04W 8/00; H04W 12/037; H04W 12/0431; H04W 12/106; H04W 76/14; H04W 92/18

(52) U.S. Cl. CPC H04W 8/005; H04W 12/037; H04W 12/0431; H04W 12/106; H04W 76/14; H04W 92/18

(57) ABSTRACT

The invention relates to a method for operating a communication system including: receiving a second discovery protected message from a first device protected with a second set of keys, the second discovery protected message including a first discovery message end-to-end protected with a first set of keys according to a policy or configuration, unding the protection and verify the integrity and freshness of the received second discovery protected messages with a second set of keys, then extract the first protected discovery messages according to a policy or configuration, constructing a third discovery message including the first discovery protected message, protecting the third discovery message using a third set of keys into a third discovery protected message according to a policy or configuration, transmitting the third discovery protected message to a third device.

### FIELD OF THE INVENTION

The present invention relates to the field of wireless communications, and in particular to security aspects in the context of cellular networks, like the UMTS Long Term Evolution (LTE) or LTE Advanced (both included in 4G), New Radio (NR) (5G) or other cellular networks or mobile in communication networks.

### BACKGROUND OF THE INVENTION

In conventional cellular networks, a primary station serves a plurality of secondary stations located within a cell served by this primary station. Wireless communication from the primary station towards each secondary station is done on downlink channels. Conversely, wireless communication from each secondary towards the primary station is done on uplink channels. The wireless communication can include data traffic (sometimes referred to User Data), and control information (also referred sometimes as signalling). This control information typically comprises information to assist the primary station and/or the secondary station to exchange data traffic (e.g. resource allocation/requests, physical transmission parameters, information on the state of the respective stations).

In the context of cellular networks as standardized by 3GPP, the primary station is referred to a base station, or a gNodeB (or gNB) in 5G (NR) or an eNodeB (or eNB) in 4G (LTE). The eNB/gNB is part of the Radio Access Network RAN, which interfaces to functions in the Core Network (CN). In the same context, the secondary station corresponds to a mobile station, or a User Equipment (or a UE) in 4G/5G, which is a wireless client device or a specific role played by such device. The term “node” is also used to denote either a UE or a gNB/eNB.

Additionally, for example, in the case of PC5 interface or Sidelink communication, it is possible to have Direct communication between secondary stations, here UEs. It is then also possible for UEs to operate as Relays to allow for example out of coverage UEs to get an intermediate (or indirect) connection to the eNB or gNB. To be able to work as a relay, a UE may use discovery messages to establish new connections with other UEs.

Therefore, the role of a relay node as shown on FIG. 1 has been introduced in 3GPP. This relay node 120 is a wireless communication station 120 that includes functionalities for relaying communication between a primary station 100, e.g. a gNB and a secondary station 110, e.g. a UE. This relay function for example allows to extend the coverage of a cell 10 to an out-of-coverage (OoC) secondary station 110. This relay node 120 may be a mobile station or could be a different type of device. In the specifications for 4G, the Proximity Services (ProSe) functions are defined inter alia in TS23.303, and TS24.334 to enable-amongst others-connectivity for the cellular User Equipment (UE) 110 that is temporarily not in coverage of the cellular network base station (eNB) 100 serving the cell 10. This particular function is called ProSe UE-to-network relay, or Relay UE for short. The Relay UE 120 relays application and network traffic in two directions between the OoC UE 110 and the eNB 100. The local communication between the Relay UE 120 and the OoC UE 110 is called device-to-device (D2D) communication or Sidelink (also known as PC5) communication in TS23.303 and TS24.334. Once the relaying relation is established, the OoC-UE 110 is, e.g., IP-connected via the Relay UE 120 and acts in a role of “Remote UE” 110. This situation means the Remote UE has an indirect network connection to selected functions of the Core Network as opposed to a direct network connection to all Core Network functions that is the normal case.

Further, it has been introduced the role of a UE to UE relay node, i.e., a relay node relaying the communication between two UE devices. This is as illustrated in FIG. 3 where the relay node 310 relays the communications between UE devices 320 and 330. UEs 310, 320, 330 may connect to the core network through a base station 300 when in-coverage.

In general, it is challenging to determine how UEs communicating by means of a UE-to-Network relay or a UE-to-UE relay can perform the discovery of each other in a secure way or establish a secure communication.

### SUMMARY OF THE INVENTION

One aim of the present invention is to alleviate the above mentioned problems.

Another aim of the invention is to better protect discovery messages and the security establishment in relay scenarios when using integrated discovery or when handling integrity failures in the initial steps of the communication establishment. Still another aim of the invention is to better and more securely switch the path in UE-to-UE Relay use cases, i.e., improve how two UE devices can securely and privately switch the UE-to-UE Relay.

Still another aim of the invention is to propose a method of a secondary station for communicating in a network which requires minimal interaction with the Core Network once in operation.

It is proposed in accordance to various aspects of the invention some modifications of the security routines to make them work operationally and improve security/privacy protection and performance.

To this end, it is proposed in accordance with a first aspect of the invention, it is proposed a an apparatus for for secure relaying of discovery messages as claimed in claim 1.

In accordance with a second aspect of the invention, it is proposed a method for secure relaying of discovery messages as claimed in claim 17.

In accordance with a third aspect of the invention, it is proposed an apparatus for secure communication as claimed in claim 18 and the corresponding method for operating the apparatus as claimed in claim 54.

In accordance with a fourth aspect of the invention, it is proposed an apparatus for secure communication as claimed in claim 22 and the corresponding method for operating the apparatus as claimed in claim 53.

In accordance with a fifth aspect of the invention, it is proposed an apparatus to securely establish a PC5 or Sidelink communication as claimed in claim 27, and the corresponding method for operating the apparatus as claimed in claim 52.

In accordance with a sixth aspect of the invention, it is proposed an apparatus for secure communication as claimed in claim 37 and the corresponding method for operating the apparatus as claimed in claim 44.

In accordance with a seventh aspect of the invention, it is proposed an apparatus for secure and efficient communication as claimed in claim 46.

In accordance with an eighth aspect of the invention, it is proposed a method for secure communication as claimed in claim 50.

In accordance with a ninth aspect of the invention, it is proposed a computer program product comprising code means for producing the steps of the method of the first to eighth aspects of the invention when run on a computer device.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatuses and the methods may have similar, corresponding and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

It is noted that the above apparatuses may be implemented based on discrete hardware circuitry, integrated chips, or arrangements of chip modules, or based on signal processing devices or chips controlled by software routines or programs stored in memories, written on a computer readable media, or downloaded from a network, such as the Internet.

It shall be understood that the apparatus of claims 1 and 2, the communication device of claim 11, the methods of claims 13 and 14, the computer program product of claim 15, and the system of claim 16 may have similar and/or identical preferred embodiments, in particular, as defined in the dependent claims.

These and other aspects of the invention will be apparent from and elucidated with reference to the embodiments described hereinafter.

### BRIEF DESCRIPTION OF THE DRAWINGS

FIG. 1, already described, schematically represents a cellular system in which the invention is implemented;

FIG. 2 schematically describes a procedure for integrated discovery in UE-to-UE Relay communication.

FIG. 3 schematically describes a discovery process in a UE-to-UE Relay scenario;

FIG. 4 schematically describes a procedure for setting up the security of a PC5 communication link in a UE-to-UE Relay scenario;

FIG. 5 schematically represents another cellular system in which the invention is implemented;

FIG. 6 schematically represents further embodiments of the invention related to UE-to-UE integrated discovery;

FIGS. 7-9 schematically represent further embodiments of the invention related to UE-to-UE discovery;

FIG. 10 schematically describes procedures to set up a secure PC5 communication link with integrated discovery over UE-to-UE Relays;

FIG. 11 schematically describes procedures to set up a secure PC5 communication link with integrated discovery over a UE-to-UE Relay or directly with a source-UE;

FIG. 12 schematically describes Model A discovery using UE-to-UE Relay Announcement scheduling assistance to End UEs; and

FIG. 13 schematically describes Model A Discovery using UE-to-UE Relay using on-demand direct discovery set protection

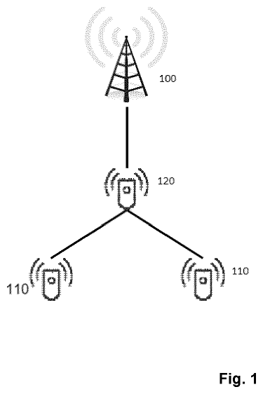

### DETAILED DESCRIPTION OF THE INVENTION

The various aspects of the invention will be elaborated in the following embodiments. As explained earlier, the embodiments of the invention can be related to various types of wireless communication, and in particular to the connection setup of devices trying to access a wireless network. A typical example is a cellular network, for example a 5G network, possibly including some relay nodes. These relay nodes may be implemented by UEs, such as Sidelink compatible Ues which can operate as relay nodes, or by other types of repeaters.

To allow a new connection through this kind of relay, a discovery phase is required where discovery messages may be sent to the relay UE or by the relay UE. One general aim of this particular exemplary embodiment is to increase the protection of such discovery messages. The Technical Specifications TS 33.303 v17.0.0 describe in Section 6.1.3.4.3 the protection of the discovery messages. It lists three types of security used to protect the restricted discovery messages detailed as follows:

Firstly, integrity protection is provided by appending a MIC (Message Identification Code) as in Open Discovery (see subclauses 6.1.3.3.1). The MIC is calculated in the sending UE using a received Discovery User Integrity Key (DUIK) and may either be checked at the receiving UE using the supplied DUIK or at the ProSe Function (Relay node) using the DUIK.

Secondly, scrambling protection, which ensures that there is no relationship between the discovery messages sent by a particular UE, i.e. to prevent tracking of a UE over time. A scrambling keystream is calculated from the Discovery User Scrambling Key (DUSK) and the UTC-based counter associated with the discovery slot (see 6.1.3.4.3.5 for more details on the calculation).

Finally, message-specific confidentiality, which provides confidentiality protection for part of the discovery message. This is used either when several UEs use the same DUSK or if it is desired to obfuscate part of the discovery message from some of the UEs that are allowed to discover the UE. A keystream is calculated from the Discovery User Confidentiality Key (DUCK), the content of the message and the UTC-based counter associated with the discovery slot (see 6.1.3.4.3.6 for more details on the calculation).

The security procedures that are applied at the sending and receiving UE are controlled by the ProSe Function by sending the Code-Sending Security Parameters and/or Code-Receiving Security Parameters to the appropriate UE (i.e. the UE shall support all of integrity protection, scrambling and message specific confidentiality). To achieve integrity protection for a ProSe restricted discovery message, either a DUSK or a DUIK needs to be provided. When a DUCK is used to apply message specific confidentiality, a DUIK is required for integrity protection as more than one message is being protected. Examples of combinations of Discovery User Keys according to use case type is provided in Annex G.

In this invention, the terms “security keying materials”, “keying materials”, “discovery security parameters” or “security keys/materials”, and “set of keys” are used interchangeably and may refer to the same set of keys (e.g., discovery keys) including DUIK, DUSK, DUCK.

At the receiving side, the scrambling protection must be undone before any matching can be attempted. Given that the operation of undoing message-specific confidentiality is computationally intense, the matching operation that precedes it should have a very minimal chance of a false positive. To this end, the ProSe Function should ensure the number of bits in a discovery message that can be matched after any scrambling has been undone is at least 16 (leading to a false positive chance of 1 in 65,536 or less).

The technical specification TS 33.503 describes further procedures to protect discovery messages where the discovery messages are featured by a long size. The discovery procedures are also specified in the context of UE to Network relays. The main differences compared with TS 33.303 refer to the usage of scrambling in the first up to 32 bytes, the confidentiality protection of the whole message and the usage of a MIC set to a random value when the message is not integrity protected.

Furthermore, TS 33.503 describes in Clause 6.3.5 a procedure for the protection of the direct communication request (DCR) message that is sent by a remote UE to the UE to Network relay whereby the protection mechanisms reuse the discovery keys. When the DUIK is configured, the DCR message is integrity protected. When the DUCK or DUSK are configured, the relay service code (RSC) and PRUK-ID are confidentiality protected.

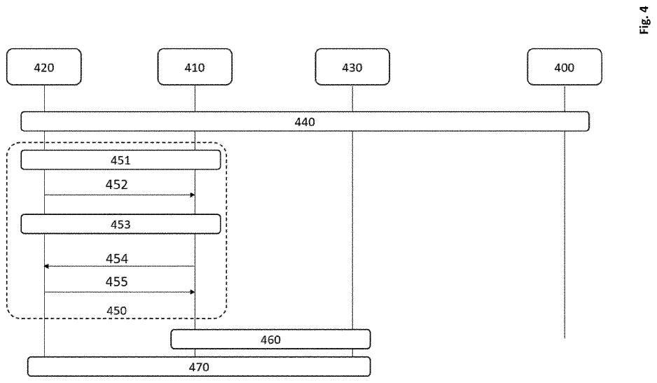

Similar techniques may apply to the establishment of a (secure) PC5 communication link in a UE-to-UE Relay scenario, upon discovery and with reference to FIG. 4 where a UE, e.g., the Source-UE may send a direct communication request (DCR) message including certain parameters, such as an RSC or the PRUK ID or a first nonce used for a subsequent key derivation. This information might be exchanged in the clear unless a procedure as in Clause 6.3.5 in TS 33.503 is applied. This procedure and need is further illustrated by means of a Source-UE 420 that wants to establish a secure communication link with a Target-UE 430 over a UE-to-UE Relay 410. The CN or one or more network functions in the CN 400 perform configuration. In a first Step, the Remote UEs (Source and Target-UEs) and the UE-to-UE Relay get the discovery parameters and Prose Key management function (PKMF) address from the 5G DDNMF and the discovery security material from the PKMF respectively. Furthermore, the Remote UEs can be provisioned with the security materials for end-to-end security setup by the PKMF. For example, the security materials for end-to-end security setup include the Prose Service Code (PSC) and associated key. In a subsequent step, the remote UE 420 performs the discovery procedure and PC5 unicast link setup procedure with the UE-to-UE Relay 410 by (i) discovering a UE-to-UE Relay; (ii) sending a Direct Communication Request that includes Relay Service Code (RSC), PRUK ID, and Nonce1; (iii) performing authentication and key agreement between the remote UE 420 and UE-2-UE relay 410 and as result of successful authentication, a key KNRP is derived. Later, the UE-2-UE relay 410 generates Nonce2 and derives KNRP-SESS using KNRP, Nonce1 and Nonce2. The UE-2-UE relay 410 sends a Direct Security Mode Command that contains Nonce 2 to the Remote UE 420. The Direct Security Mode Command is integrity protected based on KNRP-SESS. Then, the Remote UE 410 derives KNRP-SESS using KNRP, Nonce1 and Nonce2 and checks the integrity of the Direct Security Mode Command. If the verification is successful, the Remote UE 420 sends a Direct Security Mode Complete to the UE-2-UE relay 410. To protect certain privacy sensitive fields, or all fields in a DCR message exchange during UE-to-UE Relay, e.g., as detailed in above exemplary procedure, one of the keys in the discovery parameters needs to be selected by the sending device and the receiving device, e.g.:
1. if the DUCK available, the DUCK is to be used to protect those privacy sensitive fields, and
2. if the DUCK is not available AND the DUSK is available, then the DUSK is to be used to protect those, and otherwise,
3. if neither DUCK nor DUSK are available, then privacy sensitive fields, or all fields in the DCR message must not be protected.
   Once (and if) a key is selected, the sending device can protect the DCR message and transmit the protected DCR message. Once (and if) a key is selected, the receiving device can receive the protected DCR message and securely process it (decrypt/integrity verify). It is to be noted that if the Source-UE and the Target-UE have a set of common discovery keys unknown to the relay, then this set of keys might be preferred.

8etwe embodiments are described in the context of UE relays that may allow, e.g., a remote UE that may be out of coverage to connect to the network. This type of relay is called UE to Network relay or U2N relay, etc. The UE relays may also allow two end-UEs to communicate with each other. This type of relay is called UE-to-UE relay or U2U relay, etc. The end-UEs may be denoted source UE and target UE, etc. The different peers of UEs may execute a discovery procedure to discovery each other and/or may send initial communication messages to establish a secure 8etween8n8ng8 link. For instance, the remote UE and UE to Network relay may discovery each other and then the remote UE may send a Direct Communication Request to the UE to Network relay. For instance, the UE to UE relay and the two end UEs may want to discovery each other and then one of the end UEs may send a Direct Communication Request to start the establishment of the PC5 communication links.

Throughout this Disclosure, the Following Acronyms Refer to Following Respective Definitions:
KDF: stands for Key Derivation Function. A KDF is for example defined in TS 33.220 v18.0.0 in Appendix B.2. In this example, the KDF of an input bit string S with a key K, i.e., KDF(K,S), may be equivalent to HMAC-SHA-256 (K,S) where SHA-256 is the hash function used in the HMAC construction. The bit string S may be constructed as described in TS 33.220 from multiple parameters param1, param2, . . . , paramN but concatenating those parameters with their assigned length and including a unique identifier denoted FC for the specific usage of the KDF. Sometimes, instead of writing KDF(K,S) it is written KDF(K, param1, param2, . . . , paramN) where it is to be understood that the bit string S is constructed with the field param1, param2, . . . , paramN.
NEA and NIA: These are Encryption (NEA) and Integrity Algorithms (NIA). In a 5G implementation, these are described in Appendices D.2 and D.3 of TS 33.501.
DUSK, DUCK, and DUIK: these refer to respective keys, used respectively for Scrambling, Ciphering and Integrity. In a 5G Discovery embodiments, these refer to the Discovery User Scrambling Key, Discovery User Ciphering Key, and Discovery User Integrity Key, respectively.
DP_X-Y: These correspond to some security discovery parameters, for example keying materials used between entities X and Y. e.g., DP_S-UE-to-UE refers to the discovery security parameters associated with the RSC used between Source-UE and UE-to-UE Relay.

### Scrambling/Confidentiality/Integrity Protection Routines for Discovery Messages in UE-to-UE Relay Scenarios.

In the following embodiments and embodiment variants related to “UE-to-UE” relay use cases are presented in which a source user equipment (UE) device needs or wants to communicate with a Target-UE device over a UE-to-UE Relay device. This UE-to-UE Relay use case involves at least two phases, (secure) discovery and establishment of a (secure) PC5 communication link. These two phases exhibit certain challenges that have been already dealt with in some of the above embodiments.

Regarding the (secure) discovery of UEs (Source-UE, UE-to-UE Relay, Target-UE), certain architectural solutions might require “hop-by-hop” and “end-to-end” discovery. For instance, a discovery message (e.g., an announcement discovery message in discovery model A or a solicitation discovery message in discovery model B) sent by the Source-UE and directed to the Target-UE might be (1) firstly protected with discovery parameters bound to the end-to-end communication link between Source-UE and Target-UE, these discovery parameters (DP_S-T) might include a DUIK, DUSK, or DUCK. Then, the discovery message might be (2) secondly protected with discovery parameters (DP_s-UEtoUE) bound to the hop-by-hop communication link between Source-UE and UE-to-UE Relay. These parameters might also have a DUIK, a DUSK, and a DUCK. When the UE-to-UE Relay receives the message, the UE-to-UE might process the message where processing involves the security processing of a discovery message using DP_s-UEtoUE. After processing, the UE-to-UE Relay can check whether this discovery message is intended for its UE-to-UE Relay services, e.g., by performing a matching action as in TS 33.503. If it is, then it protects the message with the discovery parameters (Dp_UEtoUE-T) bound to the hop-by-hop communication link between UE-to-UE Relay and Target-UE. When the Target-UE receives message, the Target-UE might process the message where processing involves (1) the security processing of a discovery message using Dp_UEtoUE-T and then (2) the security processing of a discovery message using DP_S-T.

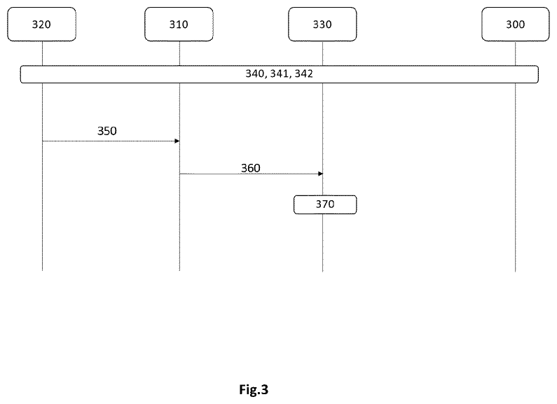

In a complementary description, the security procedure for 5G ProSe UE-to-UE Relay discovery Model A is described—referring to FIG. 3—as follows:

In FIG. 3, Step 340, announcing UE 320 is provisioned with discovery security materials from a network function in the CN 300, e.g., 5G PKMF, by performing a Relay Discovery Key Request procedure. The discovery security materials may comprise two sets of Code-Sending Security Parameters: the Code-Sending Security Parameters associated with a ProSe service and the Code-Sending Security Parameters associated with a Relay Service Code (RSC). In addition, CURRENT_TIME and MAX_OFFSET parameters are included for each set of Code-Sending Security Parameters.

In FIG. 3, Step 341, ProSe 5G UE-to-UE Relay 310 may be provisioned with discovery security materials from a network function in the CN 300 by performing a Relay Discovery Key Request procedure. The discovery security materials include both Code-Sending Security Parameters and Code-Receiving Security Parameters associated with the RSC. In addition, CURRENT_TIME and MAX_OFFSET parameters may be included for each set of security parameters.

In FIG. 3, Step 342, the monitoring UE 330 is provisioned with discovery security materials from a network function in the CN 300 by performing a Relay Discovery Key Request procedure. The discovery security materials may comprise two sets of Code-Receiving Security Parameters: the Code-Receiving Security Parameters associated with the ProSe service and the Code-Receiving Security Parameters associated with the RSC. In addition, CURRENT_TIME and MAX_OFFSET parameters are included for each set of security parameters.

In FIG. 3, Step 350, the Announcing UE can start broadcasting an Announcement message, if the UTC-based counter provided by the system associated with the discovery slot is within the MAX_OFFSET of the Announcing UE's ProSe clock and if the validity Timer has not expired. The Announcing UE can form an Announcement message and protect the message as follows: it first protects the End-to-End (E2E) ProSe discovery information using the Code-Sending Security Parameters associated with the ProSe service; then, it protects the Announcement message using the Code-Sending Security Parameters associated with the RSC.

In FIG. 3, Step 360, the ProSe 5G UE-to-UE Relay listens for an Announcement message that matches its Discovery Filter, if the UTC-based counter associated with that discovery slot is within the MAX_OFFSET of the ProSe 5G UE-to-UE Re′ay's ProSe clock. The ProSe 5G UE-to-UE Relay processes a received Announcement message to find a matching message to its Discovery Filter. When the ProSe 5G UE-to-UE Relay processes the message, it undoes the protection of the received message using the Code-Receiving Security Parameters associated with the RSC. Upon identifying a matching message, the ProSe 5G UE-to-UE Relay forms a Relayed Announcement message containing the original Announcement message and protects the Relayed Announcement message using the Code-Sending Security Parameters associated with the RSC. Then, the ProSe 5G UE-to-UE Relay starts broadcasting the Relayed Announcement message.

In FIG. 3, Step 370, the Monitoring UE listens for a Relayed Announcement message from ProSe 5G UE-to-UE Relay. The Monitoring UE processes a received Relayed Announcement message to find a matching message to its Discovery Filter. When the Monitoring UE processes the message, it first undoes the protection of the message using the Code-Receiving Security Parameters associated with the RSC, and further undoes the protection of the E2E ProSe discovery information using the Code-Receiving Security Parameters associated with the ProSe service.

In FIG. 3, message in Step 350 may include the Type of Discovery Message, Discoverer Info, RSC and E2E discovery information in the solicitation message In FIG. 3, message in Step 360 may include the Type of Discovery Message, Discoverer Info (i.e. Relay User Info ID), RSC, Relay indication (to indicate ProSe direct discovery forwarding), original Discoverer Info (i.e. source 5G ProSe U2U UE User Info ID) and E2E discovery information. Thus, message in Step 360 includes additional information including the Discoverer Info, i.e. Relay User Info ID, and a Relay indication.

In model A discovery, the Source-UE might be called an announcing UE and the Target-UE might be a monitoring UE or vice versa. In model B discovery, the Source-UE might be called a discoverer UE and the Target-UE might be a discovery UE.

In model B discovery, the message flow is as in FIG. 3 where messages 350 and 360 correspond to solicitation and relayed solicitation messages with additional messages replied by 330 towards 320 over 310 corresponding to response and relayed response messages.

The above procedures require a first consideration: when the Source-UE protects the message with DP_S-T bound to the end-to-end communication link between Source-UE and Target-UE, this security processing of the discovery message may imply scrambling of a first part of the message, e.g., the first 32 bytes of the message. If it is done, then the UE-to-UE Relay may not be able to check whether this discovery message is intended for its UE-to-UE Relay services, e.g., because certain fields are scrambled.

Thus, in an embodiment alternative, the Source-UE and Target-UE must not be configured with the DUSK in the DP_S-T bound to the end-to-end communication link between Source-UE and Target-UE. Since the DUSK is not present, then no scrambling is performed.

Thus, in an embodiment alternative, the Source-UE and Target-UE and UE-to-UE Relay must be configured with the same DUSK in the DP_S-T and DP_S-UE-2-UE. Since the DUSK is the same, then the relay UE-to-UE can descramble the message.

Thus, in another embodiment alternative, the Source-UE and UE-to-UE Relay must be configured with a policy determining that when the DP_S-T bound to the end-to-end communication link between Source-UE and Target-UE are used in the context of a UE-to-UE Relay discovery procedure, then the DUSK in the DP_S-T must not be used for scrambling.

Thus, in another embodiment alternative, the Source-UE and Target-UE must be configured with a mask determining which part of the message is to be scrambled or not with the scrambling key in DP_S-T. If this is done, a UE-to-UE Relay can still unscramble the message with DP_S-UE-2-UE and filter valid messages. For instance:
Scrambled_message=message XOR ((0xFFFF∥mask) AND time-hash-bitsequence)

For instance, the mask might be such that fields such as the message type and RSC are not masked by the Source-UE, but fields such as the Discovery Info of the sending device (e.g., Source-UE) or the End-to-End discovery information are masked.

Thus, in another embodiment alternative, the Source-UE and Target-UE must be configured with a mask that is equal or derived from the mask used in confidentiality protection.

The above procedures require a second consideration: When the Source-UE protects the message with DP_S-T bound to the end-to-end communication link between Source-UE and Target-UE, this first security processing of the discovery message might imply attaching a first MIC computed with a first DUIK in DP_S-T. When the Source-UE protects the message with DP_S-UE-to-UE bound to the hop-by-hop communication link between Source-UE and UE-to-UE Relay, this second security processing of the discovery message might require attaching a second MIC computed with a second DUIK in DP_S-UE-to-UE.

Thus, in another embodiment variant, the discovery message might have two MICs.

Thus, in another embodiment variant, the discovery message may contain two timing values, e.g., least significant bits of the UTC time. A first timing value is used with the first MIC and the second timing value is used with the second MIC.

Furthermore, in another embodiment variant, the accuracy of the first timing value used for the first MIC related to the end-to-end communication might be less accurate than the accuracy of the second timing value used for the second MIC related to the hop-by-hop (e.g., relay to Target-UE) communication. For instance, the first timing value may be such that a time difference of 2 seconds might be allowed while the second timing value may be such that a difference of a single second might be allowed. This embodiment variant allows increasing the reliability of the protocol. This is also applicable to cases in which a UE-to-UE relay may cache a received message from the Source-UE and keep rebroadcasting it. This is the case because the accuracy of the first timing value can be made equal to the caching time value of the relay.

It is to be noted that if the first timing value and the second timing value refer to some bits of the UTC based counter, the fact that the first timing value is less accurate is equivalent to saying that it refers to the accuracy of the lowest bits in the UTC-based counter. For instance, assume that the whole UTC-based counter is 16-bits long and has an accuracy of one second. For instance, assume a UTC-based counter value, in hexadecimal 0x1234 and in binary 0001 0010 0011 0100, where the most significant bit is on the left and the least significant bit is on the right and an increment of 1 implies that it is 1 second later. Then in this example the 4 least significant bits are 0100 (bits 3-0) and has an accuracy of 1 second. Because it contains information about the 4 LSBs, it can correct errors of up to 8 seconds (and in some cases 16 seconds). Assume that 4 bits of the UTC-based counter are transmitted, but corresponding to bits 4-1, i.e., 1010 as per above example. This timing value has an accuracy of 2 seconds because the lowest bit has an accuracy of 2 seconds, i.e., this timing value is less accurate. This timing value can correct errors of up to 16 seconds (and in some cases 32 seconds).

Furthermore, in another embodiment variant, the UTC time is used to scramble/unscramble a message. According to TS 33.503 and TS 33.303 (Clause 6.1.3.4.3.5), the 4 LSBs of the UTC-based counter are set to 0 for this operation. This may not be sufficient or efficient, e.g., if the UE-to-UE Relay introduces high processing or caching time (more than 8 seconds) and more than 4 LSBs of the UTC-based counter are transmitted (because as explained before, if more than 4 LSBs are transmitted, then the value remains valid for a longer period of time dependent on the index of the most significant bit transmitted). Thus, the scrambling procedure in TS 33.503/TS 33.303 is modified to set the x LSBs to 0 when scrambling the direct discovery set exchanged between the end UEs where x may be, e.g., 5, 6, . . . . This ensures that the end receiving device is capable to unscramble the message and access the integrity protected message and minimizes the amount of resources required, so that it can proceed to decrypt it and integrity verify it. For instance, if the UE-to-UE Relay may cache a discovery message for 32′, then it is advantageous if the end UEs set at least the 6 LSBs of the end-to-end UTC-based counter to 0. This embodiment variant may be configurable (e.g., depending on the ProSe Application/code or the RSC used). The absolute/relative x value may also be exchanged in the discovery message itself. Note that (the effect of) this embodiment variant is similar to using a UTC-based counter of less accuracy for the protection of the end-to-end message (protected with DP_S-T) compared with the UTC-based counter used for the protection of the discovery message between end UEs (Source-UE and Target-UE) and UE-to-UE Relay. Note that the effect of this embodiment variant is similar to requiring that DUSK of the end-to-end security parameters (DP_S-T) is not used since it allows unscrambling the message, and performing the subsequent decryption/integrity verification. This embodiment variant is applicable, e.g., to steps 2 and 4 in in Clause 6.1.3.3.3.1 Security procedure for 5G ProSe UE-to-UE Relay Discovery with Model A or Steps 1, 2, 3, 4 in Clause 6.1.3.3.2 of the draftCR to TS 33.503 (TDoc S3-233374).

In a further related embodiment variant, if the timing values (LSBs of the UTC-based counters) are different or have different accuracy, those different timing values maybe used also in the confidentiality and/or scrambling sequences. This allows a relay to cache the discovery message and to keep it for a longer period of time and allows a Target-UE to receive said message and successfully decrypt/unscramble the message for a longer period of time.

In a further related embodiment, a second timing value may correspond to the x LSB of the UTC-based counter (e.g., bits 0, . . . , x−1) and the first timing value may include a subset of y of those bits (e.g., bits 1, . . . y) or the following y bits (e.g., bits x−1, . . . x+y−1). This allows resolving a bigger time difference with a lesser number of bits. In other words, the message can remain valid for a longer period of time requiring the transmission of less bits.

In a further embodiment, the second timing value may be the 4 or the 8 LSBs of the UTC based counter, i.e., bits 0-3 and bits 0-7 respectively. Furthermore, the first timing value may include bits 5-8 or bits 8-15 of the UTC-based counter. In other words, there can be an overlap between the timing values. This approach of constructing the first timing value ensures that the first timing value can be used to correct the time difference between Source-UE and Target-UE for a longer period (longer validity time) of time without having to transmit additional bits. This longer period of time determined by the number of bits of LSBs of the UTC-based counter, and in particular, the most significant bit of the UTC-based counter transmitted, determines the validity time of the message. For example, if the first timing value refers to bits 0-7 of the UTC-based counter where bit 7 is the most significant bit, then the message is valid for ^{~}2\hat{ }{7} seconds. For instance, if the first timing value refers to bits 4-7 of the UTC-based counter, then the message is also valid for ^{~}2\hat{ }(7) seconds.

In a further embodiment variant related to the previous one, the timing values may have some overlapping bits, e.g., the first timing value may be the 4 LSBs of the UTC based counter and the second timing value may be the 8 LSBs of the UTC based counter. When the Source-UE transmits the protected discovery message to the UE-to-UE relay, overlapping bits do not need to be transmitted twice. For instance, in the previous example, 8 bits may be required to transmit both timing values because of the overlap between them. When the UE-to-UE relay forwards/transmits the protected discovery message to the target UE, the UE-to-UE relay only includes the first timing value, in the previous case, the 8 LSBs of the UTC based counter.

In a further embodiment variant related to the previous one, the first timing value may contain (part of) the second timing value.

In a further embodiment variant related to the previous one, both timing values may be included at the beginning of the discovery message. In still another variant, since the very least significant bits of the first timing value of the UTC-based counter are missing, those bits may be set to a predefined value (e.g., all zeros or all ones) when using the complete reconstructed UTC-based counter in a cryptographic function such as a KDF. For instance, if the UTC-based counter of the Source-UE transmitter is T3, T2, T1, T0 and T0 is not transmitted and T1 is transmitted, then the Target-UE receiver will use the received T1 to correct its own UTC-based counter T3′, T2′, T1′, T0′. In both cases, when the UTC-based counter is used e.g., in the computation of a MIC or in the generation of a pseudorandom bitstream for encryption purposes, the LSBs of the UTC-based counters (I.e., T0 and T0′) are set to a predefined value, e.g., all zeros (e.g., 0x00 if T0 and T0′ are 1 byte long).

In a further embodiment, the meaning of a timing value (e.g., a first timing value) and/or the correction value for the LSB (that may be not transmitted) may be determined by means of a policy or be preconfigured in the software of a UE.

In a related embodiment, one of the timing values, e.g., the first one, is an absolute time value so that the freshness check at the destination is based on an absolute time avoiding issues in case that, e.g., the relay performs caching of the discovery messages.

In a related embodiment, if a timing value is an absolute time value one or more of the integrity/confidentiality/scrambling routines may only use the LSBs of said absolute time value (e.g., UTC time) as input in the generation of a MIC or a pseudorandom sequence (used for confidentiality by xoring it with the plaintext discovery message).

In a further related embodiment, if the timing value for end-to-end communication is valid for T seconds, the discovery message arrives at the relay with a latency L, then the relay may retransmit it for T−L seconds. For instance, T may be determined from the number of bits of the UTC-based counter or the index of the most significant bit of the UTC-based counter. L may be a configuration parameter, e.g., that may determine that the discovery message should be transmitted at least L seconds before the message validity expires, or the MIC-based freshness check is not valid anymore.

In a further related embodiment, if the timing value for end-to-end communication is valid for T seconds, the discovery message arrives at the relay at time t, then the relay may retransmit till time t+T-delta where delta is a configurable safety time window to make sure that the destination UE can successfully process the received discovery message. This value T may depend on the accuracy of the received timing value. Delta may depend on a safety window to ensure that the message can be successfully verified at the receiving side.

In a further related embodiment, the discovery parameters, e.g., caching time and/or the timing value ranges/accuracy and/or discovery keys to use and/or other parameters, are determined by means of a policy. These parameters may be linked to, e.g., a discovery code, a relay service code or an application code such as a ProSe code.

In a further embodiment, if it is desired to further optimize the UE-to-UE discovery procedure, then redundant encryption/integrity protection may be avoided by configuring only the suitable keys. Redundant encryption may mean that if an RSC is only used with a ProSe service, then it is not required to apply encryption in the end-to-end and hop-by-hop links. However, ProSe code and Relay Service Codes are not mapped to each other, and this prevents flexibility. In particular, for a given ProSe application, it may be desirable that when:
A first ProSe application performs direct discovery, then all keys (DUSK, DUCK, DUIK) may be configured in the discovery keys associated to (the ProSe code of) said ProSe application,
The first ProSe application performs UE-to-UE discovery over UE-to-UE Relays that may be used by a second ProSe application, then all keys (DUSK, DUCK, DUIK) may be configured in the discovery keys associated to (the ProSe code of) said ProSe application,
The first ProSe application performs UE-to-UE discovery over UE-to-UE Relays that may be used by a second ProSe application, no keys (no DUSK, no DUCK, no DUIK) may be configured in the discovery keys associated to (the ProSe code of) said ProSe application, and only keys (DUSK2, DUCK2, DUIK2) associated to a relay service code may be configured.
   To achieve this:

In a variant, a UE may be configured with ProSe Code that includes an indication of the associated RSC to perform UE-to-UE discovery, whereby this association indicates whether the RSC is shared with other ProSe Codes (ProSe applications or not).

In a related variant, the ProSe code used for UE-to-UE discovery includes/is associated to two sets of keys, a first set of keys used for the protection of the direct discovery set as explained in other embodiments, and a second set of keys used for the complete protection of the UE-to-UE discovery message.

In a related variant, a ProSe code may include an indication determining whether it is used for direct discovery (associated to a single set of discovery keys) or UE-to-UE discovery (associated to two sets of discovery keys).

In a related variant, a UE may choose a ProSe code depending on whether the UE is performing direct discovery or UE-to-UE discovery. The type of code to use may be determined based on the discovery message being sent/received.

In a further related embodiment, the discovery parameters of the UEs are optimized for performance, e.g.,
if a relay UE can cache a discovery message for time T, then the Source-UE is only required to transmit a discovery message every T seconds and the timing values are such that can resolve the corresponding time error.
if a relay UE can cache a discovery message for time T, then the Source-UE is only required to transmit a discovery message every T seconds and the transmission time is according to a policy, e.g., to reduce errors, e.g., by transmitting when the current time t modulo T equals 0 or T/2.

Thus, in another embodiment variant, the discovery message might contain a single timing value, e.g., least significant bits of the UTC time, and the same timing value is used in the computation of both the first MIC and the second MIC. This UTC value is the UTC value of the Source-UE. Upon reception of message, e.g., 350 in FIG. 3, the UE-to-UE Relay processes the message with the end-to-end security parameters including the verification of the second MIC. The UE-to-UE Relay integrity protects the discovery message using a third DUIK in DP_UE-to-UE-T by computing a third MIC using the same UTC value in the received message and without updating or setting a UTC counter value in the transmitted message. This embodiment variant allows saving bandwidth.

In some cases, a Source-UE may want to communicate with multiple N Target-UEs. In this case, in a further embodiment, some parameters of a discovery message as defined in TS 33.503 may be reused in the computations for each of the Target-UEs, e.g., a single timing value may be used for the computation of multiple MICs, where each MIC is a MIC for end-to-end protection between Source-UE and Target-UE k, with k=1, . . . , N. This has the advantage of reducing the size of the discovery message.

Thus, in another embodiment variant both the first MIC and the second MIC might be included at the beginning of the discovery message. This might require certain changes in TS 33.503 and TS 33.303.

For instance, Clause 6.1.3.2.3 in TS 33.503 might require Step 3 of clause 6.1.3.4.3.5 of TS 33.303 [4] to be XOR (0xFFFF∥time-hash-bitsequence) with the most significant (L+16) bits of discovery message when the UE protects the discovery message with a first set of keys, e.g., when the Source-UE protects the discovery message with DP_S-T bound to the end-to-end communication link between Source-UE and Target-UE) and Clause 6.1.3.2.3 in TS 33.503 might require Step 3 of clause 6.1.3.4.3.5 of TS 33.303 [4] to be XOR (0xFFFF∥time-hash-bitsequence) with the most significant (L+16+16) bits of discovery message when the UE protects the discovery message with a second set of keys, e.g., when the Source-UE protects the discovery message with DP_S-UE-to-UE bound to the end-to-end communication link between Source-UE and UE-to-UE Relay). Here, time-hash-bitsequence-2 may be 16 bits longer than time-hash-bitsequence-1.

For instance, Clause 6.1.3.2.3 in TS 33.503 might require the time-hash-bitsequence keystream in A.5 of TS 33.303 [4] to be set to L+16 least significant bits of the output of the KDF, where L is the bit length of the discovery message to be scrambled and set to Min (the length of discovery messa-e—16, 256).

For instance, Clause 6.1.3.2.3 in TS 33.503 might require the time-hash-bitsequence keystream in A.5 of TS 33.303 [4] to be set to a variable size, e.g., L or L+16 least significant bits of the output of the KDF, where L is the bit length of the discovery message to be scrambled and set to Min (the length of discovery messa-e—16, 256).

For instance, Clause 6.1.3.2.3 in TS 33.503 might require Step 3 of clause 6.1.3.4.3.5 of TS 33.303 [4] to be XOR (0xFFFFFFFF∥time-hash-bitsequence) with the most significant (L+16+16) bits of discovery message when the UE protects the discovery message with a second set of keys, e.g., when the Source-UE protects the discovery message with DP_S-UE-to-UE bound to the end-to-end communication link between Source-UE and UE-to-UE Relay), where L is the bit length of the discovery message to be scrambled and set to Min (the length of discovery messa-e—16, 256).

Thus, in another embodiment variant, the second MIC might be computed over the whole message after the first security processing, i.e., the second MIC also implies the integrity protection of the first MIC.

In another embodiment, the second discovery protected message includes two MICs (an end-to-end MIC computed with DP_S-T and a hop-by-hop MIC computed with DP_S-UE-to-UE) and the third discovery protected message includes a single MIC.

In a further related embodiment, this single MIC in the third protected (discovery) message is computed as the XOR of the end-to-end MIC between Source-UE and Target-UE (computed with DP_S-T) and the hop-by-hop MIC between UE-to-UE Relay and Target-UE (computed with DP_UE-to-UE-T). This is feasible because the UE-to-UE Relay can compute this second hop-by-hop MIC and use it to XOR the received end-to-end MIC in the second discovery protected message that becomes the MIC in the third discovery protected message. The Target-UE can verify both hop-by-hop and end-to-end integrity because the Target-UE can first compute this hop-by-hop MIC and “remove” its contribution from the received MIC in the third discovery protected message obtaining again the end-to-end MIC. The Target-UE can then verify this end-to-end MIC in a standard way. This is advantageous because it allows reducing communication overhead while still providing both end-to-end and hop-by-hop security.

In some use cases, a Source-UE may want to communicate with multiple N Target-UEs (target_1, target_2, . . . , target_N), e.g., according to TR 23.700-33, there is a description on UE-to-UE Relay discovery message wherein for UE-to-UE Relay Model A discovery, the Type of Discovery Message, User Info ID of the UE-to-UE Relay, RSC, and/or list of User Info ID of Target-UEs are contained in the Announcement message. This requires a further consideration: how such a message should be protected.

In a further embodiment, the Source-UE may protect the contents of the discovery message as follows:
1. Protect the (fields of the) N (Source-UE to Target-UEᵢ) discovery messages to be transmitted to N different Target-UEs with up to N different sets of discovery keying materials DP_S-Tᵢ with i=1, . . . , N. This may be as follows:
   the protection of each of those Source-UE to Target-UE discovery messages may be done as per TS 33.503 so that a protected discovery message is returned.
   The Source-UE may take parts of the protected discovery messages corresponding to the fields that need to be exchanged. This allows reducing the size of the discovery message to be sent. For instance, if there are two Target-UEs, the two (Source-UE to Target-UE) discovery messages may be first built and constructed including, e.g., a timing value (e.g., LSBs of UTC-based counter). However, those timing values may be removed since a single value may need to be transmitted that is common to both discovery messages.
2. Assemble a (Source-UE to UE-to-UE Relay) discovery message with (the selected protected fields of) the N (Source-UE to Target-UE) discovery protected messages.
   Assembling may be done by means of concatenation.
   The N (Source-UE to Target-UE) discovery protected messages may be carried, e.g., in the metadata field of the (UE-to-UE RelaySource-UE to UE-to-UE Relay) discovery message.
   Assembling may be done by creating a header of the (UE-to-UE RelaySource-UE to UE-to-UE Relay) discovery message and appending/attaching/inserting the N (Source-UE to Target-UE) discovery protected messages (or chosen fields from them).
   The selected protected fields may be, e.g., the N MICs or the confidentiality protected User Info IDs.
3. Protect the (UE-to-UE RelaySource-UE to UE-to-UE Relay) discovery message with the discovery keying materials DP_S-UE-to-UE as per TS 33.503.
   In this case, the first timing value associated with the (Source-UE to Target-UE) discovery protected messages may be greater than the second timing value associated with the (UE-to-UE RelaySource-UE to UE-to-UE Relay) discovery protected message.
   In this case, only the first timing value may need to be transmitted and the second timing value may be a subset (e.g., the LSBs) of the first timing value.
4. Send said discovery protected message to the UE-to-UE relay.

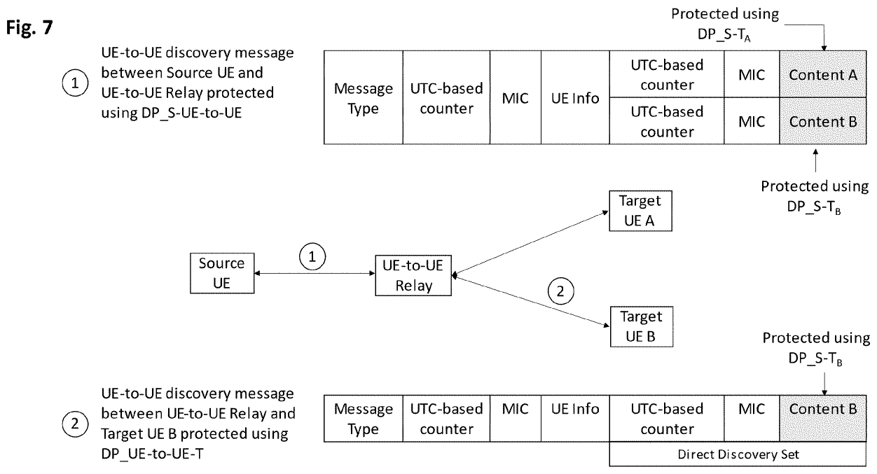

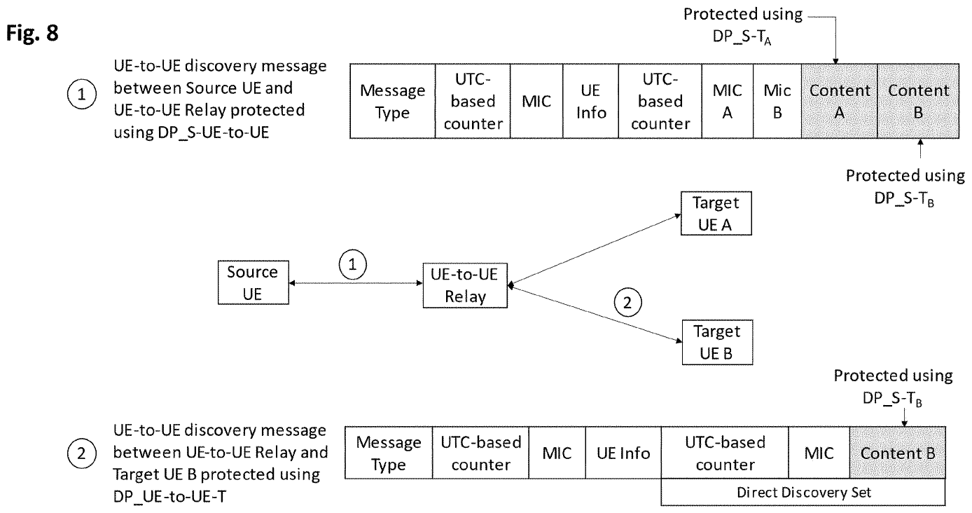

FIG. 7 and FIG. 8 illustrate potential message structures in above embodiment (as well as in other embodiments in this application), in particular, the UE-to-UE discovery message between Source-UE and UE-to-UE Relay. In these figures, the first field is the message type, followed by a timing value (UTC-based time), followed by a MIC, followed by the UE info (e.g., Source-UE or UE-to-UE Relay info), followed by a payload field (e.g., metadata field). In FIG. 7, the end-to-end discovery messages between Source-UE and Target-UE are encapsulated/transmitted as generated after applying the security routines in TS 33.503 to protect them. In FIG. 8, only chosen fields of the protected end-to-end discovery messages between Source-UE and Target-UE are encapsulated/transmitted in order to reduce communication overhead.

In a further embodiment, the UE-to-UE Relay may receive the contents of a discovery protected message, as described above, as follows:
Security process the incoming (UE-to-UE RelaySource-UE to UE-to-UE Relay) discovery message as described above with the discovery keying material DP_S-UE-to-UE.
Extract the (fields of the) N (Source-UE to Target-UE) protected discovery messages.
Re-)assemble (if required) the N (Source-UE to Target-UE) protected discovery messages, e.g., if a timing value is reused for the N protected discovery messages, then it should be reintroduced where needed. In general, if a (Source-UE to Target-UE) discovery message contains two fields (Fa, Fb) and Fa is a field that is common to multiple (Source-UE to Target-UE) discovery messages and there are a total of N (e.g., N=3) (Source-UE to Target-UE) discovery messages, then (Fa, Fb-1, Fb-2, Fb-3) is received and the N=3 (Source-UE to Target-UE) discovery messages are reassembled as (Fa, Fb-1), (Fa, Fb-2), (Fa, Fb-3). Note that as described above (Fa, Fb-1, Fb-2, Fb-3) is what may be transported, e.g., in the metadata field of the (UE-to-UE RelaySource-UE to UE-to-UE Relay) discovery message.

In a further embodiment, the UE-to-UE Relay may cache said (Source-UE to Target-UE) discovery messages for a given time, e.g., a given time configured in a policy. The UE-to-UE Relay may store and forward discovery messages. For instance, a given time dependent on the freshness value/requirement/timing value of the (Source-UE to Target-UE) discovery messages. For instance, if the (Source-UE to Target-UE) discovery messages contain the b LSB of a UTC-based timer, the UE-to-UE Relay may cache/keep/store/transmit/broadcast said (Source-UE to Target-UE) discovery message for up to around 2° units of time (if the time unit of time is 1 second, then up to 2b seconds). Once this time is over, the UE-to-UE Relay may delete the received/stored discovery messages and/or request new ones. The action taken (e.g., deleting/storing messages for how long) may be done based on a configuration/policy.

It is to be noted this time validity may be also slightly less than 2\hat{ }b bits because if the b=4 LSBs of the UTC-based-timer are 1111, but the receiving device is slightly out of sync (e.g., 1 second ahead) and its b=4 LSBs of the UTC-based timer are 0000 already, then there will be a time synchronization issue because the following bit will have changed already. Thus, from this perspective, it is safer to consider an accuracy and time validity of 2\hat{ }{b-1} time units.

To illustrate this, we can describe a possible routine to reconcile the counters a and c given a small desynchronization of up to 2\hat{ }k time units by transmitting the m=k+1 least significant bits. Assume that ABS (a-c)<2\hat{ }k where a and c are two counters and the (c) returns the absolute value of an integer value c. We can further write ABS (a1*2\hat{ }m−+a0−c−*2\hat{ }m−c0)=ABS((a1−c1)*2\hat{ }m−+a0−c0)<2\hat{ }k, where a1 and c1 refer to the most significant bits of a and c, starting with bit m and a0 and c0 refer to the m least significant bits. For m=k+1, if abs (a0−c0)>2\hat{ }k, then (a1−c1) cannot be equal to 0, and thus, the most significant bits of the counters are different and need to be corrected/reconcile as well. If device A has counter a and device C has counter c, and device A receives c0 from C, device A can reconciliate its counter to match the one of C by doing the following:
if ABS (a0−c0)<2\hat{ }k, A can keep a1 as it is and replaces a0 with the received c0, and thus, the reconciliated counter obtained by A is a1|c0 where | represents concatenation.
if ABS (a0−c0)>=2\hat{ }k, then device A has to correct a1 into a1′ by adding 1 (when a0>c0), I.e., a1′=a1+1, or subtracting 1 (when a0<c0), I.e., a1′=a1-1, and then replacing a0 with the received c0, and thus, the reconciliated counter is a1′|c0 where | represents concatenation. This algorithm allows reconciliating two counter values a and c given the exchange of the m=k+1 LSBs of one of the counters when the difference between the counters is 2\hat{ }{k} in absolute value. Note that this covers a total time range of 2\hat{ }m time units this is because a may be up to 2\hat{ }k time units smaller or greater than c. Thus, the maximum time difference that can be corrected is 2\hat{ }{m−1}, and thus, this is the maximum time validity of the received LSBs in a deterministic/error free-manner manner. Note that—as described in other embodiment (variants)—this may require exchanging a first timing value bound to data exchanged end-to-end (between end UEs) and corresponding to the LSBs of the UTC-based counter with more bits than the timing value bound to the hop-by-hop communication (between end UE and UE to UE relay).

Note that when the time difference between the LSBs is greater than 2\hat{ }k, the receiving UE A may try to replace the own LSBs (a0) of the own counter with the received LSBs (c0) from C. For instance, if A has a0=0x1 (0001) as the LSBs and receives 0xB (1011), the difference between the values is 0xA, I.e., 1010. But since there was no overflow to the MSBs, the replacement works and A can still reconcile the counter. This strategy may work sometimes (I.e., this approach is probabilistic) so that with the m=k+1 received counter, the receiving party can reconcile m bits.

Note that above reconciliation procedure assumes that the two devices A and C can have errors distributed around a central value, and thus, the reconciliation procedure works when the time difference is up to 2\hat{ }k. If m needs to be larger, e.g., 8 bits, and the error between the counters a and b is expected to be small, e.g., up to 2\hat{ }3, then above procedure may not be ideal because only allows correcting time differences of 2\hat{ }7. The following alternative counter-reconciliation procedure addresses this problem and requires:
the definition of an offset value related to the maximum allowed absolute. time error, e.g., offset=2\hat{ }3,
The sending device C with counter c′, adding the offset/2 to c′, obtaining c=c′+offset/2,
The sending device sending c0, the m LSBs of c=c1*2\hat{ }m+c0,
The receiving device A with counter a′, adding the offset/2 to a′, obtaining a=a′+offset/2=a1*2\hat{ }m+a0,
In this situation,
   if ABS (a0−c0)<offset, A can keep a1 as it is and replace a0 with the received c0, and thus, the reconciliated counter obtained by A is a1|c0 where | represents concatenation. Finally, A corrects the added offset/2 value, and obtains as the corrected counter a1|c0−offset/2.
   if ABS (a0−c0)>=offset, then device A has to correct a1 into a1′ by adding 1 (when a0>c0), I.e., a1″=a1+1, or subtracting 1 (when a0<c0), I.e., a1″=a1-1, and then replacing a0 with the received c0, and thus, the reconciliated counter's a1”|c0 where | represents concatenation. Finally, A corrects the added offset/2 value, and obtains as the corrected counter a″1|c0−offset/2.
   This algorithm allows reconciliating two counter values a and c given the exchange of the m LSBs of one of the counters when the difference between the counters is 2\hat{ }{k} in absolute value achieving a time validity of 2\hat{ }m−2\hat{ }k instead of 2\hat{ }{m−1}. This algorithm requires standarizing/agreeing on the offset value that A and C need to use.

In a further embodiment variant, two devices that communicate with each other have a specified time-counter reconciliation algorithm (e.g., as described above) used by the receiving UE (e.g., a UE-to-UE relay) to deterministically agree/reconcile its own time-counter to the time-counter value of the sensing UE (e.g., an end UE such as a source UE).

In a further embodiment, a UE-to-UE Relay may forward/rebroadcast each of the (Source-UE to Target-UE) discovery messages once they are protected using the corresponding discovery keying parameters DP_UE-to-UE-T according to the procedures in TS 33.503.
in this case, these (Source-UE to Target-UE) discovery protected messages may be transmitted all together or individually. For instance:
   the N (Source-UE to Target-UE) discovery protected messages may be transmitted in a single message protected with the DP_UE-to-UE-T discovery keying parameters.
   the N (Source-UE to Target-UE) discovery protected messages may be transmitted in N messages protected with the DP_UE-to-UE-T discovery keying parameters.
in this case, the first timing value used to protect the (Source-UE to Target-UE) discovery message(s) may be greater than the second timing value used to protect the (UE-to-UE Relay to T-UE) discovery message.
in this case, both the first and the second timing values need to be transmitted.

In a further embodiment, the (Source-UE to Target-UE) discovery message or the (Source-UE to UE-to-UE Relay) discovery message or the (UE-to-UE Relay to Target-UE) discovery message or the (Target-UE to UE-to-UE Relay) discovery message or the (UE-to-UE to Source-UE) discovery message may include one or more fields that may explicitly or implicitly indicate:
The number N of (Source-UE to Target-UE) discovery protected messages carried,
The size of the parameters used (e.g., the size of the timing values),
How the message (fields) are assembled/organized,
Which protections are applied.

In a further embodiment, instead of using a UTC-based counter, a nonce is used so that issues do not arise from a store and forward functionality of the UE-to-UE Relay.

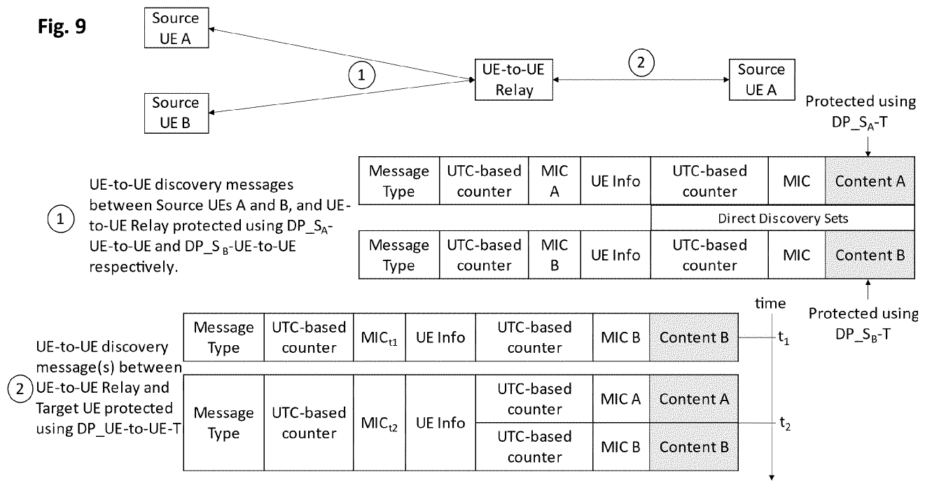

In a further embodiment, one or more Target (or Source) UEs may send one or more discovery protected messages to a UE-to-UE RelayRelay that may perform store and/or aggregate and/or forward functions of the discovery messages before sending the discovery protected message to the Source (or Target)-UE. In this case:
the processing of incoming discovery protected messages from the Target (or Source) UEs is similar to what is described in previous embodiments;
the UE-to-UE Relay may aggregate in a container message the different Target (or Source)-UE messages as time advances, e.g., at time t1 a first Target (or Source)-UE may send a first message and at time t2 a second Target (or Source-UE) may send a second message. This is illustrated in FIG. 9 where the UE-to-UE Relay transmits a discovery protected message including the first message received at t1, and upon receiving the second discovery protected message, the UE-to-UE Relay starts transmitting a new discovery protected message including both the first and second discovery protected messages received from the first and second Target (or Source)-UE;
the UE-to-UE Relay may relay/cache messages for a Max_cache_time_period determined by a policy/configuration. Furthermore, it may be taken into account the S-UE-to-T-UE discovery protected messages' validity times, i.e., S-UE-T-UE validity time should ideally always be greater than the maximum caching time period (Max_cache_time_period), otherwise, relaying of the discovery protected message (within the container) is suspended upon S-UE-to-T-UE validity time expiry;
UE-to-UE Relay may set timers to track the freshness of the Source-UE-to-Target-UE discovery protected messages and concatenate/remove Source-UE-to-Target-UE messages from the container discovery message (i.e., UE-to-UE-to-Source-UE Discovery message) as new Source-UE-to-Target-UE discovery protected messages are received and/or current Source-UE-to-Target-UE discovery protected messages in the container expire;
UE-to-UE Relay may compute a new MIC every time the container discovery message is updated.

In a further embodiment, the UE-to-UE Relay is configured with a policy determining how end-to-end discovery protected messages between a given Source-UE/Target-UE are to be routed/protected, e.g., with which sets of DP_S-UE-to-UE and/or DP_UE-to-UE-T.

In a further embodiment, the messages shown in FIGS. 7, 8 and 9 may implicitly or explicitly determine, by means of new/existing message fields, one or more of the following:
the number of end-to-end discovery protected messages that are carried/encapsulated/exchanged;
the identities of the Source-UEs and/or Target-UEs so that a UE-to-UE Relay is capable of routing and/or protecting said messages properly.

The above procedures require a third consideration: When the Source-UE protects the message with DP_S-T bound to the end-to-end communication link between Source-UE and Target-UE, this first security processing of the discovery message might imply confidentiality protecting the message with a first DUCK in DP_S-T. When the Source-UE protects the message with DP_S-UE-to-UE bound to the hop-by-hop communication link between Source-UE and UE-to-UE Relay, this second security processing of the discovery message might imply confidentiality protecting the message with a second DUCK in DP_S-UE-to-UE. These operations might be redundant.

Thus, in another embodiment alternative, the Source-UE and UE-to-UE Relay must not be configured with the DUCK in the DP_S-UE-to-UE bound to the hop-by-hop communication link between Source-UE and UE-to-UE Relay.

Thus, in another embodiment alternative, the Source-UE and UE-to-UE Relay must be configured with a policy determining that when the DP_S-UE-to-UE bound to the hop-by-hop communication link between Source-UE and UE-to-UE Relay are used in the context of a UE-to-UE Relay discovery procedure, then the DUCK in the DP_S-UE-to-UE must not be used for confidentiality protection.

Thus, in another embodiment alternative, the policy is configured by a network function in the CN 300, e.g., 5G PKMF.

Thus, in another embodiment alternative, the Source-UE and UE-to-UE Relay must be configured with a policy determining that when the DP_S-UE-to-UE bound to the hop-by-hop communication link between Source-UE and UE-to-UE Relay are used in the context of a UE-to-UE Relay discovery procedure, then the DUCK in the DP_S-UE-to-UE must not be used for confidentiality protection if the DP_S-T includes a DUCK and it is used to confidentiality protect the discovery message end to end.

In another embodiment variant that may be combined with other embodiments or used independently, the Source-UE and Target-UE may have a set of discovery keys bound to a ProSe Service Y and when the Source-UE and Target-UE communicate with each other directly, use those keys. The Source-UE and Target-UE that wish to communicate with each other for the same ProSe Service Y over a given UE to UE Relay may use a different set of keys bound to the end to end discovery message between Source-UE and Target-UE and the hop-by-hop security (Source-UE to UE-to-UE Relay, and UE-to-UE Relay to Target-UE). This allows using different sets of keys for the same ProSe service depending on how Source-UE and Target-UE communicate with each other, directly or indirectly. This means that the End UEs (Source-UE and Target-UE) are configured with different ProSe service identifiers (and corresponding keys) corresponding to the same ProSe service Y depending on whether the ProSe service is to be established directly or over a UE-to-UE Relay. When one of the End UEs (e.g., Source-UE) wishes to discover another UE (e.g., Target-UE) for a given ProSe service directly, the first End UE uses the ProSe service identifier/keys for direct discovery. When the End UE wishes to discover another UE indirectly, then it uses the ProSe service identifier/keys for indirect (over UE-to-UE Relay) discovery. In the second case, the direct discovery set (related to the the ProSe service) may be protected by DUCK1/DUSK1/DUIK1 and the discovery message may be protected by DUCK2/DUSK2/DUIK2. Depending on whether the UE-to-UE Relay may serve more than one ProSe service, then some of the keys may not be configured. For instance, if the relay only serves a single ProSe service, then DUCK1, DUSK1, DUIK1 may not be available and the protection rely only on DUCK2/DUSK2/DUIK2. In this embodiment, when an End UE (e.g., Source-UE/Target-UE) transmit a discovery message for a given ProSe service, the end UE may choose the ProSe service ID and discovery keying parameters depending on whether the discovery message is to reach the other End UE directly (direct discovery) or indirectly (UE-to-UE discovery). This may be determined by means of a policy. This policy may be configured by the core network, e.g., when discovery keying parameters are provisioned/configured.

In another embodiment similar to other embodiments for integrated discovery and that may be combined with other embodiments or used independently, the Source-UE and Target-UE that wish to communicate with each other for a ProSe Service Y over a given UE-to-UE Relay or directly may use a set of keys bound to the end-to-end discovery message between Source-UE and Target-UE and a set of keys bound to the hop-by-hop security (Source-UE/Target-UE to UE-to-UE Relay). Since the discovery message sent by a Source UE may reach the Target UE directly or indirectly, it is meaningful if:
the discovery message indicates whether it is a first hop (Source-UE to UE-to-UE Relay) or a second hop (UE-to-UE Relay to Target-UE) message,
this indication may be protected by means of the end-to-end discovery keying parameters and/or hop-by-hop discovery keying parameters.
the direct discovery set is not encrypted by means of the discovery keying parameters related to the hop-by-hop security. This allows the Target-UE to directly access the protected direct discovery set, saving computational resources.
   In particular, if the Target-UE determines that a discovery message is reaching it directly, Target UE may ignore the protections related to the hop-by-hop security protection (e.g., MIC computed with the discovery keying parameters related to the Relay service) and only security process the direct discovery set by means of the end-to-end discovery keying parameters related to the ProSe service. The Target-UE may determine this based on some of the fields of the discovery message, e.g., L2 address or the relay indication.

The above procedures require a fourth consideration, namely that having two sets of discovery keying parameters, e.g., DP_S-T and DP_S-UE-to-UE increases the configuration complexity.

Thus, in another embodiment alternative, the Source-UE is required to use the DUIK and DUCK DP_S-T and then the DUIK and DUSK DP_S-UE-to-UE. This may be done by requiring one or multiple of the following actions at the sending Source-UE:
Step 1 in Clause 6.1.3.4.3.2 in TS 33.303 unmodified;
Step 2 in Clause 6.1.3.4.3.2 in TS 33.303 to compute a first MIC using the DUIK DP_S-T as defined in Clause 6.1.3.2.3 in TS 33.503;
Step 3 in Clause 6.1.3.4.3.2 in TS 33.303 to add message confidentiality using the DUCK in DP_S-T as defined in Clause 6.1.3.2.3 in TS 33.503;
Step 4 in Clause 6.1.3.4.3.2 in TS 33.303 to compute a second MIC using the DUIK in DP_S-UE-to-UE as defined in Clause 6.1.3.2.3 in TS 33.503; and
Step 5 in Clause 6.1.3.4.3.2 in TS 33.303 to scramble the message by using the DUSK in DP_S-UE-to-UE as defined in Clause 6.1.3.2.3 in TS 33.503.

Thus, in another embodiment alternative, the Target-UE performs the inverse actions of the steps above.

Thus, in another embodiment, the UE-to-UE Relay only performs the inverse actions related to steps 5 and 4; and redoes those actions using the second hop-by-hop discovery keying parameters as:
Step 4 in Clause 6.1.3.4.3.2 in TS 33.303 to compute a second MIC using the DUIK in DP_UE-to-UE-T as defined in Clause 6.1.3.2.3 in TS 33.503; and
Step 5 in Clause 6.1.3.4.3.2 in TS 33.303 to scramble the message by using the DUSK in DP UE-to-UE-T as defined in Clause 6.1.3.2.3 in TS 33.503.

Step 4, in particular, might be optional.

In some options, it may be wished to reuse the security routines in Clause 6.1.3.4.3 of TS 33.303 and Clause 6.1.3.2.3 of TS 33.503 to protect the direct discovery set (as a discovery message) and protect the UE-to-UE discovery message (including the direct discovery protected set) using the same security routines. However, when protecting the direct discovery set, it may not be required to protect it as a discovery message, e.g., it may not be required to include the header so that some steps in those clauses may be skipped, as illustrated in previous procedures.

In a variant, the steps of the security routines are reorganized/removed (e.g., as in above procedure) to avoid calling the overall security routines (Clause 6.1.3.2.3 of TS 33.503) twice, once to protect the direct discovery set as a direct discovery protected message and once to protect the UE-to-UE discovery message (including the direct discovery protected message) generating a UE-to-UE discovery protected message.

In a variant, Step 1 in Clause 6.1.3.4.3.2 in TS 33.303 based on Clause 6.1.3.2.3 of TS 33.503 is not executed to protect the direct discovery set, e.g., as explained in previous embodiment.

In a variant, Step 5 in Clause 6.1.3.4.3.2 in TS 33.303 based on Clause 6.1.3.2.3 of TS 33.503 is not executed to protect the direct discovery set, e.g., as explained in previous embodiment.

In some options, the UE-to-UE discovery message may transport certain fields whose protection may be up to the application. It is advantageous to let the application, protect or not protect those fields, e.g., to allow passive eavesdroppers to identify messages or because of lawful interception reasons. However, routines in Clause 6.1.3.2.3 of TS 33.503 protect the most of the message as determined by A.7 in TS 33.503 in:

| | |
|---|---|
| KEYSTREAM | = output_keystream AND (Encrypted_bits_mask \| \| |
| | 0xFF..FF) |
| | = output_keystream AND (Encrypted_bits_mask \| \| |
| | EBM′) |

Thus, in a variant, A.7 in TS 33.503 is modified to replace EBM′=0xFF . . . FF with a bitstring such that it sets to 0 those bits that do not require protection, e.g., bits corresponding to the UserInfoIDs.

In an additional embodiment, given that a direct discovery set is not a discovery message but is protected as one, the LENGTH parameter in the Message-specific confidentiality mechanism for discovery defined in A.7 of TS 33.503 may need to be changed to LENGTH: LEN(discovery mes-age)−(LEN(UTC-based counter LSB)+LEN(MIC)), where LEN(x) is the length of x in number of bits, hence discarding LEN(Message Type) as it is not applicable to a direct discovery set.

The above embodiments may require a further consideration for some cases. The relayed discovery message might include multiple fields including, e.g., Type of Discovery Message, Counter, MIC, Discoverer Info (i.e. Relay User Info ID), RSC, Relay indication (to indicate ProSe direct discovery forwarding), original Discoverer Info (i.e. source 5G ProSe U2U UE User Info ID), NCGI, or E2E discovery information. According to TS 24.554, the aggregated length might be more than 32 bytes, and thus, the scrambling procedure in TS 33.503 may not be enough since it is limited to 32 bytes. To address this issue, approaches as described above capable of protecting more than 32 bytes might be applicable for the scrambling of UE-to-UE Relay messages.

The above embodiments may require a further consideration for some cases, namely that it may be advantageous to have end-to-end security (i.e., from Source-UE to Target-UE) for some security properties (e.g., confidentiality or integrity) but hop-by-hop security (i.e., from Source-UE to UE-to-UE Relay and from UE-to-UE Relay to Target-UE) for other security properties (e.g., integrity or confidentiality).

Thus, in a related embodiment, the discovery message may be confidentiality protected with the keys associated DP_S-T and the discovery message may be integrity protected with the keys related to DP_UE-to-UE-T and DP_S-UE-to-UE.

Thus, in a related embodiment, the devices are configured with a policy determining which keys of which discovery parameters are used to protect the discovery message sent over a UE-to-UE Relay.

Thus, in a related embodiment, the devices are configured with a policy determining which keys of which discovery parameters are used to protect the discovery message sent over a UE-to-UE Relay when the security routines in TS 33.503 are applied with a set of end-to-end discovery parameters and a set of hop-by-hop discovery parameters.

Thus, in a related embodiment, the devices are configured with a policy determining how the end-to-end and hop-by-hop messages are protected, e.g., which keys are used for, e.g., confidentiality in the hop-by-hop or end-to-end, whether a single MIC or two MICs are used, in which messages, and whether a single counter value is reused for end-to-end and hop-by-hop messages or two counter values are transmitted, etc.

In a related embodiment variant, the policy/configuration may also relate to the UTC-based counter, e.g., its precision, the number of transmitted LSBs of the UTC-based counters, the number of LSBs of the UTC-based counters that are set to 0 when scrambling/unscrambling. Etc.

In a further embodiment, a UE-to-UE Relay may be configured with a policy such that the UE-to-UE Relay is only configured to receive and forward the protected discovery messages without decrypting or computing a MIC. This has the advantage of reducing the computational resources consumption at the UE-to-UE Relay.
In a variant of this embodiment, if the Source-UE and Target-UE and UE-to-UE Relay share the same discovery parameters DP_S-UE-to-UE and DP_UE-to-UE-T. In this case, the discovery message sent by the Source-UE may contain, e.g., two MICs, a second MIC computed with DP_S-UE-to-UE and a first MIC computed with DP_S-T. Upon reception of the discovery message, the UE-to-UE Relay will check whether the second MIC can be verified in a successful manner given the received message and the received UTC-based counter. If the second MIC verification is successful, the UE-to-UE Relay can just forward the message. The UE-to-UE Relay may also store the message for some time and forward it at a later point of time, e.g., as long as the second MIC verification is successful. This holds in particular if both the first and second MICs are computed using the same UTC-based counter.
In a variant of this embodiment, given the received message and the received UTC-based counter, if UE-to-UE Relay's verification of the second MIC is successful, the UE-to-UE Relay may forward the message without the second MIC i.e., with only the first MIC computed with DP_S-T. The UE-to-UE Relay may also store the message for some time and forward it at a later point of time, e.g., as long as the second MIC verification is successful.

In a further embodiment, a UE-to-UE Relay may be configured to receive a discovery message and verify the MIC computed with the second set of discovery parameters (e.g., DP_S-UE-to-UE or DP_UE-to-UE-T), and if successful, determine the whole UTC-based counter. The UE-to-UE Relay may then be allowed to forward the message as long as a time window allows it. This time window may be based on a policy or may be based on a parameter (time window parameter) included in the received discovery message itself. The time window may be an absolute value or relative to the UTC-based counter used to verify the freshness of the second MIC, e.g., it may indicate an offset. This time window may determine how long the first MIC (computed with DP_S-T) can be verified correctly given the UTC-based counter associated to it.

In a scenario, the UE-to-UE Relay may receive a UE-to-UE discovery message bound to an RSC1 according to, e.g., Model A, as described in previous embodiments, the UE-to-UE relay may extract a protected end-to-end discovery message (protected direct discovery set) and may store it as long as the protected end-to-end discovery message (protected direct discovery set) is valid. The UE-to-UE relay may then transmit the protected end-to-end discovery message in a UE-to-UE discovery message towards a target UE by using RSC2. RSC1 and RSC2 are bound to discovery keying materials. RSC1 and RSC2 are bound to a security indicator determining whether the PC5 security procedure is with or without network assistance. When the UE-to-UE relay receives the UE-to-UE discovery message bound to an RSC1, the UE-to-UE relay may be able to match the RSC1 because UE-to-UE relay may be in (or out-of) coverage and RSC1 is bound to a PC5 security procedure with (or without) network assistance. However, after storing the protected direct discovery set and when preparing to send the UE-to-UE discovery message, the coverage status of the UE-to-UE relay may have changed. Thus, a method is required to determine which RSC is to be used in the discovery procedure and how to inform the end UEs. To this end, the following embodiments may be applicable:

In a further embodiment variant, the UE-to-UE Relay may be adapted or configured (e.g., with a policy) to store the RSC (and the corresponding indication regarding the type of PC5 security procedure it is bound to) next to the end-to-end protected discovery message/direct discovery set and wherein the UE-to-UE relay may be configured with a policy to use the same RSC when sending the subsequent discovery message towards the target UE, and thus, indicating the same type of PC5 security procedure to be used. This further implies that the UE-to-UE relay may not forward/transmit certain direct discovery sets that even if previously matched, they do not fulfill the network coverage situation of the UE-to-UE relay anymore.

In a further embodiment variant, the UE-to-UE Relay may be adapted or configured (e.g., with a policy) to check its coverage status before it relays a discovery message (Announcement Discovery message in Model A/Solicitation Discovery message in Model B) to a Target End UE, such that if the UE-to-UE Relay's coverage status has changed (e.g., moves from in-coverage to out-of-coverage or the other way around) from the point of time of receiving the discovery message, a different RSC e.g., RSC2, that is associated with the security procedures corresponding to the new coverage status is used in the second hop-by-hop link instead of the original RSC e.g., RSC1, received in the discovery message from the source UE.

In another embodiment variant, if the UE-to-UE Relay's coverage status changes between the time it receives a Discovery message from a Source End UE, and the time it relays said discovery message to a Target End UE, and the UE-to-UE Relay selects an RSC, e.g., RSC2, for the relayed Discovery message, associated with a different security procedure than the one associated with the RSC, RSC1, included in the received Discovery message from Source End UE, the UE-to-UE Relay may indicate to Source End UE a mismatch between security procedures to be used and/or the cause (e.g., change of coverage status).

In another embodiment variant, the change in the coverage status of the UE-to-UE relay may impact its decision to accept a discovery message or not. For instance, the UE-to-UE relay may be out-of-coverage and receive a discovery message including RSC1 bound to a PC5 security procedure with network assistance. Even if at the time of reception, the UE-to-UE relay may not be able to handle it, the UE-to-UE relay has to store the protected end-to-end discovery message/direct discovery set next to the validity time, and RSC1. The UE-to-UE relay may then check its coverage status at the time of sending the UE-to-UE discovery message and decide then whether the message is matched or not, and thus, transmitted or not.

In another embodiment variant, the change in the coverage status of the UE-to-UE Relay may impact its decision to relay the Discovery message (Announcement Discovery message in Model A/Solicitation Discovery message in Model B) and cause it to drop the discovery message, e.g., in case the UE-to-UE Relay is not provisioned with an RSC and/or long term credentials (e.g., if out of coverage) that correspond with its new coverage status. In certain scenarios, a UE (e.g., UE-to-UE Relay) that is out-of-coverage may be able to estimate/predict whether when and where it might move into 3GPP coverage, based on timing and location information of a mobile access device such as, vehicle mounted relay or a satellite part of a non-terrestrial network or a base station mounted on a UAV. Timing and location information can be deployed to devices, e.g., according to one of the conclusions related to KI #7 in TR 23.700-05, information (e.g., time duration and location information) may be deployed together with the CAG identifier for Mobile Base Station Relay (MBSR) that a UE can access. Similarly, according to clause 7.3.1.6 of TR 38.821, ephemeris information and UE location information can be used to help UEs perform measurements and cell selection/reselection. Considering the UE's ability to estimate when and/or where it may go into 3GPP coverage, the following embodiment can be considered:

In an embodiment variant, a UE-to-UE Relay or a UE-to-Network relay that is out-of-coverage may, based on the aforementioned estimations, determine whether to cache messages such as discovery messages including an RSC that is associated with security procedures with network assistance or DCR messages including an RSC that requires network assistance for the setup of the PC5 security link, based on their validity time and the time estimated to go into coverage, before they are transmitted, e.g., to a Target End UE or to the network.

In an embodiment variant, a UE-to-UE Relay that is in-coverage or out-coverage may, based on the aforementioned estimations, determine whether to relay/drop messages, e.g., discovery messages based on whether the security procedures or operations indicated in the message, e.g., by the RSC included in the discovery message(s), may or may not be supported by the time UEs (End UEs and UE-to-UE Relay) initiate through direct communication the PC5 link establishment procedure.

In an embodiment variant, a UE-to-UE Relay that is in-coverage or out-of-coverage may, based on the aforementioned estimations, announce (e.g., through Discovery Announcement Messages) its coverage schedule, such that End UEs may select the RSCs and subsequently security procedures that are supported by the UE-to-UE Relay by the time the PC5 link establishment procedure takes place.

In a more general definition of this embodiment, it is described a method by which a second device receives a discovery message from a first device, wherein the discovery message includes a relay service code that is associated with an indication determining the type of security procedures to be used during PC5 secure link establishment, wherein the second device evaluates whether to relay the discovery message to a third device, and if so, with which type of RSC, based on the following:
whether the coverage status of the second device changes between the time it receives the discovery message from the first device, and the time where it prepares the relayed discovery message to be sent to the third device, or whether the second device is (pre-)configured with a policy to maintain the same security procedure indicated by the first device through the relay service code, and drop discovery messages if a change in coverage status requires a change in the security procedures to be used, or
whether the second device is (pre-)configured with a policy to adapt or choose the RSC to its coverage status, such that, if required, an RSC supporting a different security procedure is selected for the second hop-by-hop link, whereby the first device may also be informed of the change in coverage status, and consequently the security procedures to be performed, or
whether the second device is (pre-)configured with a policy that enables the device to store discovery message, as long as they remain valid, and perform a check for whether the relay service code, and subsequently the security procedures, to be used are supported at the time of relayed discovery message transmission.

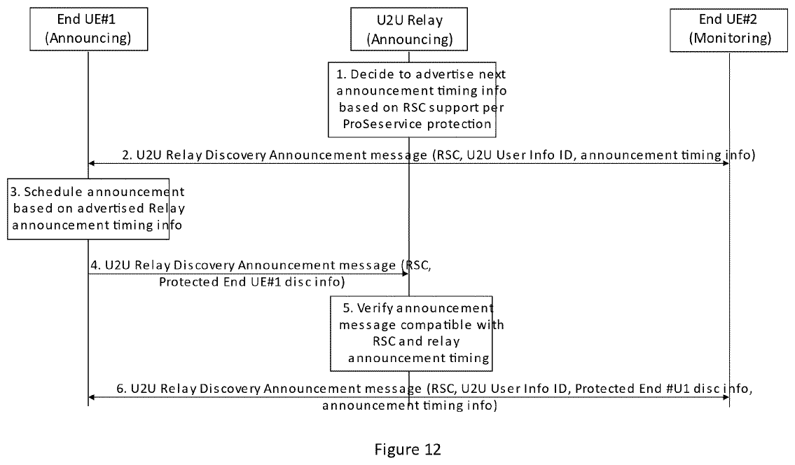

Regarding model A discovery procedu34etween34nedurer intended to ensure timely transmission of Relay Discovery announcement messages by the relay when transporting protected direct discovery sets from an Announcing End UE to a Monitoring End UE may assume two scenarios which are described as follows:
Scenario one (with reference to FIG. 12): The End UE is discoverable by actively sending announcement messages. The UE-to-UE Relay (1202) provides End UEs (1201 and 1203) with timing information about its next announcements to ensure close to real time transmission of protected direct discovery sets inside the Relay announcement message. The steps of the procedure described in FIG. 12 are as follows: Step 1210: UE-to-UE Relay can decide to advertise Relay announcement timing info based on an indication that RSC supports per direct discovery set protection. An example of timing info is a time window for when the Relay expects to receive the End UE's announcement for the End UE to be announced via the next Relay announcement.
Step 1211: UE-to-UE Relay can send a UE-to-UE Relay protected discovery message including RSC, UE-to-UE Relay User info ID and announcement timing info.
Step 1212: 1201 (Announcing-UE) schedules its next announcement message which may include a protected direct discovery set based on the received advertised Relay announcement timing info (e.g., ensures a timely transmission within advertised time window). 1203 (Monitoring-ue) aligns its listening for Relay Announcement messages based on the received advertised Relay announcement timing info.
Step 1213:1201 can send a protected UE-to-UE Relay discovery announcement message including RSC, and a protected direct discovery set from 1201.
Step 1214: 1202 verifies that Announcement message from 1201 is received within the acceptable time based on advertised Relay announcement timing info. 1202 may discard the Announcement message from End 1201 if not compliant with advertised Relay announcement timing info (e.g., outside time window).
Step 1215: 1202 sends a protected UE-to-UE Relay protected (announcement) discovery message including RSC, UE-to-UE Relay User info ID the protected direct discovery set received from 1201 according to advertised announcement timing info. 1203 (Monitoring-UE) receives the Relay Announcement at a time aligned with Relay advertised announcement timing info and discovers End UE #1 presence following the successful processing of the Relay discovery message and included protected direct discovery set of 1201.

Although, in this first scenario, UE-to-UE Relay attempts to ensure the discovery announcement message is relayed in a timely manner from Announcing UE to Monitoring UE, it does not necessarily guarantee the freshness of the direct discovery set. For instance, Although the discovery message UTC-based timer may be bound by the time window, thus guaranteeing MIC validity, the UTC-based counter used in computing the direct discovery set MIC may run out before the discovery announcement message reaches the Monitoring UE. In such case, Monitoring UE would discard the discovery announcement message. Furthermore, the approach described in this scenario does not include a verification step at the Monitoring UE's end. Thus, it is further object of the invention to address these issues.

In an embodiment, announcement timing info may refer to a time window, or the number of least significant bits to consider as a timing value used to compute the MIC over the discovery message, or the time during which a message may remain fresh, or the time during which messages may be cached by the relay. Thus, these parameters are provided by the relay (e.g., based on local policy) instead of being configured by a NF in the CN as in other embodiments.

In a further embodiment, the UE-to-UE Relay does not broadcast its timing information, but the timing information of the UE-to-UE Relay, in general, timing information associated with an RSC, is configured by the CN.

In an embodiment that may be combined with other embodiments, the ends UEs (Announcing and Monitoring UE) may be configured with a policy/indicator that determines the accuracy (e.g., number of LSBs of the UTC-based counter) difference e.g., as a factor, between the timing value announced by UE-to-UE Relay, and the timing value used to compute the MIC over the direct discovery set. This latter may be less accurate than the timing value announced by UE-to-UE Relay in order to ensure the direct discovery set remains valid when relayed. For instance, the least significant bit of the end to end timing value may have an accuracy of 2 seconds and the least significant bit of the hop by hop timing value may have an accuracy of 1 second. Additionally or alternatively, the end to end timing value may be longer than the hop by hop timing value, e.g., the end to end timing value may be the 8 LSBs of a UTC-based counter and the hop by hop timing value may be the 4 LSBs of a UTC-based counter. This has the advantage of allowing the UE-to-UE Relay to cache the message if needed, and still guarantee the direct discovery set MIC validity.

In an embodiment that may be combined with other embodiments, the ends UEs (Announcing and Monitoring UE) may be configured with a policy that determines the required number of LSBs of the UTC-based counter to be transmitted to make sure that the message may be validated by the other end UE taking into account the timing parameters of the UE-to-UE Relay. For example, if the relay sends messages every deltaT seconds, the End UEs may send messages including more than log 2(deltaT) bits so that the exact transmission time can be successfully corrected by the other UEs (e.g., monitoring UE).

In another embodiment, upon receiving the relay Discovery Announcement message, the Monitoring UE verifies whether the announcement message was received according to the advertised announcement timing info, undoes confidentiality/privacy protection if applied, and integrity verify the announcement message. Monitoring UE then verifies the direct discovery set is still valid based on the UTC-based counter, the configured timing value accuracy, and whether the MIC is still valid.

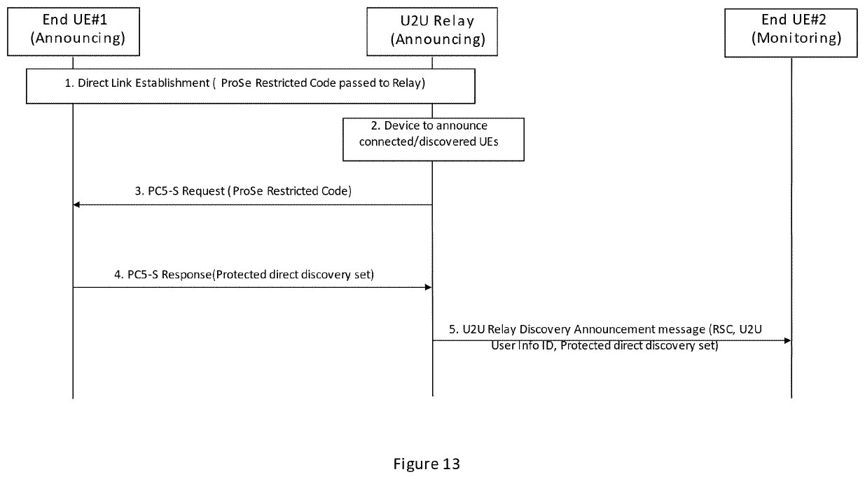

Scenario two (with reference to FIG. 13): The End UE is discoverable while being already connected (and not necessarily announcing) to the Relay. The Relay (1302) obtains the protected direct discovery set from the connected End UE (1301) on-demand to ensure close to real time transmission of the protected direct discovery set inside the Relay announcement message to a Monitoring UE (1303). The steps for the procedure described in FIG. 13 are as follows:
1.
Step 1310: The Announcing End UE (1301) can send with the RSC a ProSe Restricted code in the DCR message to the UE-to-UE Relay (1302), if the RSC is configured with an indicator for per direct discovery set protection and the ProSe service requires restricted discovery (i.e., End UE is provisioned with corresponding direct discovery set security material). The Relay verifies that the RSC supports per direct discovery set protection and stores the ProSe Restricted code in the PC5 unicast link context.
Step 1311: UE-to-UE Relay (1302) decides to announce connected UEs.
Step 1312: For each of the connected End UEs (1301) with a stored ProSe Restricted Code, 1302 sends a PC5-S request message including the ProSe Restricted Code previously received from 1301 to request a corresponding protected direct discovery set.
Step 1313: 1301 generates a secure PC5-S response message including RSC and a direct discovery set protected using the provisioned direct discovery security material. 1301 protects the PC5-S message using the PC5 link security context and sends it to 1302.
Step 1314: 1302 processes the PC5-S response message security and extracts the included protected direct discovery set(s). 1302 sends a UE-to-UE Relay protected discovery message including RSC, UE-to-UE Relay User info ID the protected direct discovery set received from 1301. the UE-to-UE Relay discovery message is protected using the security material associated with the RSC. 1303 (Monitoring UE) processes the security of the Relay discovery message security and of the included protected direct discovery set to discover 1301.

This approach assumes a PC5 secure link is already established between UE-to-UE Relay and the Announcing UE, wherein the UE-to-UE Relay triggers the discovery announcement message transmission from the Announcing UE by sending a PC5-S Request containing the ProSe Restricted Code obtained during Direct Link Establishment between the two UEs (i.e., Announcing and UE-to-UE Relay). A potential shortcoming of this approach is similar to the first scenario, and that is not guaranteeing the direct discovery set remains valid at the time the Discovery Announcement Message is delivered to the Monitoring UE. Another drawback is that the announcing UE depends on the UE-to-UE decision on when to distribute the discovery message (step 3 above). Hence, it is the subject of the following embodiments to address it.

In an embodiment, this approach may be further improved by incorporating aspects of the first scenario, namely, the timing information, into the procedure. For instance, UE-to-UE Relay may advertise next announcement timing information (e.g., similar to Step 1 in scenario 1) in the PC5-S Request in step 3 or separately. Announcing UE then sends a PC5-S Response (similar to step 4), where UE-to-UE Relay performs an adherence to timing check before relaying the direct discovery set in step 5 to Monitoring UE. When received by Monitoring UE, another adherence to timing check is performed before undoing the confidentiality/privacy protection of the Protected Direct Discovery set, and verifying its integrity.

In another embodiment variant, UE-to-UE Relay may advertise in the announcement timing information (e.g., time window, or number of UTC-counter LSBs to consider) to be used by the Announcing UE in computing the Direct Discovery set MIC. The Monitoring UE verifies the direct discovery set is still valid based on the UTC-based counter, the timing value announced by UE-to-UE Relay, and whether the MIC is still valid.

In another embodiment that may be combined with other embodiments, if UE-to-UE Relay advertises in an announcement the timing information (e.g., time window, or number of UTC-counter LSBs to consider), and multiple Announcing UEs are transmitting Announcement messages, the UE-to-UE Relay may be able to cache the announcement messages, aggregate them, and transmit them to the Monitoring UE as long as the individual Discovery Announcement messages received from Announcing UEs remain valid.

In an embodiment that may be used independently, the announcing UE is the one that communicates to the UE-to-UE Relay its transmission schedule, e.g., timing information, e.g., in Step 1 or Step 4 or in the discovery message itself. This makes sure that the UE-to-UE Relay is and/or can get ready for the relaying operation (e.g., by reserving resources). This also makes sure that the service (relaying) provided by the UE-to-UE Relay fits the needs (e.g., timing) of the announcing UE. In this embodiment, upon reception of the timing information of the announcing UE, the UE-to-UE Relay may confirm or reject or request a modification:
If confirmed, the announcing UE may then proceed to announce messages (e.g., step 4 above or as in other embodiments),
If rejected, the announcing UE may re-try, or search for a different UE-to-UE Relay,
   If a modification is required, the UE-to-UE may request a modification of the timing parameters. This modification may depend, e.g., on other announcin38etween38nnected to the UE-to-UE Rlay.

In an embodiment variant similar to previous ones, the announcing UE and UE-to-UE Relay may agree whether:
The announcing UE may send announcing messages (discovery messages) by itself (e.g., step 4 above), and/or
The announcing UE has to wait for an indication from the UE-to-UE Relay (step 3 above).

Above embodiment variants might be combined with each other or used together.

According to draftCR to TS 33.503 in TDoc S3-233374, Clause 6.1.3.3.3.1, Step 2, the UE-to-UE Relay may receive UE-to-UE discovery messages from an end UE (e.g., announcing UE, Discoverer-UE) containing protected direct discovery sets and/or receive protected direct discovery sets from an end UE (e.g., announcing UE, Disoverer-UE) that is already connected. The UE-to-UE Relay is capable of integrity verifying the messages protected with the DP_S-UE-to-UE, I.e., the discovery keys shared and used between the end UE and the UE-to-UE Relay. This integrity verification makes use of the UTC-based timer associated/used with those keys. However, this UTC-based timer may not be the same as the UTC-based timer associated to the protected direct discovery set (e.g., because the direct discovery set is protected before (i.e., first) the 5G ProSe UE-to-UE Relay Discovery or Communication message. This can lead to a situation in which the UE-to-UE Relay needs to decide what the validity of the protected discovery set is. This can be solved by means of different embodiment variants:

In an embodiment variant, the UE-to-UE Relay has to verify that the LSB of the received UTC-based timers are close to each other, e.g, that they differ by 0 (identical), or 1, or 2. Note that this difference needs to be computed modulo two to the power of the size of the LSB if the UTC-based counter, eg., if the UTC-based counter is 8 bits long, then 0xFF and 0x00 are close.

In an embodiment variant, the UE-to-UE Relay may use the time of the LSB of the UTC-based timer included in the direct discovery set to determine the validity time. This may be—one—even if the UE-to-UE Relay cannot directly verify it.

According to draftCR to TS 33.503 in TDoc S3-233374, Clause 6.1.3.3.3.1, Step 2, the UE-to-UE Rela—may—When broadcasting the Announcement me-age—include the list of valid protected direct discovery sets in the Announcement message and protect the Announcement message using the discovery security materials associated with the RSC as specified in clause 6.1.3.2.3 of TS 33.503. Then, the 5G ProSe UE-to-UE Relay sends the Announcement message. However, this can lead to the loss of some of the received direct discovery sets. In order to address this problem, in an embodiment variant, the UE-to-UE Relay may have a policy that allows storing the direct discovery sets for as long as they remain valid and a given condition applies, e.g., any of them is about expiring (e.g., expiration time—delta). When any of the direct discovery sets is about to expire, the UE-to-UE Relay includes the list of received protected direct discovery sets in the Announcement message and protects the Announcement message using the discovery security materials associated with the RSC, then broadcast it. This embodiment is advantageous because it limits/reduces the number of discarded messages.

In an embodiment variant, the UE-to-UE Relay may be provisioned with a policy or configured to broadcast Announcement messages containing direct discovery sets periodically or based on the direct discovery sets validity such that whichever condition is met first, an Announcement message is broadcasted. This has the advantage of reducing the number of expired direct discovery sets and the number of direct discovery sets to be included in the Announcement message as End UEs have more opportunities to receive the direct discovery set(s) and establish a communication link.

When the Monitoring UE(s) receive(s) the discovery announcement message broadcasted by the UE-to-UE Relay containing the direct discovery set(s), it unscrambles and/or decrypts and/or integrity verifies the discovery announcement message, and if successful, it extracts from it the direct discovery set(s), then verifies them. Since the direct discovery set(s) are protected as specified in clause 6.1.3.2.3 of TS 33.503, the order of the security operations is: Integrity protection, confidentiality protection, and finally scrambling, hence, to verify a direct discovery set, a Monitoring UE performs verification in the opposite order (i.e., unscrambling, decryption, and finally integrity verification). Also, in contrast to the restricted direct discovery scenario, where a ProSe Restricted Code is included in the discovery message, and matched based on a discovery filter as described in step 2, clause 6.1.3.4.3.3 of TS 33.303, in the UE-to-UE Relay discovery scenario, tables 10.2.1.12, 10.2.1.13, and 10.2.1.14 in TS 24.554, which describe the content of the UE-to-UE Relay discovery announcement, solicitation, and response messages respectively, and also the content of the UE-to-UE Relay discovery messages as defined in TS 23.304 (e.g., model B discovery in clause 6.3.2.4.3) do not specify/include the ProSe Restricted/App Code as an element of the end-to-end direct discovery set(s). Hence, the Monitoring UE has to verify each and every direct discovery set, as it cannot distinguish the one(s) intended for it, which increases the risk that a/some direct discovery set(s) may become unvalid by the time the Monitoring UE attempts to verify it/them. Furthermore, undoing the message-specific confidentiality is computationally intense, thus, having to undo confidentiality for each direct discovery set, and repeatedly with every received announcement discovery message would be very resource consuming. To remediate these issues, the following embodiments are proposed:

In an embodiment, the order of the security operations may be re-organized to: Confidentiality protection, Integrity protection, and finally scrambling, such that, if the direct discovery set(s) are scrambled, the Monitoring UE could unscramble and verify the integrity of the messages first, discard the unvalid direct discovery set(s), and then undo confidentiality.

In an embodiment variant, the MIC of the direct discovery set may not require scrambling protection, as such, the monitoring UE would have access to the MIC(s) directly and could verify the validity of the direct discovery set(s) first, then perform unscrambling (if applied), and finally undo confidentiality protection. Note that the MIC(s) of the direct discovery set(s) are protected as part of the discovery Announcement message by the UE-to-UE Relay.

In another embodiment aiming to assist the Monitoring UE(s) to distinguish between the direct discovery set(s) intended for it/them and the ones that are not, the Announcing End UE(s) may include the ProSe Restricted Code in the direct discovery set(s). The ProSe Restricted Code may not be confidentiality protected, and instead only scrambled (e.g., at the end) so as to enable the Monitoring End UE to access it quickly. This has the advantage of enabling the Monitoring UE to determine whether a direct discovery set is intended for it or not, without having to undo confidentiality protection.

In an additional embodiment, if the Announcing End UE(s) include ProSe Restricted Code(s) in the direct discovery set(s) and apply scrambling last, upon extracting the direct discovery set(s), the Monitoring UE(s) may unscramble and match the ProSe Restricted Codes first, and discard the direct discovery set(s) which is/are not intended for it, perform integrity verification, and finally undo confidentiality protection. This has the advantage of reducing the number of direct discovery set(s) to only the one(s) intended for the Monitoring UE, and also save resources as less MIC checks and confidentiality checks are performed.

In an embodiment, to enable ProSe Restricted Code addition without having it encrypted, the LENGTH parameter of the message-specific confidentiality mechanism for discovery described in A.7 of TS 33.503 may be changed to: LENGTH: LEN(discovery mes-age)−(LEN(ProSe Restricted Code)+LEN(UTC-based counter LSB)+LEN(MIC)), where LEN(x) is the length of x in number of bits.

In above embodiment (variants), the policy might be configured by the entity in the 5G CN configuring the discovery parameters, e.g., security keys such as DUIK, DUSK, DUCK.

Some processing steps in above description might be done from the point of view of, e.g., a sending or a receiving device. If the processing of the counterpart (e.g., receiving or sending device) is not described, then it must be understood to be the complementary. For instance, if a sending device is configured with a policy to not use a key for a given purpose in some circumstances, then the receiving device is also required with the same policy configuration not to use it. The flexibility provided by this policy is advantageous since it allows adapting the security/performance level depending on the communication situation.

In an embodiment that may be combined with other embodiments or used independently, during discovery, if UE-to-UE Relay is able to identify an End-UE with which a secure link has already been established (e.g., through a previous connection with said End-UE), the UE-to-UE Relay may reuse the security context (e.g., keying materials) to protect the discovery message relayed from (an) other End-UE(s) to the End-UE with which a security context is already established.

In an embodiment variant, the UE-to-UE Relay may be able to identify an End-UE (e.g., Target-UE) if the discovery message is protected with only one set of security materials (e.g., associated with RSC).

In an embodiment variant, in case two sets of security materials are used and the Direct Discovery set is only integrity protected, the UE-to-UE Relay may be able to identify the End-UE (e.g., Target-UE).

In another embodiment, if the Target-UE's User Info ID is long enough, an End-UE (e.g., Source-UE) may compute a pseudonym (PID) as a function e.g., a one-way function, e.g., a cryptographic function, based on the User Info ID of Target-UE (e.g., PID=Hash (Target-UE's User Info ID) and include it in e.g., the UE-to-UE Discovery set. The UE-to-UE Relay may try to identify whether a security context is established with the Target-UE by computing comparing the pseudonym received by Source-UE to PIDs computed using Target-UE User Info IDs of UEs it has an established secure link.

In an embodiment variant, Source-UE may add a salt/nonce as a parameter to the function used to compute PID, e.g., PID=Hash (salt, User Info ID of Target-UE) to avoid dictionary attacks. The salt/nonce value may be confidentiality protected and sent as part of the UE-to-UE discovery set.

In another alternative embodiment, or embodiment variant, if Source-UE has the Destination Layer-2 ID of Target-UE, Source-UE may send Target-UE's Destination Layer-2 ID protected (e.g., using hop-by-hop security keys i.e., associated with RSC) within the UE-to-UE Discovery set.

In an embodiment, where applicable, if a UE-to-UE Relay has or obtains an identifier of an End-UE (e.g., User Info ID or Destination Layer-2 ID), it may perform a check to determine whether a secure link is already established with said End-UE. Based on the policy provisioned to UE-to-UE Relay, if a secure link is already established, it may be reused to protect messages (e.g., discovery messages and/or direct communication messages) intended for the End-UE with which a security context is already established. This has the advantage of providing privacy/integrity protection independently of the ProSe Services being used and optimizing secure link establishment (e.g., skipping new Key Establishment and Direct Auth, and Security Mode Command procedures).

After the discovery phase, the UEs (i.e., End UEs and UE-to-UE Relay) may establish a secure PC5 communication link with network assistance (as per Clause 6.6.3.1 in draftCR in Tdoc S3-233374) reusing the security procedure defined in Clause 6.3.5 of TS 33.503, by replacing Remote UE by Source-UE and UE-to-Network by UE-to-UE Relay, in the first hop, and Remote UE by Target-UE and UE-to-Network by UE-to-UE Relay, in the second hop. However, for the DCR message relayed from UE-to-UE Relay to Target-UE, the content of the DCR message is different (e.g., it does not contain a PRUK-ID). It is therefore unclear how said DCR message is protected. Hence, the following embodiments:

In an embodiment, the same security procedure to protect the DCR message in Clause 6.3.5 in TS 33.503 is applied to protect the DCR message between Source-UE and UE-to-UE Relay as well as to protect the DCR message from UE-to-UE Relay to Target-UE. This has the advantage of reducing the code complexity because the same routine can be used for multiple types of DCR messages. However, the DCR message exchange between UE-to-UE Relay and Target-UE does not include a PRUK-ID (because it is the UE-to-UE Relay sending the message to the Target-UE). Thus, the UE-to-UE Relay sets the PRUK-ID field to a predefined value (e.g., all zeroes)—instead of Source-UE's PRUK-ID when sending the DCR message to the Target-UE. The Target-UE processes the incoming message according to Clause 6.3.5 in TS 33.503 and ignores the PRUK-ID field.

In an embodiment variant, if the UE-to-UE Relay sets the PRUK-ID to a pre-defined value (e.g., all zeroes), then upon receiving the DCR message, Target-UE undoes protection, and verifies if PRUK-ID is set to said pre-defined value.

In an embodiment variant, the UE-to-UE Relay sets the PRUK-ID field to a random value instead, then reuses the same security procedure to protect the DCR message to be sent to Target-UE.

In an embodiment variant, the UE-to-UE Relay removes PRUK-ID field of the received DCR message as received from the Source-UE since said PRUK-ID field is not required in the DCR message from UE-to-UE Relay to Target-UE and reuses the security routine in Clause 6.3.5 in TS 33.503. Since this security routine implies the confidentiality protection of more RSC and PRUK-ID, the resulting protected DCR message exchanged between UE-to-UE Relay and Target-UE protects some additional fields that usually are not protected. This embodiment variant is advantageous because a single security routine (as per Clause 6.3.5 in TS 33.503) is required to handle different types of DCR messages.

In a general definition of this, it is described a method and appa-tus—that can be implemented in a first d-ice—for securely protecting a discovery message by using a first set of keys and a second set of keys and optionally a policy and transmitting a second protected discovery message wherein the first device:
Protects the discovery message based on the first set of keys and the policy deriving a first discovery protected message, and
Protects the first discovery protected message based on the second set of keys and the policy deriving a second discovery protected message, and
Transmits the second discovery protected message.

Above first discovery protected message may also be referred to as first protected discovery message.

In general, it is described a method and appa-tus—that can be implemented in a third d-ice—for securely receiving and securely processing (that might include integrity verifying and/or unscrambling and/or decrypting) a third protected discovery message by using a first set of keys and a third set of keys and optionally a policy wherein the third device:
Receives a third protected discovery message, and
Securely processes the third protected discovery message based on the third set of keys and the policy deriving a first protected discovery message, and
securely processes the first protected discovery message based on the first set of keys and the policy deriving a discovery message.

In a more general definition of this embodiment, it is proposed a method and appa-tus—that can be implemented in a second d-ice—for securely receiving and securely processing (that might include integrity verifying and/or unscrambling and/or decrypting) a second protected discovery message by using a second set of keys and optionally a policy obtaining a first protected discovery message
and securely processing (that might include integrity protection and/or scrambling and/or encryption) the first protected message by using a third set of keys and optionally a policy and securely transmitting a third protected discovery message
wherein the third device:
Receives a second protected discovery message, and
securely processes the second protected discovery message based on the second set of keys and the policy deriving a first protected discovery message, and
securely processes the first protected discovery message based on the third set of keys and the policy deriving a third protected discovery message; and
transmits the third protected message.

In an option of this definition, it is proposed above methods and apparatuses which can be implemented on the first device for receiving the first set of keys and a second set of keys and optionally a policy from a fourth device.

In another option of this definition, it is above described methods and apparatuses which can be implemented on the second device for receiving the second set of keys and a third set of keys and optionally a policy from a fourth device.

In still another option of this definition, it is above described methods and apparatuses which can be implemented on the third device for receiving the first set of keys and a third set of keys and optionally a policy from a fourth device.

In still another option of this definition, it is above described methods and apparatuses in which the first set of keys (or/and the third set of keys) may be required to not contain a scrambling key.

In still another option of this definition, it is above described methods and apparatuses in which the policy requires that the protection of the discovery message based on the first set of keys must not involve scrambling if the discovery process of a third device is executed over a second device.

In still another option of this definition, it is above described methods and apparatuses in which the second protected message and/or the third protected message include two MICs.

In still another option of this definition, it is above described methods and apparatuses in which the second protected message and/or the third protected message include a single MIC that is renewed by the second device (I.e., verified the received MIC, and recomputed).

In still another option of this definition, it is described above methods and apparatuses in which the second protected (discovery) message includes two MICs (and end-to-end MIC and a hop-by-hop MIC) and the third protected (discovery) message includes a single MIC.

In still another option of this definition, it is described above methods and apparatuses in which the protection of the first protected message based on the second set of keys requires require Step 3 of clause 6.1.3.4.3.5 of TS 33.303 to be XOR (0xFFFF∥time-hash-bitsequence) with the most significant (L+16+16) bits of discovery message.

In still another option of this definition, it is described above methods and apparatuses in which the protection of the first protected message based on the second set of keys requires require Step 3 of clause 6.1.3.4.3.5 of TS 33.303 to be XOR (0xFFFFFFFF∥time-hash-bitsequence) with the most significant (L+16+16) bits of discovery message.

In still another option of this definition, it is described above methods and apparatuses in which the second MIC computed with an integrity key in the second set of keys is computed over the whole message including a MIC included in the first protected message.

In still another option of this definition, it is described above methods and apparatuses in which the second set of keys must not contain a confidentiality key.

In still another option of this definition, it is described above methods and apparatuses in which the policy requires that the protection of the message based on the second set of keys must not involve confidentiality protection if the first set of keys includes a confidentiality key.

In still another option of this definition, it is described above methods and apparatuses in which the policy requires that the protection of the discovery message is based on the integrity and confidentiality keys of the first set of keys and on the integrity and scrambling keys of the second set of keys.

It is to be noted that the above options may be used in various combinations or independently one from another.

It is to be noted that the above described apparatus may be implemented by a first device and/or a second device and/or a third device.

In general, it is described a system including a first device and a second device and a third device.

### Secure and Privacy-Aware Path Switching in Ue-to-Ue Relay Scenarios.

In a different use case under study in TR 33.740 v0.2.0, a Source-UE and a Target-UE communicating over a first UE-to-UE might need to perform a path switch from a first UE-to-UE Relay to a second UE-to-UE Relay. This functionality is required to, e.g., ensure the connectivity between Source-UE and Target-UE. The security and privacy of such a procedure is of paramount importance. For instance, in some solutions, the Source-UE first triggers a path switching in a first step. Then the Source-UE may send a Link Modification Message (including the candidate relay IDs, the Source-UE link ID, and security parameters) to the Target-UE. The Target-UE then may select a new relay and establishes new security keys and may reply with a Link Modification Accept (including the selected relay, and indicating the Target-UE link ID, and security parameters). The Source-UE may then establish new security keys and may send a Direct Communication Request including the (new) link ID of the Target-UE. The Target-UE may then locate and use new security keys to verify the DCR message and reply with a Direct Communication Accept (including the new Source-UE link ID). Upon reception of this Direct Communication Accept, then the Source-UE may locate and use new security keys to verify the Direct Communication Accept message. It is to be noted that the (e.g., Source-UE) link ID may be a locally generated random number by, e.g., the Source-UE. To avoid replay and linkability/trackability attacks across path switching procedures, a new Source-UE link ID is generated and used each time a new path switch is initiated, i.e., each time a Link Modification message for path switching is sent.

In some related solutions, it is proposed to perform the path switch by sending a Link Modification Request (TS 24.554) carrying a list including the candidate Relay identifiers (RIDs), as well as the Source-UE link ID, and security parameters. However, in such an approach it is unclear how the Source-UE might obtain an up to date list of RIDs. For instance, the Source-UE may have not gathered a list of UE-to-UE Relays during discovery, and even if it did, this list might be outdated.

In some solutions, it is proposed that the Source-UE performs the trigger of the path switching. However, in such an approach it is unclear how the Target-UE can trigger the path switching.

In some solutions, it is proposed that the Source-UE sends a Link Modification Request message and the Target-UE replies with a Link Modification Accept message that serves the purpose of establishing a new path. However, these messages seem to lack any security protection as per TS 24.554 even if they are used to establish a new path and keying materials are derived. In this situation, an attacker can inject link Modification Request message that can wrongly trigger a path switch procedure. Furthermore, any exchanged fields (e.g., new link IDs) are in the clear.

In some solutions, it is proposed to update the security keys during path switch. However, this might not always be required.

In some solutions, new identifiers such as link IDs need to be exchanged. However, this requires additional bandwidth and message modifications.

In a first embodiment that can be used independently or combined with other embodiments, it is proposed to enhance the Link Modification Request and Link Modification Accept messages with a message integrity code. This MIC may be computed with a NIA algorithm or it may be computed by means of a pseudo-random function over the the contents of the messages and a nonce or counter. For the counter, an UTC-based counter can be used from which the least significant bits are exchanged. The MIC can be computed using a key related to the current PC5 connection over the first UE-to-UE Relay, e.g., a key derived from K_NRP or K_NRP-sess. In this embodiment, a first UE (e.g., Source-UE) will construct one of those messages (e.g., Link Modification Message) including, e.g., a list of candidate RIDs and/or a Source-UE link ID, which is used on the Source-UE to associate the existing PC5 unicast link via Relay_1 to the new PC5 unicast link with the selected Relay (e.g. Relay_2) and/or Security parameters (i.e., nonce_1, MSB of K_{NRP-sess} ID). Next to it, it will append a counter, or part of it, and it will include a MIC computed over the contents of the message and counter. The second UE (e.g., Target-UE) will receive one of those messages (e.g., protected Link Modification Message) and will verify the received message by recomputing the MIC based on the received message and counter and comparing the recomputed MIC with the received MIC. If the verification is successful, the second UE can proceed with the normal message flow, e.g., as described above.

In a further embodiment that can be used independently or combined with other embodiments, it is proposed to perform discovery to trigger the UE-to-UE path switch. This might be done, e.g., as in FIG. 3 for discovery Model A or similarly for Model B including discovery response messages from the Target-UE towards the Source-UE. Model A and model B discovery messages can be protected as described in above embodiments. The difference compared with an initial UE-to-UE discovery is that in this subsequent UE-to-UE discovery both Source-UE and Target-UE already have an active PC5 connection over a given UE-to-UE Relay. Since the Source-UE is not aware of which other UE-to-UE Relays might be available, the Source-UE cannot include a list of potential relay identifiers, but it may include the ID of the current UE-to-UE Relay (i.e., the first UE-to-UE Relay) in the initial discovery message, e.g., solicitation or announcement discovery message. When a UE-to-UE Relay message forwards this discovery message from the Source-UE, the UE-to-UE Relay may not forward it if it is the UE-to-UE Relay currently handling the connection, i.e., if it is the first UE-to-UE Relay, since it may understand that the Source-UE is triggering a path switching procedure. The Target-UE will then receive discovery messages from all potential UE-to-UE Relay devices. It may or it may not receive a discovery message from the “first” UE-to-UE Relay device (if it did not forward the discovery message). In case that the Target-UE receives a message from the first UE-to-UE Relay and the Target-UE has an established connection with the Source-UE over this first UE-to-UE Relay, the Target-UE may only select it if it is the only option.

The Target-UE may then perform one or more of the following actions:
1. select none or one of the UE-to-UE Relays and reply back with a message (e.g., a discovery model B response message as per TS 33.503)) that will be relayed over the chosen UE-to-UE Relay to the Source-UE or with a link modification request including the selected relay.
2. Reply with a message (e.g., Link Modification Request or discovery message) including the list of potential UE-to-UE Relays.

In a further embodiment that can be used independently or combined with other embodiments, the returned list of potential UE-to-UE Relays returned by the Target-UE during discovery (e.g., as in the previous embodiment) is arranged according to its preferences.

In a further embodiment that can be used independently or combined with other embodiments, the list of potential UE-to-UE Relays sent by the Source-UE, e.g., in the Link Modification Accept, is arranged according to its preferences.

In a further embodiment that can be used independently or combined with other embodiments, the discovery messages used for path switching are enhanced with security parameters that will allow renewing the PC5 security context (K_NRPsess, etc) once established over the new UE-to-UE Relay. These security parameters may include nonce_1, MSB of K_{NRP-sess} ID. Upon reception of a first discovery message, e.g., a solicitation message, the Target-UE can security process the discovery message based on the description in this application or in TS 33.503 and use the received security parameters to derive new security parameters, e.g., generate a new K_{NRP-sess}.

In another embodiment that can be used independently or combined with other embodiments, the switch path procedure does not involve an update of K_{NRP-sess}, and thus, security parameters do not need to be exchanged.

In a further embodiment that can be used independently or combined with other embodiments, the discovery messages used for path switching may include a new (randomly generated) identifier, e.g., link ID, to prevent tracking and linkability.change

In a further embodiment that can be used independently or combined with other embodiments, the discovery messages used for path switching and including a new (randomly generated) identifier are confidentiality protected end-to-end, e.g., as described in above embodiments.

In further embodiment that can be used independently or combined with other embodiments, the discovery messages used for path switching may include the current Link ID that allow associating the discovery message with the existing PC5 unicast link.

In another embodiment that can be used independently or combined with other embodiments, the link IDs exchanged in the Link Modification Request or in the Link Modification Accept or in the discovery messages are confidentiality protected to prevent an attacker from performing a linkage attack where the protection might be done, e.g., by using a NEA algorithm and a key related to the current PC5 key.

In another embodiment that can be used independently or combined with other embodiments, the IDs, e.g., link IDs, exchanged in the Link Modification Request or in the Link Modification Accept or in the discovery messages are not confidentiality protected, but they are generated in a way that an attacker cannot link them. For instance, if a UE has an ID and a key, the UE might update the ID as ID′=LSB(KDF(K, ID)) where LSB(a) is a function returning a subset of the bits of a, e.g., the least significant bits and the UE send as ID′ hint computed as MSB (PRF(K, ID)) where MSB(a) is a function returning a subset of the bits of a, e.g., the most significant bits. KDF refers to a key derivation function.

In another embodiment that can be used independently or combined with other embodiments, the new link IDs to be used after path switching are not exchanged, e.g., they are not exchanged in the discovery messages or in Link modification request/accept messages, but those Link IDs are derived from either current or future keys associated to the UE-2-UE communication. For instance, the Link ID of the Source-UE might be derived by means of a key derivation function using the current key (e.g., K_NRP or K_NRP-sess) or the future key after path switch (e.g., K_NRP or K_NRP-sess)) and additional parameters such as, e.g., a bit string identifying the Source-UE or a UTC-based counter. The actual Link ID might be a subset, e.g., the least significant bits, of the output of the key derivation function. In this embodiment, no hint ID is exchanged.

In another embodiment that can be used independently or combined with other embodiments, the DCR message is protected as in TS 33.503 Clause 6.3.5, but the newly generated keys are used to protect the DCR message instead of the discovery keys as in Clause 6.3.5. Thus, if a Source-UE sends a DCR during a path switch procedure, the Source-UE protects it, e.g., with key derived from the current or future K_NRP-sess keys used in the PC5 link. A UE that has previously received message indicating the path switch (e.g., a discovery message or a Link Modification Request from a device it is currently connected to) and then receives a DCR message, then the UE will use the key derived from the current or future K_NRP-sess keys used in the PC5 link to decrypt/integrity verify the DCR message.

In another embodiment that can be used independently or combined with other embodiments, the Target-UE can trigger the path switching procedure by sending first an indication to the Source-UE. This indication of the path switch requirement might be exchanged by means of a Link Modification Request. This message might be sent empty or using a well defined identifier.

In another embodiment that can be used independently or combined with other embodiments, the Target-UE can trigger the path switching procedure and then the message flows are in the inverse fashion.

In another embodiment that can be used independently or combined with other embodiments, the derivation of new PC5 keys is performed by means of the direct communication exchange. In particular, the direct communication request includes security parameters such as nonce_1, MSB of K_{NRP-sess} ID and direct communication accept includes security parameters such as nonce_2. The session key K_{NRP-sess} is derived by the Target-UE upon reception of the DCR message and the session key K_{NRP-sess} is derived by the Source-UE upon reception of the DCA message. Previous phases, e.g., discovery phase and/or link modification phase, are used for the path discovery and/or link ID update.

In a further embodiment that can be used independently or combined with other embodiments, the path switch does not serve only the purpose of changing the path but also of securely enabling multipath communication between UEs. Thus, once two UEs have a establish path over a first UE-to-UE Relay, the Source-UE or Target-UE might run a path switch procedure with the goal of ensuring multipath communication, i.e., having more than one active communication path between Source-UE and Target-UE. In this case, the described embodiments can be used. It is advantageous to have different link IDs for different paths to hide the multipath capability. It is also advantageous to establish two or more different security context for each of the communication paths. In this case, the identity of the UE-to-UE Relay in each of the paths can be used by the UEs to derive different parameters. For instance, K_{NRP-sess} can be derived from KNRP by means of a KDF that takes as input the nonces Nonce_1 and Nonce_2 that are usually exchanged in authentication and key establishment procedures, e.g., TR 33.740, and the identity of the UE-to-UE Relay. In this way, a single set of parameters needs to be exchanged and different K_{NRP-sess} can be generated, one per link, i.e., a K_{NRP-sess} (relay ID) key. Similarly, the link IDs to be generated and used per communication path might be generated from a key such as KNRP Or K_{NRP-sess} (relay ID) by means of a KDF that takes as inputs that key and/or a time counter and/or the bitstring of the UE role (source/Target-UE) and/or the relay UE ID.

In another embodiment that can be used independently or combined with other embodiments, the overall process for a UE-to-UE Relay path switching includes (1) a discovery phase as in above embodiments and (2) the exchange of Direct Communication Request and Direct Communication Accept as described in other embodiments.

In another embodiment that can be used independently or combined with other embodiments, the overall process for a UE-to-UE Relay path switching includes (1) a discovery phase as in above embodiments and (2) the exchange of Link Modification Request/Link Modification Accept messages and (3) the exchange of Direct Communication Request and Direct Communication Accept messages as described in other embodiments.

In another embodiment that can be used independently or combined with other embodiments, the overall process for a UE-to-UE Relay path switching includes (1) the exchange of Link Modification Request/Link Modification Accept messages and (2) the exchange of Direct Communication Request and Direct Communication Accept messages as described in other embodiments.

The following table shows some of the multiple combinations feasible of previous embodiments to achieve the key functionality of path negotiation (i.e., determining the new UE-to-UE Relay), key update negotiation (i.e., deriving a new key for the PC5 link), link ID update (i.e., agreeing on/generating a new link ID, either implicitly or explicitly), and confirming (the new link).

| | Option 1 | Option 2 | Option 3 | Option 4 |
|---|---|---|---|---|
| Discovery phase | | Path negotiation, | Path negotiation, | Path |
| | | | key update | negotiation, |
| | | | negotiation, | link ID update |
| | | | link ID update | |
| Link | Path negotiation, | key update | | |
| Modification | Key update | negotiation, | | |
| phase | negotiation, | link ID update | | |
| | link ID update | | | |
| Direct | confirmation | confirmation | confirmation | key |
| communication | | | | negotiation, |
| phase | | | | confirmation |

In a general definition of another embodiment, it is proposed a method and apparatus for path switching that can be implemented on a device including one or several of the following phases:
a link modification phase consisting in the sending of a link modification and the reception of a link modification accept messages,
a direct communication phase consisting in the sending of a direct communication request and the reception a direct communication accept messages.
   Further, the secure exchange of new link IDs may include encrypting and integrity protecting when exchanged in link modification phase.

In general, it is proposed a method and apparatus as described above wherein the DCR message is protected as in Clause 6.3.5 in TS 33.503 using the newly generated keys.

In general, it is proposed a method and apparatus as described above preceeded by a discovery phase in which the link selection is performed in an initial discovery phase instead of in the link modification phase and the link modification phase serves the purpose of renewing the PC5 keys to be used after path switch and/or updating the link IDs.

In general, it is proposed a method and apparatus as described above preceeded by a discovery phase in which the link selection is supported by an initial discovery phase that returns the available UE-to-UE Relays to the Source-UE.

### Choice of Security Establishment Procedure During Path Switching

When securing the communication between Source-UE and Target-UE over a UE-to-UE Relay, a standard security establishment procedure may be used. A standard security procedure is a procedure used to establish security between a Source-UE and Target-UE over a UE-to-UE Relay when Source-UE and Target-UE are not communicating yet and/or have not established a security context yet. For instance, a standard security establishment solution may be a solution such as Solution #3 in TR 33.740 (this is an in-coverage solution that relies on the CN to perform the PC5 security establishment, i.e., it is a procedure with network assistance) or Solution #4 in TR 33.740 (as an out-of-coverage solution that does not rely on the core network for the PC5 security establishment, i.e., it is a procedure without network assistance).

Furthermore, it may be feasible to establish a secure link during path switching in UE-to-UE Relay scenarios wherein a Source-UE and a Target-UE that are communicating over a first UE to UE relay wish to communicate over a second UE-to-UE Relay. The (re-)establishment of this security link during path switching may be performed in an efficient manner by means of an optimized procedure, where an optimized procedure is more efficient than using a standard security establishment procedure, as described in above embodiments or as described in Solution #14 in TR 33.740.
However, it is not always possible to decide which security procedure to use, a standard one or an optimized one.
For instance, the initial communication over the first UE-to-UE Relay between a Source-UE and a Target-UE may have been established by means of a standard out-of-coverage solution. Then the second UE-to-UE Relay may be in coverage. It is the question: should the security during path switching rely on an optimized procedure (e.g., one of above embodiments optimized for path switching scenarios) or should it rely on a standard security establishment procedure (e.g., taking advantage of the fact that the second UE to UE relay is in coverage).

It is an aim to address this problem by means o54etween54nllowing embodiments that may be combined with each other.

In an embodiment, the method to establish a security context in case of UE-to-UE Relay path switching may be based on a policy provisioned to the UEs (e.g., Source-UE and/or Target-UE and/or UE-to-UE Relay). This policy may determine which security method/procedure is to be used or preferred, e.g., whether to skip a standard security establishment procedure and used an optimized procedure, e.g., by re-using the already established security context (e.g., security policy and security algorithms) from the previous PC5 unicast link e.g., for optimization purposes e.g., to allow a quicker link setup and path switching, and minimize service disruption. In this case, the security policy and security algorithms to be used e.g., for End-to-End security over a first relay, are not renegotiated again during the establishment of the new link over a second relay, and instead, only derive new security keys for the new link using the agreed upon security policy and security algorithms from the first link. In a related embodiment, skipping the standard security establishment procedure is subject to the policy provisioned to the UEs (e.g., Source-UE and/or Target-UE and/or UE-to-UE Relay) which may depend on factors including, but not limited to:
The UEs coverage situation, e.g., the coverage situation of the first UE-to-UE Relay and the coverage situation of the second UE-to-UE Relay,
Ultra Reliable Low Latency Communication (URLLC) requirements,
performance requirements, e.g., the maximum introduced delay that is wished during path switching for the application at hand,
whether the keying materials used to establish the original security context over the first UE-to-UE Relay are still valid/authorized at the time of performing path switching,
Optimization purposes.

In a related embodiment, re-using a security context from a first link (i.e., between Source-UE and Target-UE over a first UE-to-UE Relay) in a to-be established second link (i.e., between Source-UE and Target-UE over a second UE-to-UE Relay) may be subject to negotiation between the End UEs (e.g., Source-UE and Target-UE) and the second UE-to-UE Relay, wherein the outcome is determined based on UEs (Source-UE, Target-UE, UE-to-UE Relay) policies.

For instance, during the initial security establishment over the first UE-to-UE Relay the Target-UE and Source-UE may indicate whether they prefer the usage of a standard security establishment procedure during path switching or they prefer an optimized one as in above embodiments or e.g., in Solution #14 in TR 33.740 and the conditions for the usage the optimized one. This preference may be based on a policy configured, e.g., by a NF in the network. The negotiation may determine, e.g., that the optimized one may only be used if, e.g., both Target-UE and Source-UE agree.
For instance, a UE-to-UE Relay may have a policy determining that two end UEs (Source-UE and Target-UE) may only be allowed to perform path switching in an optimized way if the UE-to-UE Relay is out of coverage. If in coverage, then the standard security establishment procedure may be required otherwise.

In a related embodiment, end UEs (e.g., Source-UE and Target-UE) may want to establish a multipath communication between them over multiple relays. In such case, end UEs' policy may allow keeping the security context (e.g., security policy and security algorithms) from the first link, and only derive new security keys for other links (e.g., over other UE-to-UE Relays).

In another embodiment, when establishing a multipath communication and/or path switching, an End UE (e.g., Source or Target-UE) may announce during discovery that it already has a security context established and/or wishes to re-use it when available, such that UE-to-UE Relays provisioned with a policy that supports/does not support this approach may determine whether to establish/not establish a link with said End UE.

In an embodiment, the Source-UE may send a first message corresponding to the preferred security procedure for path switching, e.g., as agreed during the initial security establishment procedure over the first UE-to-UE Relay. The second UE-to-UE Relay may then evaluate its local policy and determine whether this security procedure is suitable or not. If it is not, it may, e.g., reject the request, and/or ignore the request, and/or indicate to the Source-UE that a different security procedure for path switching is required.

In an embodiment, the Source-UE may obtain the preferences of a UE-to-UE Relay regarding the type of security establishment to be used, e.g., depending on the coverage conditions or service provided. These preferences may be obtained, e.g., during the initial security establishment procedure over the first UE-to-UE Relay and/or by other means, e.g., listening and receiving discovery messages from a second UE-to-UE Relay that may indicate its preference or coverage status. Based on this information, and/or the initial negotiation between the Source-UE and Target-UE during the initial security establishment procedure over the first UE to UE relay and/or the local policy at the Source-UE, the Source-UE chooses the security procedure to be used during path switching.

In general, it is proposed a method and apparatus for negotiating the security procedure to use between a Source-UE and a Target-UE when switching paths from a first UE-to-UE Relay to a second UE-to-UE Relay adapted to perform one or more of the following steps:
a) Receiving a configuration/policy to determine the path switching security procedure,
b) Negotiating during a first security establishment procedure over a first UE-to-UE Relay the negotiated preferences for a subsequent path switching procedure,
c) Receiving information regarding the coverage status of a second UE-to-UE Relay,
d) Choosing a security procedure for path switching based on at least one of:
   a. Configuration/policy,
   b. Negotiated preferences, and
   c. Coverage status of the second UE-to-UE Relay.

### Protection of DCR Message and PC5 Security Establishment in Integrated Discovery

TR 23.700-33 describes the need for discovery integrated into PC5 unicast link establishment procedure in the UE-to-UE Relay scenario. This procedure could largely reuse the mechanism of Restricted Discovery procedure and Direct Security Establishment procedure defined in TS 33.503. However, in such an integrated procedure, the Source-UE does not search for a suitable UE-to-UE Relay by means of discovery messages, but instead, it relies on the Direct Communication Request, i.e., it is done in an integrated manner.

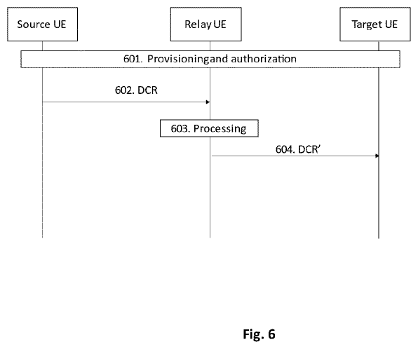

This is illustrated by means of FIG. 6 where a Source-UE, a UE-to-UE Relay, and a Target-UE interact with each other to establish a PC5 unicast link. In a first step 601, the UEs are configured, e.g., with keying materials if authorized. In Step 602, the Source-UE sends message DCR to UE-to-UE Relay. In Step 603, message DCR is processed. In Step 604, UE-to-UE Relay sends message DCR′ to TUE.

TS 33.503 describes how to protect discovery messages (Clause 6.1.3.2.3). TS 33.503 describes also how to protect certain fields of DCR messages in UE-to-Network relay scenarios (Clause 6.3.5). However, these procedures do not solve how to protect the DCR message in UE-to-UE Relay integrated discovery use cases.

An aim of this invention is to address this issue.

In an embodiment that may be combined with other embodiments, the Security Information field in the DCR message with integrated discovery may be sent unprotected.

A first consideration is that discovery messages are scrambled/confidentiality protected/integrity protected as per Clause 6.1.3.2.3 of TS 33.503. DCR messages as per Clause 6.3.5 are integrity protected and partially encrypted. The problem arises from the fact that message DCR (Step 602) and message DCR′ (Step 604) do not have the same format and thus the protection routines cannot be reused.

For instance, assume that DCR contains (encapsulates) a standard discovery message, e.g., U2U discovery message for discovering the Target-UE and that Target-UE and the UE-to-UE Relay have established a secure connection using the security mechanism specified in clause 6.2 of TS 33.503 in a subsequent step. This refers to Clause 5.3 in TS 33.536.

In an embodiment, the whole DCR is protected as if it is a discovery message as in or similar to Clause 6.1.3.2.3 of TS 33.503. Some changes may be required:
Scrambling may not be limited to 32 bytes because the DCR′ message may be longer and/or more sensitive fields may be present.
The scrambled bytes may be such to hide the initial part of the encapsulated discovery message.
The DCR′ message may be structured to include in the beginning of the DCR′ message the (fields of) discovery message followed by the remaining fields of the DCR message (e.g., PRUK ID or nonce or other parameters) so that the security routines in Clause 6.1.3.2.3 of TS 33.503 are applicable.

A further embodiment is to protect some fields of the DCR′ message similar to TS 33.503 Clause 6.3.5 and the field encapsulating the discovery message as in Clause 6.1.3.2.3 of TS 33.503. When receiving the message, the receiving party may first retrieve the discovery message (unscramble, decrypt, MIC verify) and then retrieve the remaining fields of DCR′ message.

In a further embodiment, the DCR′ message is verified by performing blind decryption/unscrambling since when the DCR′ message is received the relay UE is not aware of the discovery code (e.g., a relay code) contained in the discovery message.

In a further embodiment, a UE (e.g., UE-to-UE Relay/Target-UE) has to try multiple keys (e.g., scrambling keys) to have access to message type, relay service code, and/or other identifier type in the DCR (DCR′) message that can be used to determine the integrity/encryption keys to used in the processing of the DCR (DCR′) message. This is a difference compared with the processing of a DCR message in Clause 6.5.3 in TS 33.503 where a U2N relay may already know which keys to use based on the previous discovery phase.

In a further embodiment, a field in the DCR′ message is useful (i.e., included and used) to determine the RSC or encryption keys or integrity keys is scrambled.

In a further embodiment, one or more preconfigured keys (e.g., linked to the RSC) may be used to protect the fields of the DCR (except the integrated discovery message) and discovery keys may be used to protect the integrated discovery message.

In a further embodiment, the integrated discovery message includes a field (e.g., integrated_discovery_indication), which may be on or off (or present/not present) and determines whether the discovery is integrated or not and/or whether it is protected or not. This might be explicit or implicit. This field may also be integrity protected to ensure that an attacker cannot replay the discovery message in an integrated discovery message as a normal discovery message.

In a further embodiment, an indication (e.g., the integrated discovery indication) indicates whether the message is protected or not.

In a further embodiment, an indication (e.g., the integrated discovery indication) may indicate the type of protection (e.g., confidentiality and/or integrity) applied to the integrated discovery message and/or whether the protection applies to the integrated discovery message or the whole DCR message.

In a further embodiment, an indication (e.g., the integrated discovery indication) may serve to enable interoperability with V2X-enabled devices.

In another embodiment variant, the integrated_discovery_indication may be confidentiality and/or integrity protected as part of the direct discovery set elements.

In a further embodiment, the Relay Service Code (RSC) provisioned at UEs (e.g., Source, Target, and UE-to-UE Relay) may implicitly indicate whether the discovery is integrated or not and/or whether it is protected or not.

In another embodiment variant, the ProSe Restricted Code provisioned at End UEs (e.g., Source and Target-UE) may implicitly indicate whether the direct discovery set is integrated or not.

Other embodiments in this filing, e.g., relying on two sets of discovery keys may be applicable.

Other embodiments in this filing, e.g., applicable to UE-to-UE Relay discovery security may be applicable.

In an embodiment, the UEs (e.g., Source-UE and Target-UE) may be provisioned with two sets of keying materials such that, the first set of keys (e.g., DP_S-T) is used to protect the direct discovery set elements, and the second set of keys (e.g., DP_S-UE-to-UE and/or DP_UE-to-UE-T) is used to protect the UE-to-UE discovery set elements, the whole UE-to-UE discovery message, part of DCR message (e.g., sensitive fields in the DCR message and discovery message), or the whole DCR message. Note that here and in other parts of the description, direct discovery set (elements) and UE-to-UE discovery set (elements) refer to the two sets of elements in a discovery message.

In another embodiment variant, the Source-UE may use the first set of keys (e.g., DP_S-T) to protect the direct discovery set elements, and the second set of keys (e.g., DP_S-UE-to-UE) to protect only the UE-to-UE discovery set elements, such that Target-UE is able to retrieve the direct discovery set if e.g., Target-UE receives the DCR message with integrated discovery directly from Source-UE.

In another embodiment variant, the DP_S-UE-to-UE are used to integrity protect the whole DCR message so that the relay can verify it, however, the DP_S-UE-to-UE is only used to scramble/confidentiality protect fields that are required for the relay itself.

In an embodiment, the integrated discovery message includes an indication determining whether the message is protected with a single set of keys (e.g., DP_S-UE-to-UE/DP_UE-to-UE-T) or with two sets of keys (e.g., DP_S-UE-to-UE/DP_UE-to-UE-T and DP_S-T)

In an embodiment, if the DCR message includes the User Info ID of the Target-UE, and the UE-to-UE Relay receiving the DCR message has an already established secure context with the Target-UE, DCR′ may be protected based on the set of keys corresponding to the established security context.

In an embodiment, if the Source-UE and Target-UE have an established connection and one of the End-UEs decides to path switch (e.g., due to link deterioration) to communicate over a UE-to-UE Relay, the End-UEs may maintain and re-use the already established security context (e.g., security policy and algorithms) after hop-by-hop secure links are established between Source-UE and UE-to-UE Relay and UE-to-UE Relay and Target-UE.

In an embodiment, one or more UEs (e.g., Source-UE, and/or Target-UE, and/or UE-to-UE Relay UE) may be (pre-)configured or provisioned with a policy that indicates which communication path and/or message type is prioritized e.g., if a UE, e.g., Target-UE, receives one ore more messages (types) over one or two paths, e.g.,
DCR message from a UE-to-UE Relay, and/or
DCR message from Source-UE, and/or
Direct discovery message, and/or
UE-to-UE discovery message

A UE, e.g., Target-UE, may be configured to prioritize a message or path, e.g., a direct connection with Source-UE). This may depend on a policy and/or communication conditions (e.g., coverage situation, signal strength, etc). This allows for a better handling of the overall discovery process.
Which keying materials are used to protect which data fields in the DCR message. For instance, the DCR message may be protected with one or two sets of keys to protect the UE-to-UE discovery message fields and another (set of) keys to protect the DCR fields, excluding the UE-to-UE discovery message. Or the DCR message may be protected with two sets of keys where the DCR message fields are protected with the DP_S-UE-to-UE/DP_UE-to-UE-T and DP_S-T keying materials.
What form of protection is applied, on which data fields of the DCR message, and under which conditions. (e.g., which fields are scrambled/encrypted and integrity protected, which are only integrity protected and using which keys).
How the Target-UE deals with the UE-to-UE discovery set elements (e.g., relay indication, RSC) if it receives the DCR message directly from Source-UE and chooses a direct communication path with Source-UE e.g., verify the DCR MIC, and discard the UE-to-UE discovery set and process (e.g., unscramble/decrypt/integrity verify) only the direct discovery set).
Which security mechanism is used by UE-to-UE Relay to protect DCR′ e.g., based on whether the DCR message contains the User Info ID of Target-UE, or there being a security context already established between UE-to-UE and Target-UE.

In general, we can differentiate between two scenarios: the DCR message broadcasted by the Source-UE could either be relayed by one (or multiple UE-to-UE Relays), or received directly by Target-UE. Regardless of how the DCR message reaches Target-UE, Target-UE should always be able to process the received message, e.g., unscramble and/or decrypt and/or verify the integrity of the content (e.g., discovery message) of the DCR message received. As such, we may consider the following:

In an embodiment, the same security materials (e.g., encryption/scrambling/integrity keys) could be used to protect the first hop-by-hop link (i.e., between Source-UE and UE-to-UE Relay) and the second hop-by-hop link (i.e., between UE-to-UE Relay and Target-UE) such that the DCR message could be decrypted and/or unscrambled and/or integrity verified regardless of whether the Target-UE receives the DCR message directly or through a UE-to-UE Relay.

In another embodiment, UE-to-UE Relay(s) may be (pre-)configured or provisioned with a policy that determines how a DCR message with integrated discovery should be constructed and protected when relayed to a Target-UE, depending on e.g., whether UE-to-UE Relay can identify the Target-UE (i.e., depending on whether DCR contains the User Info ID of Target-UE), and/or if it already has a security context established with said Target-UE. For instance:

Example 1: If a UE-to-UE Relay cannot identify Target-UE (e.g., the User Info ID of T-UE is not included in the DCR message), the UE-to-UE Relay may process the DCR message (i.e., unscramble and/or decrypt and/or verify the integrity of the Discovery message), if the required verifications are successful, the UE-to-UE Relay constructs another DCR message (e.g., DCR′) by e.g., discarding the relay_indication, and/or including an integrated discovery indication, and/or changing the RSC, and adding the User Info ID of the UE-to-UE Relay to DCR′, where it protects the UE-to-UE Discovery set elements similarly to Source-UE. If applicable, UE-to-UE Relay may re-use the security materials (e.g., first hop-by-hop security materials) used to protect the UE-to-UE discovery set in the DCR message to protect the UE-to-UE discovery set in DCR′ (e.g., second hop-by-hop security materials i.e., keep the same RSC). Alternatively, the UE-to-UE Relay may use different security materials than the ones used in the first hop-by-hop link i.e., change RSC in DCR′, and eventually broadcast the protected DCR′ message.

Example 2: If a UE-to-UE Relay processes the DCR message (e.g., similarly to the scenario above) and identifies the Target-UE (e.g., through User Info ID or Destination Layer-2 ID of Target-UE). If a security context is already established with this Target-UE, the UE-to-UE Relay may construct a subsequent message (e.g., DCR′) as follows: discard the relay_indication, and if not included already, include an integrated discovery indication, and include only the Direct Discovery set of elements from the integrated Discovery message. The entire (or part of the) message may then be protected based on the keying materials corresponding to the established security context.

In another embodiment, the UE-to-UE Relay may be able to identify the Target-UE (e.g., through User Info ID of T-UE in the DCR message or Destination Layer-2 ID of Target-UE), in which case it may establish a secure unicast link with Target-UE following the procedure defined in clause 5.3 of TS 33.536, wherein, UE-to-UE Relay transmits DCR′ (including UE-to-UE Relay Info User ID) which includes the end-to-end protected direct discovery set, in addition to the Key_Est_Info/Security Information used for direct auth and key establishment between UE-to-UE Relay and Target-UE.

In an embodiment, the Target-UE User Info ID may be protected as part of the UE-to-UE Discovery set such that a UE-to-UE Relay could identify the Target-UE when a DCR message with integrated discovery is received.

In a further embodiment, Source-UE may compute a pseudonym (PID) as a function, e.g., a one-way function, e.g., a cryptographic hash, based on the ID, e.g., PID=Hash (Target-UE's User Info ID). The Source-UE may send PID as part of the UE-to-UE discovery set, or unprotected in another field of the DCR message. This approach may be applicable, in particular, when the Target-UE User Info ID is long enough.

In another embodiment variant, Source-UE may add a salt/nonce as a parameter to the function used to compute PID, e.g., PID=Hash (salt, Target-UE's User Info ID) to avoid dictionary attacks. The salt/nonce value may be protected and sent as part of the UE-to-UE discovery set.

In another embodiment, the UE-to-UE Relay may use the received PID and/or the received ID to determine whether the UE-to-UE Relay has already a secure connection with the Target-UE. This allows then the UE-to-UE Relay to protect the message (e.g., direct discovery set) with the corresponding keys/key from the security context already established.

In another embodiment variant, if Source-UE has the Destination Layer-2 ID of target 5G ProSe End UE, it may be transmitted instead of, or alongside, Target-UE's User Info ID, as described in the above embodiments, while Target-UE's User Info ID is protected and sent as part of the Direct discovery set.

In another embodiment, the UE-to-UE Relay may be able to identify the Target-UE (e.g., through User Info ID of Target-UE, or Destination Layer-2 ID in the DCR message) and have a secure link already established with it (e.g., through a previous link setup with another Source-UE). In such case, UE-to-UE Relay may transmit the DCR′ message protected using the security materials from the already established security context. Moreover, as a secure link is already established, Direct Auth and Key Establishment, and Direct Security Mode Command procedures may be skipped between the UE-to-UE Relay and Target-UE.

In another embodiment, the UE-to-UE Relay may use a Default Destination Layer-2 ID it was provisioned with, as per clause 5.1.5.1 of TS 23.304, which may be associated with a Target-UE with which the UE-to-UE Relay might already have a secure link established. In this case, similar to above embodiments, the UE-to-UE Relay may reuse the keying materials associated with the established security context to protect DCR′ when relaying it to the Target-UE. In other words, there is a mapping between Default Destination Layer-2 ID and Target-UE so that the UE-to-UE Relay knows which security keying materials to use given then Default Destination Layer-2 ID.

In another embodiment, if a UE-to-UE Relay receives a DCR message with integrated discovery, and has a secure link already established with Target-UE, the UE-to-UE Relay may remove the UE-to-UE discovery set element (e.g., RSC, Security Information) from DCR′ sent to Target-UE.

In another embodiment variant, the UE-to-UE Relay's reuse of an existing security context with an End-UE (e.g., Target-UE) is not limited to integrated discovery scenario, but may also be applicable to, e.g., a normal discovery procedure. That is, during the discovery phase, if Source-UE intends to establish a secure link with a Target-UE over a UE-to-UE Relay, if the UE-to-UE Relay already has a secure link established with said Target-UE, UE-to-UE Relay may reuse the keying materials associated with the established context. The UE-to-UE Relay's reuse of existing security context may also be applicable to other security procedures. For instance, in Sol #3 in TR 33.740 v0.7.0, 63etweedescribed how a secure link is established between two End-UEs with network assistance. If UE₁ and UE₂ already communicate over a UE-to-UE Relay, and then UE₃ wishes to communicate with UE₂ over the same UE-to-UE Relay, UE₃ and UE-to-UE Relay need to establish the secure link as described, e.g., in Sol #3 in TR 33.740, but the security context between UE₂ and UE-to-UE Relay can be kept and reused and does not need to be reestablished.

In another embodiment, all or part of the embodiments related to reusing of an existing security context between a UE-to-UE Relay and an End-UE (e.g., Target-UE) may be combined with other embodiments or used independently, and may be applicable to integrated and normal discovery procedures.

In another embodiment, the UE-to-UE Relay may be unable to identify the Target-UE, in which case the UE-to-UE Relay may have to broadcast DCR′. According to clause 5.5.3.1 in TS 33.536, there are no particular procedures defined for securing the NR based PC5 broadcast mode, as such, the UE-to-UE Relay may protect DCR′ as if it is a discovery message as in, or similar, to Clause 6.1.3.2.3 of TS 33.503, wherein the required changes are applied as described in the embodiment above.

In another embodiment variant, if UE-to-UE Relay supports multiple protection mechanisms, the choice of the security mechanism employed may be configured by the network (e.g., through a policy). Moreover, UE-to-UE Relay may include in the DCR′ message an indication of which protection mechanism was employed to protect the message.

In another embodiment, if the UE-to-UE Relay is in 3GPP coverage, the network may assist by e.g., providing keying materials e.g., DUIK/DUSK/DUCK to scramble/encrypt/integrity protect the DCR′ message, and/or by providing security policies e.g., to determine which security approach to adopt (e.g., establish new secure link or use established security context).

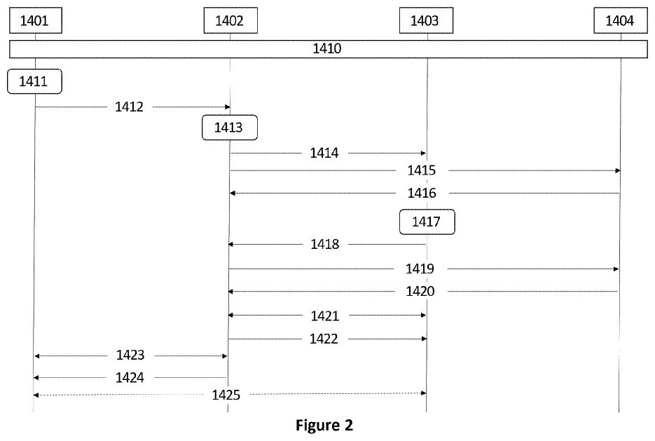

In another embodiment with reference to FIG. 2 the usage of above techniques is illustrated, where the UE-to-UE Relay is in 3GPP coverage and is supported by the network, the establishment of hop-by-hop secure links between Source-UE and the UE-to-UE Relay and between the UE-to-UE Relay and Target-UE may be performed as follows, whereby (1) not all steps may always be required, (2) some of the steps may be executed multiple times and (3) some steps may be executed in a different order:

With 1401 representing an End UE (e.g., Source-UE), 1402 a UE-to-UE Relay, 1403 an End UE (e.g., Target-UE), and 1404 representing the 5GC, secure hop-by-hop links between UEs may be established as in the following steps below:
Step 1410: UEs are provisioned with discovery parameters, keying materials to establish a PC5 secure communication link, etc when in-coverage.
Step 1411: Constructs a DCR message with integrated discovery similarly to step 1 in FIG. 12. Source-UE may include in the Security Information field (e.g., as defined in clause 6.4.3.7.4 in TS 23.304) of the DCR message the PRUK-ID₁ and K_{NRP1} freshness parameter 1. The integrated discovery message is protected similarly to step 1 in FIG. 12 (i.e., using discovery security materials provisioned in step 1410).
Step 1412: Source-UE broadcasts the protected DCR message with integrated discovery.
Step 1413: UE-to-UE Relay processes the received DCR message, decrypts/unscrambles/integrity verifies the protected integrated discovery/DCR message, extracts the RSC1, the PRUK-ID₁, and K_{NRP1} freshness parameter 1, and then constructs DCR′ including its User Info ID then sends it to Target-UE whereby the DCR′ message may include some of these parameters, e.g., RSC_{1/2} privacy protected while DCR′ is integrity protected.
Step 1414: The UE-to-UE Relay transmits the DCR′ to Target-UE. This step may occur before, after, or concurrently with steps 1415 and 1416.
Steps 1415/1416: The UE-to-UE Relay sends a Key Request to the 5GC containing one or more of RSC1, PRUK-ID₁, and the K_{NRP1} freshness parameter 1 retrieved from the DCR message in step 1413, then receives K_{NRP1} and K_{NRP1} freshness parameter 2 from 5GC. This step may also happen at a later point of time, e.g., once the secure connection between UE-to-UE Relay and Target-UE has been established. Message 1415 may include the identity of the Target-UE (PRUK-ID₂) so that the core network can verify whether the Source-UE is authorized to communicate with the Target-UE. If performed before (e.g., before Step 1414), then the UE-to-UE Relay can be sure that the Source-UE is authorized so that the Target-UE only receives the DCR′ message in this event. If performed later, e.g., after Step 1414, or even after Step 1419/1420, the UE-to-UE Relay can make sure that the Target-UE is authorized/willing to communicate with the Source-UE so that the core network is only involved in this case.
Step 1417: Target-UE may receive multiple DCR messages (e.g., from one or more UE-to-UE Relays); for simplicity, FIG. 2 shows a single DCR message e.g., DCR′, as sent in step 1414. Target-UE processes the DCR′ message, decrypts/unscrambles/integrity verifies the protected integrated discovery/DCR message, then based on whether a security context is already established with the UE-to-UE Relay and policy evaluation, Target-UE decides whether to (re)-establish a secure link with the UE-to-UE Relay.
Step 1418: If Target-UE is to (re)-establish a secure link with the UE-to-UE Relay, Target-UE sends a Direct Auth and Key Establishment Request containing RSC2, PRUK-ID₂, and a K_{NRP2} freshness parameter 1, which are protected similarly to step 1411.
Steps 1419/1420: Similar to steps 1415/1416, UE-to-UE Relay sends a Key Request to 5GC with the parameters (i.e., RSC2, PRUK-ID₂, and K_{NRP2} freshness parameter 1) to the core network, and receives a Key Response message containing K_{NRP2}, and K_{NRP2} freshness parameter 2. In Steps 1419/1420, the UE-to-UE Relay may also include the identity of the Source-UE (PRUK-ID₁) so that the 5GC can verify whether both UEs are authorized to communicate with each other.
Step 1421: Direct Security Mode Command procedure where UE-to-UE Relay transmits K_{NRP2} freshness parameter 2 to Target-UE in a Direct Security Mode Command message, then Target-UE derives K_{NRP2} from its PRUK, RSC2, K_{NRP2} freshness parameter 1, and K_{NRP2} freshness parameter 2. Successful verification of Direct Security Mode Command assures Target-UE that UE-to-UE Relay is authorized to provide relay services. If the verification is successful, Target-UE sends a Direct Security Mode Complete message to UE-to-UE Relay.
Step 1422: Upon receiving the Direct Security Mode Complete message from Target-UE, UE-to-UE Relay verifies whether Target-UE is authorized to get relay services. If the verification is successful, UE-to-UE Relay sends a Direct Communication Accept message to Target-UE to complete the secure link establishment procedure.
Steps 1423/1424: Similar to steps 1421/1422, a secure link is established between Source-UE and UE-to-UE Relay.
Step 1425: If the UE-to-UE Relay communication link is established through a Layer-2 UE-to-UE Relay, an end-to-end secure link is established between End UEs (i.e., Source and Target-UE).
   Steps 1423 and 1424 may be performed after step 1416, concurrently, or after a secure link is established between UE-to-UE Relay and Target-UE.

In an embodiment, in step 1421, UE-to-UE sends a Direct Auth and Key Establishment Response containing K_{NRP2} freshness parameter 2 to Target-UE. Then, Target-UE derives K_{NRP2} from its PRUK, RSC2, K_{NRP2} freshness parameter 1, and K_{NRP2} freshness parameter 2. Following that, step Target-UE sends a Direct Security Mode Command message to UE-to-UE Relay containing e.g., MSB of K_{NRP2} ID. Successful verification of Security Mode Command message ensures UE-to-UE Relay that Target-UE is authorized to receive relay services. UE-to-UE Relay then sends a Security Mode Complete message to Target-UE containing e.g., LSB of K_{NRP2} ID to Target-UE. Upon receiving the Security Mode Complete messagthessfull verification, Target-UE is ensured that UE-to-UE Relay is authorized to provide relay services, and then sends (e.g., in step 1422) a Direct Communication Accept message to UE-to-UE Relay to complete the secure link establishment procedure.

In a related embodiment that may be combined with other embodiments for integrated discovery or used independently, DCR′ which is sent (in step 1414) from UE-to-UE Relay to Target-UE does not contain PRUK-ID, as such only RSC2 is confidentiality protected, while DCR′ is integrity protected. Therefore, the confidentiality protection routine in Clause 6.3.5 of TS 33.503 is updated so that only the RSC is encrypted. As such, in Annex A.5 in TS 33.503, the DCR confidentiality keystream is set to L least significant bits of the output of the KDF, where L=the length of the RSC.

In an embodiment variant, DCR′ which is sent in step from UE-to-UE Relay to Target-UE does not contain PRUK-ID, hence, the PRUK-ID field may be set to a pre-defined value (e.g., all zeroes), or a random value, such that the confidentiality protection routine defined in clause 6.3.5 of TS 33.503 can be re-used to protect PRUK-ID and the RSC. When received, decrypted and/or unscrambled and/or integrity verified by Target-UE, the PRUK-ID pre-defined value may be discarded. A further difference compared with Clause 6.3.5 in TS 33.503 is that in integrated discovery there is no previous discovery phase, and thus, in a related embodiment that may be combined with other embodiments for integrated discovery or used independently, the UE-to-UE Relay and Target-UE have to perform blind decryption/integrity verification when receiving messages DCR (Step 1413) and DCR′ (Step 1417) instead of verifying the integrity of the received DCR message using the code-sending security parameters used for discovery as stated in Clause 6.3.5.3 in TS 33.503 and/or decrypting the encrypted PRUK ID and RSC using the code-sending security parameters used for discovery and verifying if the RSC matches with the one that it sent in the discovery message as stated in Clause 6.3.5.2 in TS 33.503.

While the UE-to-UE Relay does not know which keys are to be used to integrity verify, and decrypt the DCR message (Step 1413), the UE-to-UE Relay does know which keys (i.e., associated with RSC2 sent in DCR′) are used when receiving the message from the Target-UE including the PRUK-ID₂, RSC₂ of the Target-UE. Thus, in a different embodiment that may be combined with other embodiments for integrated discovery or used independently, the UE-to-UE Relay performs decryption/integrity verification of the message received from the Target-UE (step 1418) using the keys that were used to encrypt/integrity protect DCR′ message (step 1413). This may require the UE-to-UE Relay to keep track of the keys used to protect DCR′ message Step 1413 wherein this tracking/storage may be limited to a number of keys and/or a time limit.

In an embodiment variant that may be combined with other embodiments for integrated discovery or used independently, if the same RSC is used between Source-UE and UE-to-UE Relay, and between UE-to-UE Relay and Target-UE, UE-to-UE Relay performs blind-decryption/integrity verification when receiving DCR (step 1413), then re-uses the keys (associated with RSC) to derive the keystream to confidentiality protect the RSC and integrity protect DCR′. Target-UE performs blind decryption/integrity verification upon receiving the DCR′ (step 1417), and re-uses the same key (associated with RSC) to confidentiality protect PRUK-ID and RSC and integrity protect the message transmitted to UE-to-UE Relay (in step 1418). Then, UE-to-UE Relay performs decryption/integrity verification of the message received from Target-UE using the same keys used to protect DCR and DCR′ messages. In an embodiment that may be combined with other embodiments for integrated discovery or used independently, the DCR with integrated discovery message may be received directly by Target-UE. In such case, Target-UE processes the message differently from when it is relayed by a UE-to-UE Relay. That is, Target-UE may not have to decrypt RSC and PRUK-ID; Target-UE may only blindly integrity verify the DCR with integrated discovery message which includes the encrypted PRUK-ID and RSC, and if the integrity verification is successful, Target-UE may discard the PRUK-ID and RSC. In an alternative, Target-UE may not integrity verify the message. The communication link between Source-UE and Target-UE is then established following the procedure described in 5.3 of TS 33.536.

In an embodiment, steps required to establish hop-by-hop secure links may be repeated/retried (e.g., in case of (a) failure(s)) a number of times (e.g., N times) that may be determined by a policy provisioned at UEs (i.e., Relay and End UEs) e.g., in step 1410.

In another embodiment, if Target-UE receives multiples DCR messages with integrated discovery (e.g., from multiple UE-to-UE Relays), and it identifies that a secure link is already established with one of the Relays, if Target-UE selects that UE-to-UE Relay (e.g., according to policy evaluation and path selection step), steps 1418, 1419, 1420, 1421, and 1422 may be skipped, and instead Target-UE sends a Direct Communication Accept message to UE-to-UE Relay.

In another embodiment variant, the steps performed between Target-UE and UE-to-UE Relay to establish the second hop-by-hop secure link may be in the opposite order; that is Target-UE may initiate the Security Mode Command Procedure (e.g., in step 1418) and provide its RSC2, PRUK-ID₂, and a K_{NRP2} freshness parameter 1, steps 1419 and 1420 remain the same, and upon successful verification of Target-UE's authorization to receive Relay services, in step 1422 the UE-to-UE Relay transmits K_{NRP2} freshness parameter 2 to Target-UE in a Direct Security Mode Complete message, Target-UE then derives K_{NRP2} from its PRUK, RSC₂, K_{NRP2} freshness parameter 1, and K_{NRP2} freshness parameter 2. Successful verification of Direct Security Mode Complete message assures Target-UE that UE-to-UE Relay is authorized to provide relay services. If the verification is successful, Target-UE sends a Direct Communication Accept message (in step 1422) to UE-to-UE Relay to complete the secure link establishment procedure.

In another embodiment, End-UEs may provide their SUCIs/GUTIs in addition to, or instead of their PRUK-IDs in steps 1411 (for Source-UE) and 1418 (for Target-UE) for identification, and/or authentication, and/or authorization purposes.

The exchanged security parameters may also be applicable to another related embodiment variant, whereby one or more of the Source-UE and Target-UE and UE-to-UE Relay may be out of coverage, and/or, the UEs may agree or are configured to use a security procedure without network assistance. In this embodiment variant, the Key Request/Response messages with the 5GC are not used. Keying materials may involve authorization tokens (similar to Sol #4 in TR 33.740) or long-term credentials that allow for the establishment of the PC5 security link. With regards to authorization tokens, the authorization tokens (AT) may be provided by the 5GC. The AT from the Source-UE may be sent in message 1412 and maybe verified by the UE-to-UE Relay upon reception of message 1412. If verification is successful, the UE-to-UE Relay may forward its own AT and potentially the AT of the Source-UE in Step 1414 (DCR′). The Target-UE verifies authorization upon reception of message 1414. The Target-UE may then send its AT in message 1418 and upon reception 1418, the UE-to-UE Relay may verify the authorization of the Target-UE. In another embodiment that may be combined with others or used independently, Steps 1415/1416 and 1419/1420 in FIG. 2 may also be executed in parallel. In other words, the Key Request messages to 5GC in steps 1415 and 1419 may be combined to include one or more of RSC1, PRUK-ID₁, and K_{NRP1} freshness parameter 1, RSC2, PRUK-ID₂, and K_{NRP2} freshness parameter 1. The Key response messages from 5GC in Steps 1416/1420 may be combined to include K_{NRP1}, and K_{NRP1} freshness parameter 2, K_{NRP2}, and K_{NRP2} freshness parameter 2. The sending of the combined Key Request message may happen once the Target-UE has replied to the UE-to-UE Relay with its Direct Auth and Key Establishment Request message (step 1418). This approach allows reducing the number of round trips with the 5GC, and thus, reduces the latency. This also allows the 5GC to verify whether the UE-to-UE Relay is authorized to establish the communication link between Source-UE and Target-UE in a single step. This embodiment variant may be applicable to other types of security establishment in UE-to-UE Relay, e.g., it may be applicable to a standard PC5 security establishment procedure with network assistance as Sol #3 in TR 33.740.

In another embodiment variant, security parameters included in the DCR message with integrated discovery (e . . . g, DCR′) such as PRUK-ID or authorization tokens may be protected with the discovery materials and/or existing security context as in other embodiments.

From a Target-UE's side, we can differentiate between several scenarios. For instance, Target-UE may receive multiples DCR messages e.g., directly from Source-UE and/or from one or many UE-to-UE Relays, with UE-to-UE Relays potentially employing different security mechanisms, e.g., as described in the UE-to-UE Relay security establishment options above. Since Target-UE performs path selection, it may be (pre-)configured/provisioned with a policy to determine how such path is selected (e.g., direct link, or through a UE-to-UE Relay) to establish a communication link with Source-UE. The path selection may depend on factors including, but not limited to, signal strength, optimization requirements (e.g., UE-to-UE Relay with which a security context is already established may be more favorable than a UE-to-UE Relay with which a key establishment step is required to establish a secure link), and/or relay avoidance (e.g., where possible, always opt for a direct link with Source-UE as it minimizes the security procedures Target-UE needs to perform to establish secure links). Based on the Target-UE policy, the received DCR messages may be handled according to one or more of the following embodiments:

In an embodiment, if a Target-UE receives multiple DCR messages from one or many UE-to-UE Relays, Target-UE is to prioritize a link to one of the relays with which a security context is already established. This has the advantage of Target-UE being able to skip the direct auth and key establishment, and Direct Security Mode Command procedures, hence establishing a connection with Source-UE more efficiently.

In an embodiment variant, if a Target-UE receives multiple DCR messages from multiple UE-to-UE Relays, Target-UE may decrypt/unscramble/integrity verify the received DCR messages, and based on the UE-to-UE Relay User Info ID in the Discovery set, Target-UE can determine whether a security link is already established with said UE-to-UE Relay.

In an embodiment variant, if a Target-UE receives multiple DCR messages from multiple UE-to-UE Relays, Target-UE may (1) use the L2 addresses to determine whether a security link is already established with one of the UE-to-UE Relays, (2) use it to retrieve a security context used (e.g., set of keys) to decrypt/unscramble/integrity verify the received DCR message(s).

In an embodiment variant, if one set of security materials is used, UE-to-UE Relay may identify the Target-UE (e.g., through its User Info ID), in which case, UE-to-UE Relay may transmit a message to Target-UE that contains only the direct discovery set, and is protected using the security materials associated with the already established link. Alternatively, the UE-to-UE Relay may include an integrated_discovery_indication to the message transmitted to Target-UE.

In an embodiment variant, the Target-UE may receive several DCR messages, e.g., from Source-UE and from one of many UE-to-UE Relays. Target-UE is to always prioritize the establishment of a direct link with the Source-UE, regardless of whether a security context exists or is established (e.g., with one of the UE-to-UE Relays) and/or which security solutions/mechanisms are used.

In another embodiment, if a Target-UE receives multiple DCR messages from different UE-to-UE Relays, Target-UE may select the preferred UE-to-UE Relay based on several criteria such as, how the DCR′ message is protected, and what is required to establish a secure link with the UE-to-UE Relay. For instance, if a UE-to-UE (e.g., UE-to-UE₁) already has a secure link established with T-UE, and its DCR′ message (e.g., DCR′₁) is protected using the security materials of the already established security context, and another UE-to-UE Relay (e.g., UE-to-UE₂) transmits a DCR′ message (e.g., DCR′₂) partially protected (e.g., only the discovery message is protected as per clause 6.1.3.2.3 of TS 33.503), while the rest of the DCR′ (e.g., Key_Est_Info) is unprotected; Target-UE may select UE-to-UE₁ as it is more efficient e.g., to establish a secure link with Source-UE. Alternatively, it may select UE-to-UE₂ if, for example, the signal quality is better e.g., such that Target-UE doesn't have to resort to relay reselection if the link with UE-to-UE₁ deteriorates.

In another embodiment, the Target-UE may receive multiple DCR messages from different UE-to-UEs relays at different points in time. For instance, Target-UE may evaluate and select a particular path, and then receive a DCR message from one of the UE-to-UE Relays which may have a higher priority (e.g., a security context is already established). For such case, Target-UE policy may set a timer to consider the received DCRs and discard any DCRs received after the timer runs out.

In an embodiment, the Target-UE may trigger path switching or relay reselection based on e.g., link quality deterioration, in which case, Target-UE may indicate/inform Source-UE of its intent to switch paths and whether the security policies and algorithms may be maintained (i.e., non renegotiated through the reselected relay) e.g., to optimize the path switching and security establishment procedures.

In an embodiment, the Target-UE (or/and UE-to-UE relay) checks whether the DCR message is protected by means of an indication, wherein the indication can be the RSC used, or a security indicator associated to the RSC, or the presence of a PRUK-ID field, or the message length.

In an embodiment, if the DCR message with integrated discovery is protected, the Target-UE undoes protection, verifies the DCR message's freshness and integrity, and whether the PRUK-ID field is set to a predefined value (e.g., all zeroes).

In an embodiment, if the DCR message with integrated discovery is protected, the Target-UE undoes protection, verifies the DCR message's freshness and integrity, and check whether the RSC included is bound to a security procedure with network assistance.

In an embodiment, the relay indication may be protected (e.g., integrity protected) independently or as part of the DCR message (e.g., within the UE-to-UE discovery set).

In an embodiment, if two sets of discovery security materials are used, relay_indication may be protected (e.g., integrity protected) by Source-UE using the end-to-end keying materials (e.g., DP_S-T), such that Target-UE can verify it, if the integrated discovery DCR message is received directly by Target-UE. If the DCR message is received by a UE-to-UE Relay, after discarding of relay_indication, UE-to-UE Relay may replace the end-to-end computed MIC by a hop-by-hop computed MIC, such that when Target-UE receives the DCR message through a Relay, it can verify its integrity using DP_UE-to-UE-T.

In an embodiment, if the integrated discovery DCR message is relayed, the UE-to-UE Relay may protect (e.g., encrypt/scramble/integrity protect) the relay indication as part of the UE-to-UE discovery set.

In an embodiment, if only one set of discovery security materials is used, Source-UE may protect the integrated discovery message including e.g., Source User Info ID, ProSe Service Info, RSC, and if included, Target-UE User Info ID, using the discovery security materials associated to the RSC as per clause 6.1.3.2.3 of TS 33.503. If Source-UE is configured with DUCK, or DUSK and/or DUIK, RSC and relay_indication may be scrambled, or encrypted, and/or integrity protected using DUCK, DUSK, and/or DUIK. Alternatively, RSC and relay indication may be protected using the discovery security materials.

In an embodiment, the integrated discovery message confidentiality protection may be based on the discovery confidentiality mechanism described in A.7 of TS 33.503 wherein the input parameters to the ciphering algorithms are:

| | |
|---|---|
| - | KEY: 128 least significant bits of the output of the KDF (DUCK, UTC-based counter, MIC) |
| - | COUNT: UTC-based counter |
| - | BEARER: 0x00 |
| - | DIRECTION: 0x00 |
| - | LENGTH: LEN(di-covery message) − (LEN(Message Type) + LEN(UTC-based counter LSB) + |

LEN(MIC)), where LEN(x) is the length of x in number of bits
where

| | |
|---|---|
| - | LEN(discovery message) may refer to the length of the (integrated) discovery message, |

and/or

| | |
|---|---|
| - | Message Type, in an integrated discovery scenario, may refer to the ProSe signaling message |

type as defined in table 11.3.1.1 clause 11.3.1 of TS 24.554.

In another embodiment, LEN(discovery message), in an integrated discovery scenario, may refer to the length of the integrated discovery message which includes the direct discovery set (e.g., Source and Target-UEs User Info IDs) and the UE-to-UE discovery set (e.g., UE-to-UE Relay User Info ID, RSC) and excluding other DCR fields (e.g., Security Information).

In another embodiment variant, LEN(discovery message) may refer to the length of the entire DCR message including the integrated discovery message.

The above embodiments may be considered independently or combined with each other where applicable.

In an embodiment variant, the processing at the Source-UE when protecting the DCR message may involve the following steps:
1. Construct message m1 including Direct discovery set elements e.g., Source-UE and Target-UE IDs, and a subset of DCR fields, e.g., integrated_discovery_indication.
2. Message m1 may be integrity protected with a MIC computed with the DUIK as configured in the Direct Code-sending security parameters. The MIC is inserted, e.g., concatenated, appended, etc. in/to m1.
3. Privacy sensitive fields in message m1 are confidentiality protected with DUSK or DUCK as configured in the Direct Code-sending security parameters (DP_S-T). This results in a protected message 1, pm1.
4. Construct message m2 (unprotected integrated DCR message) including pm1, remaining fields of DCR message (not included in m1 e.g., relay indication) and UE-to-UE Discovery set elements e.g., RSC, and UE-to-UE Relay User Info ID.
5. Message m2 may be integrity protected with a MIC computed with the DUIK as configured in the UE-2-UE Code-sending security parameters. The MIC is inserted in message m2.
6. Privacy sensitive fields in message m2, e.g., RSC in the UE-to-UE Discovery set, are confidentiality protected with DUCK as configured in the UE-2-UE Code-sending security parameters (DP_S-UE-to-UE). This results in protected message 2, pm2.
7. Privacy sensitive fields in pm2 that might require easier access for performance reasons may be scrambled, thus resulting in a scrambled protected message2, spm2.

Spm2 is the protected DCR message with integrated discovery that can be transmitted by the Source-UE.

In an embodiment similar to other embodiments, the protection of some fields in an integrated discovery message using specific keys may be subject to a policy, e.g., whether keys in the DP_S-T (Direct Code-sending security parameters) and/or in the DP_S-UE-to-UE (UE-2-UE Code-sending security parameters) as well as which keys (I.e., DUSK and/or DUCK and/or DUIK in DP_S-UE-to-UE/DP_S-T) are used or not in the protection of the integrated discovery message.

Fields in pm1 excluded from the subsequent protection in step 5 and 6. This allows a Target-UE receiving the integrated discovery message directly from a Source-UE to directly access pm1.

In an embodiment variant, the processing at the Target-UE when processing a received protected integrated DCR message may be as follows:
1. Check if the relay_indication field is included. If it is, then Target-UE can directly process pm1 in Step 5.
2. Descramble the message spm2 by using the UE-2-UE Code-receiving security parameters or existing context with UE-to-UE Relay obtaining pm2.
3. Remove confidentiality in pm2 by using the UE-2-UE Code-receiving security parameters or existing context with UE-to-UE Relay obtaining m2 and MIC.
4. Verify m2 by using the received m2, received MIC, and the UE-2-UE Code-receiving security parameters or existing context with UE-to-UE Relay. If MIC verification succeeds, the remove MIC obtaining pm1.
5. Remove confidentiality in pm1 by using the Direct Code-receiving security parameters, thus obtaining m1 and MIC.
6. Verify m1 integrity by using the received m1, received MIC, and the Direct Code-receiving security parameters and the PRUK-ID, if it's a pre-defined value. If MIC verification succeeds, then remove MIC and return m1. PRUK-ID field may also b74etween74n74d upon successful verification.

In an embodiment variant, steps 2, 3, 4 always use the same UE-2-UE Code-receiving security parameters. This has the advantage of adding another layer of security through steps 5 and 6 to pm1.

In an embodiment variant, steps 2, 3, 4 always use the existing context if Target-UE is configured with a policy that gives priority to reusing existing security context e.g., between Target-UE and UE-2-UE Relay.

In an embodiment variant, a Target-UE may determine whether a security context is available by checking the User Info ID, or Layer2 ID of the UE-to-UE Relay.

In an embodiment variant, the processing at the UE-to-UE Relay when processing a received protected integrated DCR message may be as follows:
1. Check if the relay indication is included. If it is not, the relay drops the DCR message.
2. Steps 2, 3, and 4 are similar to the same steps in the processing of the protected DCR message by Target-UE.
5. Construct a new mes′age m2 (e.g., m2′) by adding UE-to-UE Relay User Info ID to the UE-to-UE Discovery set, discarding of the relay_indication, and optionally updating the RSC. If the RSC is associated to a network assistance security indicator that indicates a security procedure with network assistance, the UE-to-UE Relay further sets the PRUK-ID field to a pre-defined value or discards it.
6. Steps 6, 7, and 8, are similar to steps 5, 6, and 7 of the Source-UE construction and protection of the DCR message, and result in a scrambled pro'ected'essage m2’, ‘pm2’.
9 spm2′ is the protected DCR message with integrated discovery that can be relayed by the UE-2-UE relay.

In an embodiment variant, if the UE-2-UE Relay re-uses the same RSC used by Source-UE, i.e., the same UE-2-UE Code sending security materials, the protection in steps 6 and 7 may also be applied on pm1.

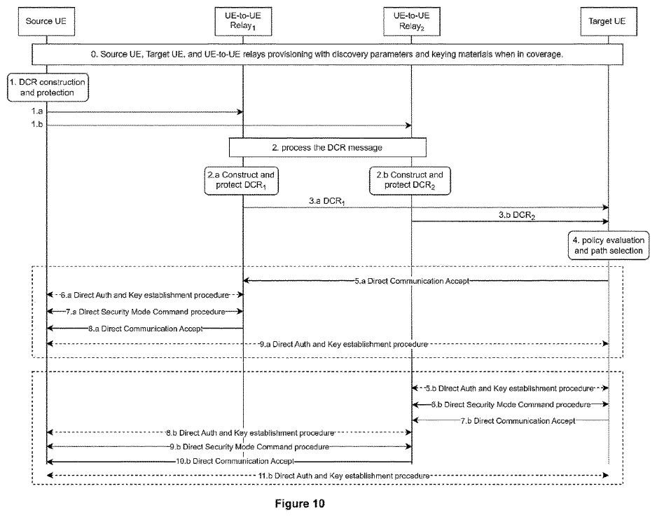

In an embodiment variant, after step 4, if the UE-2-UE Relay has a security context already established with the Target-UE, the UE-to-UE Discovery set may be removed, and steps 6, 7, and 8 may be based on the security keying materials corresponding to the already established security context.
In relation to FIG. 10, where a secure PC5 link can be established between Source-UE and Target-UE over one or more UE-to-UE Relays, the procedure could be described as follows:

Source, Target, and UE-to-UE Relays are provisioned with security policies, and two sets of discovery security materials and parameters to enable the establishment of a secure PC5 link.
1. Source-UE constructs the DCR message including Direct Discovery set, UE-to-UE Discovery set, and fields specific to the DCR message (integrated_discovery_indication and relay indication). Direct Discovery set and integrated_discovery_indication are protected with the Direct Code-sending security parameters. The whole DCR message is protected with the UE-to-UE Relay Code-sending security parameters whereby the Direct Discovery set and integrated_discovery_indication are not confidentiality protected
2. When a UE-to-UE Relays receives the DCR message and descramble/decrypts/integrity verifies it. If integrity verification succeeds, the UE-to-UE Relay sets the relay indication to “OFF” and constructs another DCR message (e.g., DCR1 or DCR2) in a similar was as in step 1
2.a If the relay e.g., UE-to-UE Relay1 identifies Target-UE and a secure link is already established with Target-UE, UE-to-UE Relay1 uses the security keys corresponding to the already established security context with Target-UE to protect DCR1
2.b If the relay e.g., UE-to-UE Relay2 cannot identify Target-UE or does not have a security context established with it, UE-to-UE Relay2 uses the UE-2-UE Code-sending security parameters to protect DCR2.
3.a/b UE-to-UE Relay1 and UE-to-UE Relay2 transmit DCR1 and DCR2 to Target-UE
4. As Target-UE may receive several DCR messages (e.g., from one or multiple UE-to-UE Relays). When applicable, Target-UE unscrambles/decrypts/verifies the integrity of the DCR message with the corresponding keys (either existing context or UE-2-UE Code-receiving security parameters) Then the target-UE uses the Direct Code-receiving security parameters to decrypt/integrity verify the Direct discovery set and integrated_discovery_indication. Based on the policy evaluation and path selection in step 4, a secure link is established in either one of the following cases, case 1 and case 2.
Case 1: Assuming Target-UE selects a communication path going through UE-to-UE Relay1.
5.a Since a security context is already established, the Direct auth and key establishing, and Direct Security Mode Command procedures are skipped, instead, Target-UE sends a Direct Communication Accept to UE-to-UE Relay2.
6.a/7.a/8.a correspond to the establishment of a secure link between Source-UE and UE-to-UE Relay1.

Lastly, in step 9.a, an end-to-end secure link between Source-UE and Target-UE, through UE-to-UE Relay1.
Case 2: Assuming Target-UE selects a communication path going through UE-to-UE Relay2.
5.b/6.b/7.b correspond to the establishment of a secure link between UE-to-UE Relay2 and Target-UE.
8.b/9.b/10.b correspond to the establishment of a secure link between UE-to-UE Relay2 and Source-UE.

Lastly, in step 11.b, an end-to-end secure link between Source-UE and Target-UE, through UE-to-UE Relay2.

In a Secure hop-by-hop or end-to-end links between UE-to-UE Relay2 and End-UEs, UE-to-UE Relay1 and Source-UE, and between End UEs are established as per clause 5.3 of TS 33.536, based on Security Information in the DCR message.

Above embodiments, in which an existing security context (e.g., between UE-to-UE Relay and Target-UE) is reused upon reception of the DCR message, may be applied to other procedures, e.g., Solution #3 or #4 in TR 33.740 that describe security procedures to establish a secure PC5 communication link after the discovery procedure.

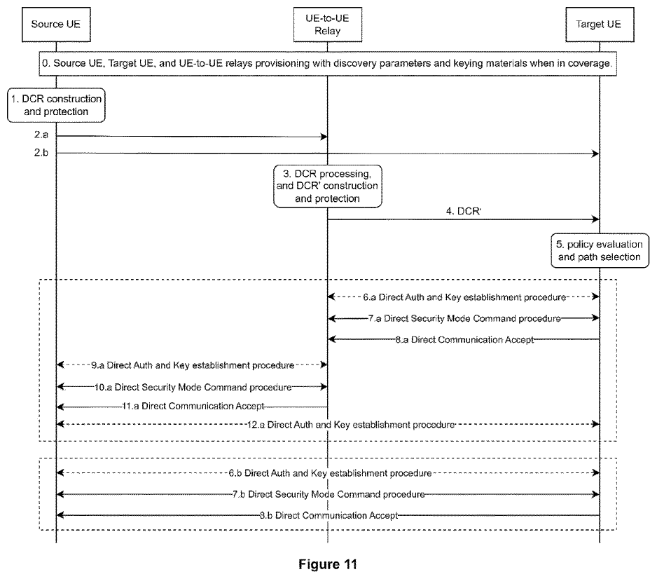

In another embodiment, related to FIG. 11, where a secure PC5 link can be established between Source-UE and Target-UE directly or over a UE-to-UE Relay, the Target-UE needs to be able to process the incoming integrated DCR message independently of the path taken, direct or indirect. This requires that the Target-UE is capable of accessing the direct discovery set as described in above embodiments e.g., the discovery security materials associated with the RSC(s) and intended to protect the hop-by-hop messages are not used to confidentiality protect the direct discovery set that is protect with a set of keys associated with the ProSe service.

The DCR message by UE-to-UE (i.e., step 3) relay, and secure link establishment through the relay (i.e., steps 6.a to 12.a) are similar to the processing and secure link establishment through the UE-to-UE Relay2 in FIG. 10.

Target-UE processes messages 2.b similarly to DCR′ received in step 4, wherein, if the relay indication is not set, and Target-UE prioritizes a direct link with Source-UE, it may establish the link with Source-UE following steps 6.b, 7.b and 8.b.

In some cases, some configurations may be implicitly or explicitly indicated in the DCR message itself.

A solution related to TR 33.740 v0.5.0 in clause 6.30 is as follows:

The 5G Prose Source-UE and 5G Prose UE-to-UE Relay may encrypt the Source User Info ID, Relay User Info, Target User Info ID and RSC as follows:
1) If the UE is configured with Discovery User Confidentiality Key (DUCK)/Discovery User Scrambling Key (DUSK), the DCR ciphering key KDCR is set to DUCK/DUSK. If the UE is not configured with DUCK/DUSK, the DCR message is not protected, and Steps 2-3 are skipped.
2) Set Keystream to DCR confidentiality keystream calculated using KDCR, UTC-based counter, Bearer, Direction, and Length as described in Annex A.7 in TS 33.503 [6].
3) the message is XORed with the Keystream.

This approach, however, deals only with privacy/confidentiality protection and does not cover integrity protection. Moreover, no distinction is made between the protection of the DCR message with integrated discovery transmitted by Source-UE and the one transmitted by the UE-to-UE Relay. For instance, UE-to-UE Relay User Info ID may not be part of the Integrated Discovery message transmitted by Source-UE. This approach also assumes that only one set of security materials is used to protect both the direct discovery set(s) and the U2U discovery set in the discovery message. Hence, it is the object of the following embodiment to address these shortcomings.

In an embodiment related to other embodiments, the DUCK is used as KDCR if the DUCK is available; if the DUCK is not available, then the DUSK is used as KDCR if the DUSK is available; if neither DUCK nor DUSK are available, then the KDCR is not configured, and the message is not confidentiality/privacy protected.

In an embodiment, a transmitter UE (e.g., Source-UE, or UE-to-UE Relay) may be provisioned/configured with a Discovery User Integrity Key (DUIK). If this key is available, this key is used to protect the integrity of the message. The DCR integrity key KINT is set to DUIK and a MIC is computed over the DCR message using KINT and a UTC-based counter. Finally the MIC IE is set to the computed MIC. This may be done as described in other embodiments.

In a related embodiment, the receiver performs the inverse operation to verify the integrity of the message.

In an embodiment variant, if the transmitter UE is not provisioned/configured with a DUIK, the DCR message is not integrity protected.

In an embodiment variant, End UEs (i.e., Source and Target-UEs) may be provisioned with two sets of security materials, such that a first Discovery User Integrity Key DUIK1, associated with a ProSe Restricted Code, and is used to integrity protect the direct discovery set, and a second Discovery User Integrity Key DUIK2, associated with Relay Service Code (RSC), is used to integrity protect the UE-to-UE discovery set or the entire DCR message. UE-to-UE Relay is provisioned only with sets of security materials, associated with RSCs, and intended to integrity protect the UE-to-UE discovery set or the entire DCR message, including the direct discovery set.

In an embodiment variant, Ends UEs (i.e, Source and Target-UEs) may only be provisioned/configured with a DUIK associated with ProSe Restricted Code, in which case Ends UEs integrity protect the Direct Discovery set, while the UE-to-UE discovery set or the entire DCR message are not integrity protected.

In an embodiment, the Ends UEs (i.e., Source, and Target-UE) may be provisioned/configured, when in coverage, by the network with a policy/indicator, e.g., security_materials_indication, which indicates whether one or two sets of security materials are used to protect (e.g., confidentiality, scrambling, and/or integrity protection) the DCR message with Integrated Discovery.

In an embodiment variant, the UEs (Source, Target, and UE-to-UE Relay) may be provisioned/configured with a policy, Relay_discovery_security_indication, that indicates e.g., which type of protection (e.g., encryption, scrambling, integrity) is applied, and/or whether it is applied on the UE-to-UE discovery set, or the entire discovery message, or in case of Integrated Discovery, the entire DCR message.

In some embodiments, the DP_S-UE-to-UE or DP_UE-to-UE-T refer to the set of keys or security keying materials used to protect a discovery message in a hop-by-hop manner, e.g., keying materials associated with the Relay Service Code.

In some embodiments, the DP_S-T refer to the set of keys or security keying materials used to protect a discovery message in an end-to-end manner, e.g., keying materials associated with the ProSe Restricted Code.

In an embodiment, the End UEs (Source and Target-UEs) are provisioned/configured with a policy/indicator e.g., direct_discovery_security_indication, that indicates e.g., whether the direct discovery set is protected with its own set of security materials (e.g., associated with ProSe Restricted Code), and/or which type of protection (e.g., encryption, scrambling, integrity) is applied, and on which fields (e.g., Integrity protection over the entire Direct discovery set e.g., Source-UE User Info ID, Target-UE User Info ID, and integrated_discover_indication, and privacy/confidentiality protection through encryption/scrambling applied only on privacy sensitive fields e.g., Source and Target User Info IDs).

In an embodiment, a UE may be configured with a first and a second set of keys and a policy, and the UE may protect a first message based on the first set of keys and the policy delivering a first protected message, and the UE may then protect the first protected message based on the second set of keys and the policy delivering a second protected message that is then transmitted by the device.

According to clause 6.4.3.7.4 of TS 23.304, the User Info ID of target 5G ProSe End UE is an optional field in the DCR message with integrated discovery. As such, if the Target End UE's User Info ID is included, and the DCR message (with integrated discovery) is not protected, privacy sensitive information of Source and Target-UE (e.g., User Info IDs, and link between them i.e., the fact that Source-UE is trying to establish a link with Target-UE) may be compromised. This may also happen if the UE-to-UE relay is not trusted. Hence, in an embodiment, the DCR message (with integrated discovery) may be required to be protected, e.g., end-to-end protected between source and target UEs, as described in above embodiments, when the Source-UE includes the Target-UE's User Info ID. In other words, the protection of the DCR message may not depend only on the coverage status of the UE-to-UE Relay(s) or on the type of security procedure to be used in the security setup of the PC5 communication link, but also on the content of the DCR message as constructed by Source-UE.

In an embodiment variant, Source-UE may trigger protection of the DCR message (with integrated discovery) if either one, or both of the following occurs:
Source-UE includes the Target-UE User Info ID in the DCR message with integrated discovery
Source-UE opts for a network-assisted secure link establishment procedure.

In an embodiment variant, where both conditions of the previous embodiment are met, the security procedure defined in 6.3.5 of TS 33.503 is reused to protect the DCR message with integrated discovery wherein, the privacy sensitive information (e.g., RSC, PRUK-ID, User Info IDs of Source, UE-to-UE Relay, and Target-UE) are confidentiality protected, and the DCR message is integrity protected. Since Clause 6.3.5 of TS 33.503 can only protect up to 256 bits, then the confidentiality key may be used in combination with a NEA algorithm to protect a payload longer than 256 bits.

In an embodiment variant, if Source-UE includes the Target-UE's User Info ID in the DCR message with integrated discovery, wherein an RSC associated to a disabled Network Assistance Security Indicator is used, the security procedure defined in 6.1.3.3.2.2 of TS 33.503, up to, and including, step 2 at least, is reused to protect the DCR message with integrated discovery with two sets of keys wherein, the Discoverer UE is the Source UE, the Discoveree UE is the Target-UE, the solicitation discovery message is replaced by the DCR message with integrated discovery, the first set of keys associated to a Prose service code is used to protect the end-to-end discovery elements e.g., User Info IDs of Source and Target UEs, and the second set of keys, associated to a relay service code is used to protect the DCR message with integrated discovery.

In an embodiment variant, if Source-UE includes the Target-UE's User Info ID in the DCR message with integrated discovery, wherein an RSC associated to a disabled Network Assistance Security Indicator is used, the security procedure defined in 6.3.5 of TS 33.503 is reused to protect the DCR message with integrated discovery wherein, the privacy sensitive information (e.g., RSC, User Info IDs of Source, UE-to-UE Relay, and Target-UE) is privacy/confidentiality protected, and the DCR message is integrity protected based on the set of keys (e.g., DUIK, DUCK, DUSK) associated to the RSC.

In a related embodiment variant, if Source-UE opts for a network-assisted security procedure, then only UE-to-UE Relays which are within 3GPP coverage may security process the DCR message broadcasted by Source-UE. The UE-to-UE Relay may recognize whether the security procedure is network-assisted or not based on the network assistance security indicator associated with the RSC used in the DCR message. For instance, if the UE-to-UE Relay is out-of-coverage and receives a DCR message with an RSC associated with an enabled network assistance security indicator, it drops the DCR message, otherwise, it processes the message and uses network assistance to initially establish a secure hop-by-hop link with Source-UE.

In a related embodiment variant, once UE-to-UE Relay (re-)broadcasts the DCR message (e.g., intended for Target-UE), Target-UE may determine whether to security process the received DCR message based on whether it supports/prefers a non-network/network-assisted security procedure. For instance, if Target-UE receives a DCR message with an RSC associated with an enabled Network-assisted security procedure, Target-UE may provide the UE-to-UE Relay with its PRUK-ID (or SUCI) so that UE-to-UE Relay uses network assistance to establish a secure hop-by-hop link with Target-UE.

In an embodiment variant, a Target-UE which does not have proper credentials (e.g., valid long term credentials) and/or prefers a network-assisted security procedure may not reply/react to DCR messages which include an RSC that is associated with a disabled network-assistance security indicator.

In an embodiment, if Source-UE includes Target-UE's User Info ID in the DCR message with integrated discovery, that should have no impact on whether the UE-to-UE Relay security processes the DCR message or not.

In a related embodiment, a Target-UE may decide to security process DCR message(s) based on e.g., whether the DCR message is intended for it. For instance, a Target-UE with limited resources may be pre-configured to only establish PC5 communication links (e.g., direct or over a UE-to-UE Relay) with UEs (e.g., Source-UEs) requesting its services, e.g., UEs which include an identifier (e.g., User Info ID, or Destination Layer-2 ID) corresponding to said Target-UE in the DCR message.

In a related embodiment, a Target-UE e.g., with limited resources which receives a DCR message may, at a first stage, try to determine whether its User Info ID and/or Destination Layer-2 ID is included in the integrated discovery message based on e.g., the message size. For instance, if the integrated discovery message size indicates that no identifiers (e.g., User Info ID/Destination Layer-2 ID) is/are included, the Target-UE may drop the DCR message.

In a related embodiment, if the Target-UE successfully performs a size check to determine whether an identifier is included, it may proceed to check the security procedure selected (e.g., based on the RSC included and the status of the network-assistance security indicator associated with it). Based on the outcome of the check against its preference, Target-UE determines whether to continue processing the DCR message or drop it (e.g., if the security procedure is not supported e.g., due to unvalid/expired credentials).

In an embodiment variant, a Target-UE may extract and process the direct discovery set, which includes the End-UEs (e.g., Source and Target-UE) User Info IDs, first, then determine based on whether the Target-UE's User Info ID included in the direct discovery set matches his, whether to process the DCR message or drop it.

These embodiments/checks may be performed separately as they may be combined. When combined, they may be performed in a different order, and/or some of them may be skipped depending on the Target-UE's configuration e.g., preferences, requirements, credentials availability, coverage status etc.

In an embodiment variant, if Source-UE opts for a network assisted link establishment procedure and also includes Target-UE's User Info ID in the DCR message, this latter may be protected as described in other embodiments, e.g., inline with the procedure described in FIG. 2.

In an embodiment variant, the Source-UE may opt for a network-assisted link establishment procedure and send an integrated discovery message. However, this integrated discovery message, i.e., the DCR message with integrated discovery, may also be received by the Target-UE directly. Thus, to address this situation, the Target-UE may need to be provisioned with a policy to determine how to communicate with said Source-UE, e.g., by requesting or replying to allow for a direct communicati82etween82n82waiting/preferring a relayed communication wherein the PC5 security is established with network assistance. For instance, Target-UE may be configured to wait for the DCR message to be relayed through a UE-to-UE Relay which provides network assistance, and select the path favoring Source-UE's choice (i.e., link establishment through the UE-to-UE Relay with network assistance). Alternatively, if the target-UE is able to decrypt/unscramble/integrity verify the integrated discovery message, it may be configured to try establishing the link directly with Source-UE instead.

In an embodiment, if the Ends UEs (Source and Target-UEs) are provisioned with or configured to use only one set of security materials (e.g., Relay_Discovery_security_indication is enabled and Direct_discovery_protection_indication is disabled), Ends UEs use the provisioned security keys associated with RSC to protect the DCR message with integrated discovery.

The processing procedures by UEs (Source, Target, and UE-to-UE Relay) can be similar to the ones described above using two sets of security materials, with slight changes. They may be described as in the following embodiments:

In an embodiment variant, the processing at the Source-UE when protecting the DCR message with one set of security materials may involve the following steps:
1. Construct message M including Direct discovery set elements e.g., Source-UE and Target-UE User Info IDs, integrated_discovery_indication, UE-to-UE Discovery set elements e.g., relay indication, and other DCR fields e.g., ProSe Service Information and Security Information.
2. Message M may be integrity protected with a MIC computed with the DUIK associated with RSC, if provisioned/configured in the UE-2-UE Code-sending security parameters. The MIC is inserted in message M.
3. Privacy sensitive fields in message M, e.g., Source-UE and Target-UE User Info IDs, are confidentiality protected with DUCK/DUSK as configured in the UE-2-UE Code-sending security parameters. This results in protected message, pm.
4. Privacy sensitive fields in pm2 that might require easier access for performance reasons (e.g., RSC) may be scrambled, thus resulting in a scrambled protected message, spm where spm is the protected DCR message with integrated discovery that can be transmitted by the Source-UE.

In an embodiment variant, ProSe Service Information may also be privacy protected in step 3.

In an embodiment variant, Step 2 may apply to the Discovery sets integrated in the DCR message only, or to the entire DCR message (i.e., integrated discovery sets and other specific DCR fields e.g., Security Information).

In another embodiment, the processing at the Target-UE when processing a received integrated DCR message protected with one set of security materials may be as follows:
1. Unscramble the message spm by using the UE-2-UE Code-receiving security parameters (e.g., DUSK), or keys associated with existing security context with UE-to-UE Relay, thus obtaining pm.
2. Remove confidentiality in pm by using the UE-2-UE Code-receiving security parameters (e.g., DUCK), or keys associated with existing security context with UE-to-UE Relay, thus obtaining m and MIC.
3. Verify the integrity of m by using the received m, received MIC, and the UE-2-UE Code-receiving security parameters (e.g., DUIK) or existing context with UE-to-UE Relay. If MIC verification succeeds, then remove MIC, thus obtaining M.

In an embodiment variant, Target-UE may receive spm directly from Source-UE, in which case the same processing steps above apply.

In another embodiment, the processing at the UE-to-UE Relay when processing a received protected integrated DCR message protected with one set of security materials may be as follows:
1. Check if the relay indication is included. If it is not, the relay drops the DCR message.
2. Steps 2, 3, and 4 are similar to steps 1, 2, and 3 in the processing of the protected DCR message by Target-UE, but using code-sending security materials.
   Construct a new m′ssage M (e.g., M′) by adding UE-to-UE Relay User Info ID to the UE-to-UE Discovery set, discarding the relay_indication, and optionally updating the RSC.
   Steps 4, 5, and 6, are similar to steps 2, 3, and 4 of the Source-UE protection of the DCR message with integrated discovery, wherein the UE-to-UE Relay User Info ID is also privacy protected (e.g., encrypted) while RSC may be scrambled, thus resulting in a scrambled pr′tecte′ message M′, spm′.
   Spm′ is the protected DCR message with integrated discovery that is transmitted by the UE-2-UE relay to Target-UE.
   Alternatively, if a security context is already established between UE-to-UE Relay and Target-UE, and UE-to-UE Relay managed to identify the Target UE (e.g., M containing Target-UE User Info ID), in step 3, the UE-to-UE constructs a new message M (e.g., M″) containing the end-to-end/direct discovery discovery elements, protects M″ using security keys associated with the established security context, then sends it to Target-UE.

In accordance with a general definition of this embodiment, it is proposed a method and an apparatus that may be implemented in a Target User Equipment (UE) such that the apparatus
receives one or multiple Direct Communication Request (DCR) messages, e.g., with integrated discovery, from a Source-UE and/or from one or multiple UE-to-UE Relays,
determines how to process and/or prioritize the received DCR messages, and/or select a communication path, e.g., to a Source User Equipment, based on a configured policy wherein the policy may prioritize:
   a UE-to-UE Relay with which a security context is already established; or
   establishing secure links with fresh security materials, with and through a UE-to-UE Relay; or
   setting a direct link with Source-UE.

In another general definition of this embodiment, it is proposed a method and an apparatus that may be implemented in a UE-to-UE Relay such that the apparatus
receives a Direct Communication Request (DCR) message e.g., with integrated discovery from a Source-UE
processes the received DCR message and determines whether it can identify the Target-UE through an identifier e.g., Target-UE User Info ID or the Destination Layer-2 ID of Target-UE
determines based on a configured policy how a secure link is established with Target-UE wherein the policy may prioritize:
   re-using security materials associated with an established security context, if such context exist between UE-to-UE Relay and Target-UE, to protect the message to be relayed to Target-UE
   protecting the DCR message using discovery security materials and establishing a secure link with Target-UE using fresh security materials.

Embodiments may be combined with each other as suitable.

Verification of a Message from the Remote Ue (End Ue) at a (U2N) Relay

In some scenarios, when a remote UE (after discovery) sends a DCR message to the UE to Network (U2N) relay, the U2N relay verifies the integrity of the received parameters (e.g., RSC). Similar can also happen in UE to UE relay scenarios when an end UE sends a DCR message too the UE to UE relay. This integrity verification might be done as described in above embodiments or also as described in TS 33.503, Clause 6.3.5. However, if the integrity verification fails, currently there are no means for the U2N relay to inform the remote UE about the failure, hence the remote UE will keep retrying until a maximum number of retries is reached. This leads to unnecessary delays when setting up the communication link between the remote UE and the CN over the U2N relay. A potential solution is that the U2N relay sends a failure (or reject) message when the integrity check fails. However, since the integrity check fails, the U2N relay may not integrity protect such a failure/rejection message. This means that such an unprotected failure message may be used by an attacker to launch DoS attacks in a very simple way: when the remote UE tries to connect to a U2N relay, the attacker has to only send unprotected failure messages to the remote UE and this latter will just drop the communication.

A similar situation applies also to, e.g., direct link establishment procedure for UE-to-Network relay. A similar situation may apply when a U2N relay receives the direct link establishment request, during Direct Security Mode procedure when the verification of Direct Security Mode Command message or Direct Security Mode Complete message.

These specific situations can be generalized to a first device that is trying to connect to a second device by sending a first message including, e.g., an identifier (such as a service identifier or a session identifier) or a message integrity check such as a MIC. When the second device receives the first message and processes it, the second device might be instructed not to reply if the identifier check or the integrity check fails. In this situation, the first device is forced to wait (e.g., till a timer expires) and retry. The first device may need to repeat this operation (wait and retry) up to N times where N may be configurable. The above specific potential solution can also be applied to this more general scenario: the second device may need to send a failure (or reject) message when the identity or integrity check fails. As argued before, this failure message may not be integrity protected, so the failure message may be misused to launch DoS attacks.

Thus, an aim is to deal with this security problem and still allow for a more efficient option than having the first device waiting and retrying. To fulfil this aim the following embodiments are proposed.

Note that, in general, in the following embodiments:
1. U2N relay and remote UE may refer to a second device and a first device, respectively,
2. a DCR message may refer to a first message sent by the first device,
3. RSC may refer to an identifier such as a session or service identifier.

In an embodiment, the U2N relay sends a failure message when the integrity verification of the DCR message sent by a remote UE fails and the U2N relay sends an accept message (or success message) when the integrity verification of the DCR message succeeds. This has the advantage that the remote UE can discern the situation when the message is accepted and when the message verification fails.

In an embodiment, the U2N relay sends an accept message (or success message) when the integrity verification of the DCR message succeeds and does not send a failure message when the integrity verification of the DCR message sent by a remote UE fails. This has the advantage that the remote UE can discern the situation when the message is accepted.

In a related embodiment, the accept message is integrity protected and the failure message is sent without integrity protection.

In an embodiment, the accept message may be integrity protected in a similar way (e.g., same algorithm and/or integrity key) as the DCR message.

In an embodiment, the integrity protection of the accept message is done by including the RSC and encrypting it with the key chosen for encryption in the DCR message.

In an embodiment, the integrity protection of the accept message is done by including a MIC, e.g., computed using a NIA algorithm and the integrity key, e.g., DUIK, associated to the RSC and used in the DCR message.

In an embodiment, the integrity protection of the accept message is done by including a MIC computed using a KDF that takes as input the DUIK associated to the RSC and used in the DCR message.

In an embodiment, the integrity protection of the accept message is done by adding a digital signature computed with a private key owned by the second device and whose public key is (pre-) configured in the first device.

In an embodiment, the algorithm and/or keys to be used to protect the accept message is configured by a managing entity, e.g., the CN in a telecommunication system.

In an embodiment, the algorithm to be used to protect the accept message is determined based on the security capabilities associated to the remote UE and sent in the DCR message.

In an embodiment, the MIC of the accept message is computed by taking as input the whole or part of the received DCR message (e.g., RSC, MIC, PRUK ID, . . . ).

In an embodiment, the MIC of the accept message is computed by taking as input a time-based counter (e.g., UTC-based) or a nonce, e.g., received in the DCR message or determined at the time of sensing the accept message.

In an embodiment, the freshness of the accept message may be verified based on a nonce—implicit (e.g., MIC) or explicit (e.g-random value)—included in the DCR message or a UTC-based counter. An implicit nonce may be the MIC used in the DCR message.

In an embodiment, the MIC in the accept message is computed by—aking as input—for the MIC generation in th-accept message—the MIC of the received DCR message. The MIC of the DCR message is a “fingerprint” of the DCR message itself and it is also bound to a time value (I.e., its value changes with time) if the MIC is computed from a UTC-based counter. This approach has the advantage of binding DCR message and accept message, reducing CPU overhead sinc88etweenthe MIC is required as input, and providing both integrity and freshness protection.

In a related embodiment, the accept message is integrity protected and the failure message is sent also with integrity protection.

In an embodiment, the failure message is integrity protected, e.g., in a similar way as in above embodiments for the accept message.

In an embodiment, the U2N relay sends a failure message when the integrity verification of the DCR message sent by a remote UE fails.

In an embodiment the U2N relay has a policy/configuration so that the U2N may not send the reject message in the event that:
a second DCR message (a second “first message”) is received (e.g., from an attacker impersonating the remote UE) and
this second DCR message cannot be integrity verified
   If previously
a first DCR message (a first “first message”) was already received and
this first DCR message was successfully integrity verified.

In an embodiment the U2N relay has a policy/configuration so that the U2N may not send the reject message in the event that:
a second DCR message (a second “first message”) is received and
this second DCR message is successfully integrity verified
a first DCR message (a first “first message”) is/was also already received (e.g., from an attacker impersonating the remote UE) and
this first DCR message could not be integrity verified

In a related embodiment, the U2N relay has a policy/configuration to determine whether to send, or not, a reject message depending on the reception of one or more “first messages” where at least one of them is successfully verified.

In an embodiment related to the previous ones, the U2N relay may have a policy/configuration for sending a notification to the remote UE or a NF in the CN notifying about the event.

In a related embodiment, the U2N relay has a policy to prioritize a successfully verified “first message” regardless of whether it was the first or second “first message” (DCR message).

In a related embodiment, the U2N relay has a policy/configuration specifying that no reject message is to be sent if the time between the reception of the first DCR message (the first first message) and the second DCR message (the second first message) is less than a predefined time, e.g., T1 seconds.

This embodiment and the previous ones have the advantage of preventing an attacker from forcing the U2N relay to send a protected reject message by sending/replaying a manipulated DCR message (e.g., the same first DCR message with some errors) shortly after the remote UE has sent the DCR message.

In an embodiment, the U2N relay may have a configuration/policy determining that the U2N relay should not send the reject message, if the reject message cannot be integrity protected, e.g., in case that the U2N relay does not find a suitable integrity key to protect the reject message.

This has the advantage of reducing communication overhead, in particular, if the remote UE has a policy stating that unprotected reject messages should be rejected.

In an embodiment, the U2N relay may include an identifier in the reject or accept message allowing the remote UE to determine the key to be used for integrity verification. This identifier may be the RSC in the first message or a fingerprint of the first message. This field may also be used as input in the generation of the MIC.

This has the advantage of efficiently finding the correct integrity key.

In an embodiment, the U2N relay may not include an identifier in the reject or accept message.

This has the advantage of providing higher privacy when indicating the service that is rejected and comes at the cost of the remote UE having to perform blind search (trying multiple integrity keys).

In a related embodiment, the remote UE has a policy so that no reject message is accepted if no DCR message (no first message) had been previously sent in the last time (e.g., T2 seconds) and/or there is no ongoing related communication procedure that may expect a reject message.

This has the advantage of preventing an attacker from forcing the reception of a fake rejection message.

In a related embodiment, the remote UE expecting a protected reject message may have a policy determining that a reject message should be dropped/ignored if the remote UE does not have a suitable key to integrity verify the reject message. If the protected reject message does not include an identifier, such policy may allow/prevent the UE to/from performing blind search depending on e.g., the type of UE and/or time/computational constraints.

In a related embodiment, a mechanism to integrity protect a reject message (e.g., Direct Communication Reject message and Direct Security Mode Reject message) is described when a key such as DUIK is provisioned for discovery.

In this embodiment, if a first message cannot be integrity verified (e.g., a Direct Security Mode Command procedure fails), then the protection of the reject message (e.g., Direct Security Mode Reject message) is performed as follows.
The protection and/or sending of the reject message may be subject to a policy/configuration. For instance, it may be subject to one or more conditions so that the U2N relay may not protect and/or send the reject message if:
a previous first message (e.g., Direct Security Mode Command procedure) has succeeded including integrity verification;
the previous first message was received/successfully verified in the last T1 seconds;
there is an established communication;
. . .
   If the U2N integrity protects the reject message, the U2N relay does so by using the code-sending security parameters used for discovery.
1. If the UE is configured with DUIK, the integrity key KINT is set to DUIK. Otherwise, the Direct Communication Reject message is not integrity protected, and steps 2-3 are skipped.
2. Calculate Message Integrity Check (MIC) using KINT, UTC-based counter by means of a KDF as in above embodiments.
   As in the above embodiments, the procedure can benefit if the reject message includes an RSC or an identifier linked to the DUIK (or integrity key to use) so that the receiving party can determine the DUIK to use.
   As in the above embodiments, the procedure can benefit if the reject message includes (a fingerprint of) the first message whose verification failed so that the remote UE can link messages in case that multiple first messages are sent, and, e.g., better determine the cause the failure.
4. 3. Set the MIC IE to the calculated MIC.
   The U2N relay may have a configuration/policy determining that the U2N relay should not send the reject message if it cannot be integrity protected, and act accordingly.
   The 5G ProSe Remote UE, on receiving the reject message, verifies the integrity of the received reject message using the code-receiving security parameters used for discovery.
   If the integrity verification of the reject message fails, the remote UE may have a policy determining whether it should ignore the reject message or not.
   If the message is not integrity protected or it is considered to be not integrity protected because the remote UE lacks an integrity key, the remote UE may have a policy determining whether it should process the message or not, and act accordingly.
   The remote UE verifies the integrity of the received reject mese as follows:
5. 1. If the UE is configured with DUIK, the integrity key KINT is set to DUIK. Otherwise, the reject message is not integrity protected, and step 2 is skipped.
   As in the above embodiments, the procedure can benefit if the reject message includes an RSC or an identifier linked to the DUIK (or integrity key to use) so that the receiving party can determine the DUIK to use.
   As in the above embodiments, the procedure can benefit if the reject message includes (a fingerprint of) the first message whose verification failed so that the remote UE can link messages in case that multiple first messages are sent, and, e.g., better determine the cause of the failure.
2. Calculate a MIC using KINT, UTC-based counter and the received reject message by means of a KDF and compare the calculated MIC with the MIC included in the reject message. If they mismatch, the integrity check fails.
3. Compare whether the RSC and/or MIC in the previously sent Direct Communication Request message match the reject cause in the received Direct Communication Reject message. If they mismatch, the Direct Communication Reject message is rejected/ignored.

In an embodiment variant, the fingerprint included in the message may be the MIC computed by the relay UE that does not match the MIC included in the Direct Communication Message.

In an embodiment variant, the fingerprint may not be sent explicitly, but it may be implicit. For instance, the MIC in the reject message may be computed taking as input the received Direct Communication Message itself. Thu—, the remote UE—when receives th-reject message—computes the MIC itself using the Direct Communication Message that it had previously sent and the contents of the received reject message. If the MIC computed locally by the remote UE and the MIC in the received reject message do not match, then the remote UE is aware that the reject message was not addressed to the remote UE.

In an embodiment variant, the reject message may include multiple MICs, each computed with a different DUIK, each of them associated to a different RSC. This requires the (UE-to-Network) relay UE to compute multiple MICs and send them.

In an embodiment variant, the reject message may include a single MIC where the DUIK used to co92etweehe MIC is chosen according to a policy, e.g., the DUIK linked to the RSC in the last exchanged/matched discovery procedure.

In an embodiment variant, the remote UE tries out with multiple DUIKs associated to multiple RSCs. For instance, if the remote UE had tried to perform discovery with multiple RSCs associated to multiple keying materials, the remote UE may try to verify the reject message with all DUIKs used in the last X discovery messages or T seconds, whereby X and T may be configurable.

In an embodiment variant, the direct disclosure of the RSC for which the DUIK is used to protect the reject message may lead to a privacy issue. And thus, a pseudoidentifier of it may be used, e.g., some bits (e.g., of the MIC) of the discovery message previously used.

In an embodiment variant, if the remote UE receives a protected reject message including a fingerprint, if the MIC verification of the reject message fails but the fingerprint in the reject message matches (i.e., the reject message includes a fingerprint that matches the fingerprint of the DCR message the remote UE had sent), the remote UE may try to verify the reject message with other keys (DUIKs) associated to the RSCs configured in the remote UE. This is done to try to determine a common key between remote UE and relay UE. This has the advantage of allowing the remote UE to determine a common key. If a key is found that allows verifying the MIC, the remote UE may retry sending the DCR message protected with keys associated to that RSC if this RSC is admissible by the remote UE for the intended communication service the remote UE wants to access, or the remote UE may decide to redo the discovery process.

In an embodiment variant, the fingerprint in the reject message may be checked before the MIC verification is performed. This allows verifying whether the reject message is intended for the remote UE or not before performing any cryptographic operations, i.e., it is more efficient.

In an embodiment, the failure message is integrity protected with a key configured to protect failure messages only.

In an embodiment, the key intended to only protect failure messages is configured such that it is common for multiple sets of devices or discovery keying materials or DCR messages or RSCs.

The last embodiments have the advantage that the failure message may be protected and verified even if the specific integrity key used to verify the DCR message could not be used in a successful manner.

In an embodiment, the failure message includes the cause of the failure, e.g., RSC mismatch and/or MIC failure and/or other parameters that may allow to identify the failure cause (e.g., time, or key time validity (e.g., in case the U2N relay has identified that an old/expired key was used by the remote UE)). This has the advantage that the remote UE may then choose different parameters to send the DCR message and avoid the failure cause and/or trigger any other procedure (e.g., a request to renew/update the configured parameters such as keys).

In an embodiment, the remote UE contains a policy that determines its behavior when (1) no message is received upon sending the DCR message and/or (2) a failure message is received upon sending the DCR message and/or (3) an accept message is received upon sending the DCR message; and/or (4) both a failure and an accept message are received upon sending the DCR message.

In a related embodiment, the policy in the remote UE is configured by a managing entity, e.g., the CN in a telecommunication system, e.g., by a NF in the CN, e.g., the PKMF or DDNMF.

In a related embodiment, the policy determines that the remote UE should retry sending the DCR message a number of times if no message (no failure message and no accept message) is received before a timer expires.

In a related embodiment, the policy determines that the remote UE should stop retrying sending the DCR message if only the failure message is received. This may also indicate that the remote UE should search for a different U2N relay.

In a related embodiment, the policy determines that the remote UE should stop retrying sending the DCR message if the accept message is received and correctly verified, e.g., within a (configured) time window. The UE may then wait a given time (that may be specified in the policy) to receive further messages from the communication with, e.g., the U2N relay and/or the CN (e.g., authentication process) over the U2N relay.

In a related embodiment, the policy determines that the remote UE should stop retrying sending the DCR message if both the failure message and the accept message are received and the accept message is correctly verified. The UE should then wait (e.g., a configured time) to receive further messages, e.g., from the communication with the CN (e.g., authentication process) over the U2N relay. This has the advantage of letting the remote UE deal with both potential attacks (e.g., if an attacker misuses an unprotected failure message) and improve performance (by explicitly signaling that a message is properly verified by means of the accept message) by giving a higher priority/importance to the accept message over the failure message.

In a related embodiment, the policy may determine a timer during which the remote UE should not retry sending DCR messages if only unprotected failure messages are received (e.g., attacker misusing failure messages). If an accept message is received before the timer runs out and it is correctly verified, the accept message is prioritized.

In a related embodiment, the policy may determine a timer during which the remote UE should not retry trying to setup a communication with the U2N relay if only unprotected failure messages are received (e.g., attacker misusing failure messages). If an accept message is received before the timer runs out and it is correctly verified, the accept message is prioritized, e.g., communication can proceed ignoring the failure message.

In a related embodiment, the accept message may be an explicit message. In other words, it is a message sent with the main purpose of informing the remote UE that the integrity verification at the U2N relay was successful.

In a related embodiment variant, the accept message may be sent implicitly by means of another protected message Y. In other words, the accept message is implicitly included (or deemed to be received) if the UE receives the next step protected message. In other words, the accept message may be represented by means of a protected message Y sent by the U2N relay to the remote UE, where said protected message Y is sent for a given purpose, e.g., communicate certain parameters, perform authentication, etc. Such a message may be direct from the UE to Network relay to the remote UE or it may be sent over the U2N relay, e.g., when the UE to Network relay forwards a message to the remote UE originated in a third device (e.g., in the core network). In other words, the purpose of message Y is not only to inform the remote UE that the integrity verification at the U2N relay was successful. If the remote UE receives said message Y, the remote UE implicitly understands that the UE to Network relay was capable of verifying the DCR message. In the context of other embodiments, if a remote UE receives said protected message Y and an unprotected failure message, the remote UE may prioritize the processing of protected message Y and ignore the unprotected failure message according to a (pre-)configured or hardcoded policy.

In a related embodiment, the policy determines that the remote UE should send an attack notification message to the managing entity (e.g., CN in a telecommunication system) if both the failure message and the accept message are received and the accept message is correctly verified.

In an embodiment, the remote UE implements routines to verify the integrity and/or freshness of accept and/or failure messages that are the counterpart of above embodiments.

In an embodiment, the U2N relay implements routines to verify the integrity and/or freshness of accept and/or failure messages that are the counterpart of above embodiments.

In a related embodiment, the remote UE performs integrity verification by checking a MIC that has been computed by the relay UE as described above.

In some situations, an attacker may fake an unprotected failure message, e.g., with the goal of preventing a remote UE from connecting to the U2N relay. In telecommunication systems relying on a medium access control that is coordinated by the RAN, the RAN oversees performing resource allocation, e.g., by means of control messages. In the particular case of a remote UE and a U2N relay, a device connecting to the remote UE over sidelink may also perform local resource allocation, e.g., using a common resource pool. Thus, above issues may also be addressed by improving/monitoring how resource allocation is performed.

In an embodiment, the resource allocation for the transmission of the DCR message and the subsequent reply with a failure message or an accept message is performed simultaneously. This is advantageous because an attacker has less room to inject arbitrary messages.

In a related embodiment, the devices (remote UE and/or U2N relay and/or RAN and/or CN) monitor that resources are not allocated in an anomalous manner, e.g., by monitoring that no message is sent for the transmission of a message to the remote UE.

In a related embodiment, the devices might trigger an alarm in the case that resources are allocated in an anomalous manner where the alarm may be sent, e.g., to the CN or remote UE. The above embodiments may be implemented by means of a computer program executed in a remote UE or in a U2N relay.

### Identifying the Keys to Use to Decrypt/Integrity Verify the DCR Message

The fact that a UE relay may not be able to integrity verify a message such as a DCR message may be caused because the UE relay does not know which keys to use. Thus, in order to alleviate the problem of having a U2N (or UE to UE) relay that receives a message (e.g., a protected DCR message as in other embodiments) from a remote UE (or end UE), and after decrypting the RSC in the message, the relay cannot match the RSC (in general, integrity verify the message) to the one that is sent in the discovery message, the following embodiments are proposed that may be combined with other embodiments (e.g., sending a failure/reject message) and/or used independently, in particular, the relay UE may take one or more of the following actions:
match the decrypted RSC against an RSC, or list of RSCs, that is sent in one of the previous discovery messages (i.e., the decrypted RSC matches with an RSC that is sent in a discovery message), for instance, in the last X discovery messages where X may be configurable or in the discovery messages sent in the last T seconds where T may also be configurable, and/or
match the decrypted RSC against an RSC, or list of RSCs, that is sent/received in one of the previous discovery messages in the last t seconds where t may be configurable, and/or
match the decrypted RSC with any of the RSCs supported by the relay.
   Note that matching the decrypted RSC with an RSC that is sent in one of the previous discovery messages and/or supported by the relay may require decrypting the message multiple times, e.g., with the discovery keys associated to each of those RSCs. This embodiment may make the usage of a failure/reject message less necessary and/or frequent. And this may be advantageous.
   Note that in the following embodiments when a type of relay is mentioned, e.g., UE to Network relay, the embodiment may also be applicable to other types of relays.

In an embodiment variant, the end device (e.g., Remote UE) may signal in the direct communication request (DCR) an identifier (e.g., its Layer-2 ID), where the identifier may be tied to device (e.g., Layer-2 ID) and/or the RSC (e.g., least significant bits of MIC in a discovery message) used by the device during discovery, to the relay, e.g., the UE-to-Network Relay. The Remote UE may also include the identifier (e.g., Layer-2 ID) in the DCR message to enable the relay, e.g., U2N, to identify the RSC, and subsequently security keying materials to use for decryption, RSC matching, and integrity verification. In this embodiment variant and related embodiment variants below, the relay, e.g., UE-to-Network Relay, may need to keep track of the RSCs and identifiers used by remote UEs/end UEs in the discovery procedures so that when the DCR message including an identifier is received, the relay UE can check which RSC is to be used.

In an embodiment variant, a Remote UE may attempt PC5 security establishment for 5G ProSe UE-to-Network Relay communication over both the User Plane and the Control Plane, and the UE-to-Network supports both security procedures. The UE-to-Network Relay may match both RSCs indicating said security procedures, and thus, the remote UE may send a DCR message to initiate any of them. When the Remote UE sends the DCR message, including its Layer-2 ID, and one of the RSCs protected with the corresponding keying materials, the UE-to-Network Relay may select the wrong RSC, and subsequently the wrong security keying materials, thus leading to an RSC mismatch/integrity verification failure. To address this issue, the UE-to-Network Relay may perform blind decryption/verification on the received DCR message using the security keying materials associated to the RSCs which are in turn associated to the device identifier, in this case, Remote UE's Layer-2 ID, and that have been stored by the UE-to-Network relay.

In another embodiment that may be combined with the previous embodiments or used independently, the Layer-2 ID of a Remote UE may not be changed/updated during a PC5 link establishment procedure or between the discovery procedure and the direct link establishment procedure, so that previous embodiments can operate without issues.

In an embodiment variant, the User Info ID of the Remote-UE may play a similar role as the Layer-2 ID in previous embodiments i.e., the UE-to-Network Relay may perform blind decryption/verification of the received DCR message using security keying materials associated to the RSCs associated with the Remote UE's User Info ID.

In a related embodiment addressing above problem, how the U2N relay performs the matching is specified according to a policy (similar to other embodiments) that may be configurable, e.g., depending on the number of supported RSCs.

In a related embodiment addressing above problem, the policy (as in other embodiments) may further specify whether the U2N relay sends a failure message and/or an accept message, either protected or unprotected, either implicit or explicit, depending on how the RSC matching is performed.

In another related embodiment addressing above problem of having a UE (e.g., UE to network relay) that receives a message (e.g., a protected DCR message as in other embodiments) from a another UE, e.g., a remote UE, and after decrypting the RSC in the message, the U2N relay cannot match the RSC (in general, integrity verify the message) to the one that is sent in the discovery message, the 5G ProSe Remote UE and the 5G ProSe UE-to-Network may use part of a discovery message (e.g., the least significant bits (e.g., least significant k bits, where k is (pre-)configured by the network or indicated in the message) of the MIC exchanged in the last or matched discovery message, k bits of the scrambled message, or the encrypted RSC exchanged in the discovery message . . . ) to identify the discovery keying materials to use when protecting direct communication messages. For instance, if remote UE and UE to Network relay (similar procedure may be applicable to other relaying procedures) are engaged in two discovery procedures, e.g., associated to two different relay service codes, RSC1 and RSC2, wherein for each of the discovery procedures the remote and relay UEs exchange discovery messages according to model B, both UEs may store, e.g., the k=12 least significant bits of a field (e.g., MIC, or encrypted RSC, . . . ) in the second discovery message in model B for both discovery procedures associated to RSC1 and RSC2. In the first discovery procedure the MIC may be 0xABCD and in the second discovery procedure the MIC may be 0x12EF, then both UEs may keep a table:

RSC1, 0xBCD
RSC2, 0x2EF

If then the remote UE decides to send the direct discovery request (DCR) message associated to RSC1, remote UE will protect the DCR message with the discovery keys associated to RSC1. To indicate this in a privacy-sensitive manner, the message includes the identifier IDX 0xBCD in the message, in the clear. The relay UE can then receive the message, extract the identifier IDX, and use this identifier IDX to look up the table to determine which RSC it is related to (in this example, RSC1), and retrieve the corresponding keys, e.g., DUCK, DUIK, DUSK associated to RSC1, that allow the correct processing of the message. This approach is also applicable when two different remote UEs are performing two discovery procedures in parallel with a same relay UE. This approach is also applicable when a Source End UE performs two discovery procedures in parallel, using RSCs supporting two security procedures (with and without network assistance), with the same UE-to-UE Relay. This approach allows linking in a privacy sensitive manner the keys used in the discovery phase with the keys used to protect subsequent messages (e.g., DCR message, reject message) before the PC5 security context is established.
Note that when this is done, it may not not required to include the RSC in the DCR message, because the the new included identifier already identifies it, even if it may make sense in some cases (e.g., when the DCR message is not integrity protected) to check that the decrypted RSC matched the RSC linked to IDX.

In another related embodiment, the indication on the security keys used may also be exchanged in other messages and computed in a different way. For instance, the indication or key identifier may be included in the failure message. For instance, the indication may be computed as the least significant bits of the output of the key derivation function with input the used key (e.g., the used DUIK) and a time counter.

In a Remote-UE to UE-to-Network Relay PC5 link establishment scenario, CT1 LS C1-234362 describes an issue, wherein the UE-to-Network relay is required to retrieve the security keying materials to decrypt and verify the PRUK-ID and RSC. However, the security keying materials are associated with the RSC, which is sent encrypted in the DCR message. As a result, the UE-to-Network Relay cannot identify which RSC is used, and subsequently which security keying materials to use to process (e.g., decrypt, integrity verify) the received DCR message. This problem is similar to the one discussed in previous embodiments. To address this issue, a potential approaches may be as follows: during the Discovery Request procedures, the 5G DDNMF in the HPLMN of the Announcing-UE (In Model A)/Discoveree-UE (In Model B) returns to the Announcing-UE/Discoveree-UE, in step 4 of FIGS. 6.1.3.2.2.1-1 and 6.1.3.2.2.2-1, a key identifier that is associated with the discovery security materials. The key identifier is also communicated to the HPLMN of the Monitoring-UE/Discoverer-UE (in step 9) and through the Relay Discovery Key Response, corresponding to steps 10, and 11 of the aforementioned figures, respectively, the Monitoring-UE/Discoverer-UE obtains the the discovery security materials and their identifier. It is then proposed to include the key identifier in plaintext in the DCR message, to identify the security keying materials used to protect said DCR message. The key identifier may also be included in the discovery messages exchanged during the discovery phase. The usage of a key identifier has already been discussed in previous embodiments. However, this approach may jeopardize the privacy of UEs, especially if the discovery security materials are reused. Since the key identifiers are fixed and are communicated in clear text, an eavesdropper can recognize when a certain set of security materials is used and by which UEs binding them to the RSC. Furthermore, if the key identifier is exchanged also during the discovery phase, it may serve as an equivalent to the RSC and thus, if it is exchanged unprotected, it would impact the privacy of End UEs/users. To address these concerns, the following embodiments are considered wherein these embodiments may be applicable to UE-to-Network relays but also to UE-to-UE relays:

In an embodiment variant, the key identifier associated with the discovery security materials may be rotated based on a condition (e.g., time, one-time-use) that is configurable by the network. For instance, the key identifier(s) may be updated/rotated every hour thus ensuring that the key identifiers are dynamic.

In an embodiment variant, the Remote UE may include the whole key identifier or only a part of it (e.g., b LSBs/MSBs) in the DCR message, whereas, in the latter case, the UE-to-Network Relay may communicate e.g., the b MSBs/LSBs corresponding to the same key identifier when responding to the Remote UE. These MSB/LSB identifiers may be included, e.g., in the DCR message and in the reject messages.

In another embodiment variant similar to others described above and that may be combined with the previous embodiment, the key identifier may be computed based on the discovery security materials and a UTC-based counter that are fed as input to a KDF, whereby the last b bits of the KDF output are taken as a key identifier which remains valid for e.g., an hour, or until it is used.

In another embodiment, the network (e.g., PKMF, DDNMF, . . . ) may compute and allocate a list of pseudoIDs to the UEs (e.g., Remote and UE-to-Network Relay UEs) based on the provisioned discovery security materials and time periods, such that each pseudoID is valid during a particular time period. This list of pseudoIDs may be computed as described in the previous embodiment, or at random.

In a related embodiment that may be combined with other embodiments or used independently, UEs (e.g., Remote-UE and UE-to-Network Relay) which are provisioned with a list of pseudoIDs may select the key pseudoID to use (e.g., include in the DCR message) based on their current timestamp, whereby the timestamp falls within a time range for which a pseudoID corresponds.

In another embodiment variant, a list of pseudoIDs may be computed and stored by the UEs (e.g., Remote UE and UE-to-Network Relay) upon being provisioned with the discovery security materials, wherein the b LSBs of the UTC-based counter may be set to zero, such that small time differences do not result in different pseudoIDs at UEs (Remote UE and UE-to-Network Relay) ends.

In another embodiment variant, the UEs (e.g., Remote UE and UE-to-Network relay, or UE-to-UE relay) may try with adjacent/close/subsequent pseudoIDs to avoid rejecting a message because of time synchronization issues.

In another embodiment, where the pseudoID associated with the discovery security materials is updated/changed during the direct communication phase, a UE-to-Network Relay may not match the pseudoID communicated in the DCR message with the updated pseudoID. In this case, the UE-to-Network Relay may try to match the received pseudoID against the (previously valid) pseudoID corresponding to the previous time period.

In another embodiment variant similar to another embodiment variant above, it is important to keep a list of matched/authorized RSCs and/or key identifiers during an initial discovery phase so that only DCR messages including a key identifier in the list or bound to one of the matched/authorized RSCs in the list are authorized as well. To this end, as illustrated in previous embodiments, a relay UE (e.g., UE-to-Network relay) may keep track (by means of a list) of the RSCs matched in the last k discovery messages or in the last T seconds where k and T may be configurable. When the relay UE receives a DCR message with a key identifier, the relay UE may check whether the key identifier corresponds to any of the RSCs that are stored in the list. The UE relay may only allow DCR messages including a key identifier/RSC in said list. This is advantageous because it allows performing potential authorization checks only in the discovery procedure.

In an embodiment, the key identifier (e.g., a fix key identifier that may have been configured by the network and the key identifier is bound to an RSC and discovery keying materials) used in the DCR message may be scrambled with a pseudorandom sequence, e.g., preconfigured or generated from a key, e.g., with the DUSK in the discovery keying materials. The UE relay may descramble the message where the descrambling operation may be done blindly, I.e., by trying the scrambling keys that the UE has and generating the pseudorandom sequences. If the key identifier matches the key identifier bound to the RSC/discovery keying materials/DUSK used for descrambling, then the UE knows that the key identifier is the correct one and can further process the security of the DCR message, I.e., decrypt and integrity verify the DCR message. This embodiment variant may require that blind descrambling is done. Blind descrambling may be improved, e.g., by only trying descrambling with keys that are used in previously matched discovery messages as in other messages. Scrambling may be done by using a pseudorandom sequence that changes with low frequency, e.g., once per hour. Scrambled key identifier can be computed as XOR (key identifier, TRUNC (KDF(K, UTC-based counter),b)) where XOR(a,b) returns the bitwise xor of a and b, TRUNC(a,b) returns b bits of a, and KDF(K, a) returns the key derivation function of a. The recovery of the key identifier is done by means of the inverse operation, I.e., XORing the scrambled key identifier with TRUNC(KDF(K, UTC-based counter),b).

Thus, in accordance with this embodiment, it is proposed a method comprising a UE relay receiving a key identifier in a DCR message, said key being scrambled by a pseudo random sequence, the UE relay unscrambling the key identifier, and upon determining that the unscrambled key identifier matches the key identifier of the key used for descrambling, the UE relay further processing the DCR message security.

In a general de102etween102n of this invention, it is proposed a method by which a discovery security material identifier is bound to a list of authorized Relay Service Code that is stored by a second device, wherein the authorized Relay Service Codes stored in the list match the Relay Service Codes used in the previous discovery phases, and/or were exchanged/used during a time window, whereby the number of discovery phases or time window is configurable.

In a general definition, it is proposed a method by which a first device signals to a second device, by means of an identifier, which discovery security materials to use to process a DCR or reject/failure message, wherein, the identifier is updated periodically/dynamically and/or based on a pre-configured condition and/or with a pseudorandom sequence, whereby said identifiers and/or input to compute the identifiers and/or pseudorandom sequence are determined by themselves (e.g., in a previous communication phase) or allocated to the first and second devices by a network entity and are stored by the devices themselves.

The above embodiments may represent methods to allow for secure and reliable communication in a telecommunication network.

The above embodiments may represent an apparatus—that can be implemented in the first device (—g., remote UE)—to enable secure and efficient operation when connecting to a second device (e.g., relay UE).

The above embodiments may represent an apparatus—that can be implemented in the second device—g., relay UE)—to enable secure and efficient operation when providing connectivity to a first device (e.g., remote UE).

In general, the different embodiments presented in this description can be combined one with another.

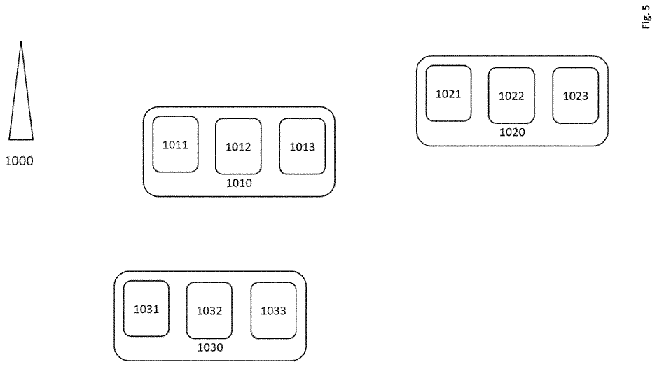

As explained throughout the previous embodiments, the proposed variants of the invention can be implemented in a network, for example a cellular network as a 5G network, shown on FIG. 5. A cell of the network is served by a primary station 1000. Under the coverage of the primary station 1000 (e.g. a gNB), a plurality of secondary stations can connect to the primary station. Some secondary station may be adapted to operate as relay stations 1010. Such a relay station may comprise a transmitter 1011, coupled with a transmit antenna, a receiver 1012 coupled with a receive antenna. Typically, the receive and transmit antenna are the same antenna. Further, depending on the technology, the antenna may be formed by an antenna array which may allow different transmission/reception modes, such as MIMO, transmit diversity, and operation on different sets of frequencies.

A controller 1013, for example a CPU or microcontroller (such as a microprocessor dedicated for the communication (baseband processor) or a main microprocessor of the device including the UE) operating with a software stored on an internal memory (e.g. ROM, EEPROM, SSD) is adapted to control the transmitter and the receiver and control the antennas. It is to be noted that some or all of the transmitter, the receiver and the controller may be part of a single baseband processor. In connection with the above described embodiments, the controller is adapted to establish a connection between the relay station 1010 and the primary station 1000. More specifically, the controller 1013 can configure the receiver 1012 for receiving in at least one first secure message from the primary station 1000 a first set of configuration parameters including attributes or service codes

The controller 1013 can control the transmitter 1011 and cause it to transmit at least one transmitted attribute or service code from the first set of configuration parameters. This attribute or service code can be broadcast for reception by other stations, for example like secondary station 1020 or 1030.

Typically, the relay station may be a UE, like a Sidelink compatible UE, which thus can behave as a relay station when configured to. Alternatively, the relay station may also be another primary station, like an Access Point, or a gNB or a femtocell gNB.

The secondary station 1020 (or similarly 1030) may typically be a UE, and comprises a transmitter 1021, a receiver 1022, both typically coupled to one or more antennas or antenna array. Further, the secondary station 1020 includes a controller 1023 which is adapted to control the receiver 1021, the transmitter 1022 and possibly other elements of the UEs. As for the relay station, the controller 1023 may be a processor or a CPU, and may operate thanks to a software.

The controller 1023 is able to cause the receiver 1021 and the transmitter 1022 to establish a connection with the primary station 1000. This includes for example configuring the receiver 1021 for receiving from the primary station 1000 in at least one second secure message a second set of configuration parameters including attributes or relay service codes linked to an upcoming data exchange with the relay station 1010.

The receiver 1021 may be adapted for receiving at least one transmitted attribute or service code from the relay station 1010 and the controller may be configured for determining whether the transmitted attribute or service code is included in the second set of configuration parameters or fulfil a policy in it and causing the transmitter to establish a direct communication with the relay station 1010 upon determination that the transmitted service code is included in the second set.

The secondary stations 1020 and 1030 may also be able to communicate with each other by means of relay station 1010.

A single unit or device may fulfill the functions of several items recited in the claims. The mere fact that certain measures are recited in mutually different dependent claims does not indicate that a combination of these measures cannot be used to advantage.

The described operations like those indicated in the different figures, e.g., FIG. 3 and FIG. 4, can be implemented as program code by means of a computer program and/or as dedicated hardware of the related communication device or access device, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

The above embodiments may also be applicable to multi-hop PC5 communication link establishment, wherein relays (e.g., UE-to-UE Relays) may forward/relay discovery and/or communication messages between End UEs and/or between an End-UE (Remote-UE) and the Network, taking into consideration the changes required to be implemented to adapt the inventive procedures to a multi-hop link. For instance, the checks performed to verify e.g., the validity of an end-to-end protected direct discovery set that is relayed over multiple relays is performed at each UE-to-UE Relay that the discovery message is relayed through, and where deemed invalid by a k\hat{ }th UE-to-UE Relay, the discovery message is dropped by said UE-to-UE Relay. For instance, in a UE-to-Network relay scenario with relays between a Remote UE and the UE-to-Network Relay, if an RSC mismatch or the integrity verification of the message fails at o104etweenthe relays between Remote UE and the UE-to-Network Relay, a reject message is sent back through to the Remote UE through the relays used to establish the link. For instance, to ensure the path (i.e., list of UE-to-UE Relays used to establish the link) is preserved, each relay may store an identifier of the relay from which the message was received, and the relay to which the message was relayed. For instance, a relay_indication_counter may be added to the discovery/communicated message, whereby the counter is updated (e.g., incremented) every time the message is relayed, and where a max_limit, which may be configured by the network and/or a Source-UE (e.g., Announcing/Discoverer/Remote UE) is reached before the discovery/communication message reaches the destination UE (e.g., Target End UE/UE-to-Network Relay), the message may be dropped. For instance, in a UE-to-relays-to-Network scenario, the protection of the DCR message may be adapted to account for the multitude of the RSCs that could be used between the several relay UEs, whilst the Remote UE identifier (I.e., PRUK-ID/SUCI) which remains as is may for instance be protected end-to-end between the Remote UE and the U2N Relay or is protected using the hop-by-hop security keys associated with the different RSCs used between the relay-UEs.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.

1. An apparatus comprising:
a processor circuit and a memory circuit, wherein the memory is arranged to store instructions for the processor circuit,
wherein the processor circuit is arranged to receive a second discovery protected message from a first device,
wherein the second discovery protected message is protected with a second set of keys,
wherein the second discovery protected message comprises a first discovery message,
wherein the first discovery message is end-to-end protected with a first set of keys according to a policy or a configuration,
wherein the processor circuit is arranged to undo the protection of the second discovery protected message,
wherein the processor circuit is arranged to verify the integrity and freshness of the second discovery protected message with the second set of keys,
wherein the processor circuit is arranged to extract a first protected discovery messages according to the policy or the configuration,
wherein the processor circuit is arranged to construct a third discovery message,
wherein the third discovery message comprises the first discovery protected message,
wherein the processor circuit is arranged to protect the third discovery message using a third set of keys into a third discovery protected message according to the policy or the configuration,
wherein the processor circuit is arranged to transmit the third discovery protected message to a third device.

2. The apparatus of claim 1,
wherein the first discovery protected message and the second discovery protected message are associated to or comprises include a first timing value and a second timing value,
wherein the first timing value and the second timing value are determined by the policy or the configuration,
wherein the first timing value has lower resolution than the second timing value.

3. The apparatus of claim 1,
wherein the first discovery protected message is stored together with a validity time,
wherein the validity time is determined from a timing value, or the number of bits of a timing value, or the accuracy of the timing value, or the index of the most significant bit of the timing value, or as two to the power of a value computed as the index of the most significant bit of the timing value minus one, or the time that remains until the timing value cannot be used to correctly reconstruct a Coordinated Universal Time Counter used to verify a Message Integrity Code MIC, unscramble, or decrypt,
wherein the timing value is comprises included in the first discovery protected message or the second discovery protected message.

4. The apparatus of claim 1,
wherein the first discovery protected message and the second discovery protected messages comprises a Message Integrity Code,
wherein each Message Integrity Code computed according to Clause 6.1.3.2.3 in TS 33.503.

5. The apparatus of claim 1, wherein the policy or the configuration determines that the first protected message is not scrambled.

6. The apparatus of claim 1,
wherein the policy or the configuration determines that the first protected message is scrambled by setting b least significant bits of the Coordinated Universal Time Counter to zero,
wherein b is greater than four,
wherein b is sufficient to ensure that the message can be descrambled if the first protected message is cached for a time greater than two to the power of b seconds.

7. The apparatus of claim 1, wherein the policy or the configuration determines whether the first discovery message and or second discovery protected message or third discovery protected message is encrypted or scrambled or integrity protected or not.

8. The apparatus of claim 1,
wherein a first discovery protected message received or stored by the apparatus is comprises a third discovery protected message if the first discovery protected message is valid,
wherein validity depends on the validity time of the first discovery protected message and at least one of:
the time of constructing the third discovery message;
the time of protecting the third discovery message; and
the time of transmitting the third discovery protected message.

9. The apparatus of claim 1, wherein the condition to transmit the third discovery protected message is based on at least one of:
a time period;
a maximum number of first discovery protected messages comprising the third discovery protected message; and
a first discovery protected message whose validity time is about to expire.

10. The apparatus of claim 1, wherein a first discovery protected message's validity time is determined by the Coordinated Universal Time Counter-based timer, or a set of LSBs of the Coordinated Universal Time Counter-based timer, or the number of bits of a timing value or the accuracy of the timing value or the index of the most significant bit of the timing value that is associated with the first discovery protected message.

11. The apparatus of claim 1, wherein the security operations performed to protect the third discovery message are confidentiality protection, then integrity protection, and then scrambling.

12. The apparatus of a claim 1, wherein the third discovery protected message comprises at least one of:
an indication of the number of first discovery protected messages; and
an identifier of the device to which each first discovery protected message is addressed.

13. The apparatus of claim 1, wherein the processor circuit is arranged to extract a first protected discovery message from the second discovery protected message by reassembling and duplicating redundant message fields contained in the second discovery protected message.

14. The apparatus of claim 1, wherein the the sets of keys and/or the policy or configuration are arranged by a network function in a network.

15. The apparatus of claim 1, wherein the policy or parts of the policy may be hardcoded in the apparatus.

16. (canceled)

17. A method comprising:
receiving a second discovery protected message from a first device protected,
wherein the second discovery protected message is with a second set of keys,
wherein the second discovery protected message comprises including a first discovery message,
wherein the first discovery message is end-to-end protected with a first set of keys according to a policy or a configuration;
undoing the protection of the second discovery protected message;
verifying the integrity and freshness of the received second discovery protected messages with a second set of keys,
extracting the first discovery protected messages according to the policy or the configuration;
constructing a third discovery protected message, wherein the third discovery message comprises the first discovery protected messages;
protecting the third discovery message using a third set of keys into a third discovery protected message according to the policy or the configuration; and
transmitting the third discovery protected message to a third device.

18. An apparatus comprising:
a processor circuit and a memory circuit, wherein the memory is arranged to store instructions for the processor circuit,
wherein the processor circuit is arranged to construct a Direct Communication Request message,
wherein the Direct Communication Request message comprises integrated discovery,
wherein the Direct Communication Request message comprises an indication determining whether the message is protected,
wherein the processor circuit is arranged to protect the Direct Communication Request message with a second set of keys if the indication is enabled,
wherein the processor circuit is arranged to broadcast the Direct Communication Request message.

19. The apparatus of claim 18,
wherein the second set of keys is used to confidentiality protect privacy sensitive information,
wherein the second set of keys is used to integrity protect the Direct Communication Request message when network assistance is used for secure link establishment as indicated by a Relay Service Code,
wherein the Direct Communication Request message comprises the Relay Service Code.

20. The apparatus of claim 19,
wherein the Direct Communication Request message is protected using two sets of security materials,
wherein end-to-end sensitive information are confidentiality and integrity protected with a first set of keys, if the Direct Communication Request message comprises an User Inform ID.

21. (canceled)

22. An apparatus comprising:
a processor circuit and a memory circuit, wherein the memory is arranged to store instructions for the processor circuit,
wherein the processor circuit is arranged to receive a Direct Communication Request message,
wherein the Direct Communication Request message comprises integrated discovery,
wherein the Direct Communication Request message comprises a protection indication from a first device,
wherein the processor circuit is arranged to undo the protection if the protection indication is enabled,
wherein the processor circuit is arranged to verify the integrity and freshness of the Direct Communication Request DCR message if the protection indication is enabled,
wherein the processor circuit is arranged to construct a new Direct Communication Request message from the Direct Communication Request message,
wherein the Direct Communication Request message comprises integrated discovery,
wherein the Direct Communication Request message comprises the protection indication,
wherein the processor circuit is arranged to protect the new Direct Communication Request message with at least one set of keys, if the indication is enabled,
wherein the processor circuit is arranged to broadcast the protected new Direct Communication Request message with integrated discovery to a third device.

23. The apparatus of claim 22, wherein the processor circuit is arranged to identify the protection indication by the usage of a security mechanism to establish a PC5 communication link relying on network assistance,

24. The apparatus of claim 22,
wherein the processor circuit is arranged to construct a new Direct Communication Request message if the protection indication is enabled,
wherein new the Direct Communication Request message comprises integrated discovery,
the new Direct Communication Request message does not comprise a Prose Remote User Key Identification field,
wherein the Relay Service Code is protected by XORing the Relay Service Code with the output of a key derivation function whose output is truncated to the length of the Relay Service Code.

25. The apparatus of claim 22,
wherein the received Direct Communication Request message is protected with a first set of keys and a second sets of keys,
wherein the processor circuit is arranged to undo protection,
wherein the processor circuit is arranged to verify the integrity and freshness of the Direct Communication Request message using a second set of keys,
wherein the second set of keys is associated to a first Relay Service Code, and
wherein the processor circuit is arranged to construct a new Direct Communication Request message,
wherein new the Direct Communication Request message comprises integrated discovery,
wherein new the Direct Communication Request message comprises end-to-end protected information,
wherein the end-to-end protected information is protected with a first set of keys, and
wherein the processor circuit is arranged to protect the new Direct Communication Request message with a third set of keys,
wherein the third set of keys is associated to a second Relay Service Code, and
wherein the processor circuit is arranged to broadcast the protected new Direct Communication Request message to a third device.

26. (canceled)

27. An apparatus comprising:
a processor circuit and a memory circuit, wherein the memory is arranged to store instructions for the processor circuit,
wherein the processor circuit is arranged to receive at least one Direct Communication Request messages,
wherein the at least one Direct Communication Request messages comprises integrated discovery,
wherein the at least one Direct Communication Request messages comprises a protection indication from a second device, and
wherein the processor circuit is arranged to undo the protection,
wherein the processor circuit is arranged to perform integrity and freshness verification of the at least one Direct Communication Request messages, with integrated discovery, if the protection indication is enabled.

28. The apparatus of claim 27,
wherein the processor circuit is arranged to perform path selection to select the device to respond to based on a policy,
wherein the processor circuit is arranged to construct a direct communication message based on a policy,
wherein the processor circuit is arranged to protect the direct communication message with at least one set of keys based on a policy if the protection indication is enabled,
wherein the processor circuit is arranged to transmit the protected direct communication message to the device selected in the first step based on a policy.

29. The apparatus of claim 28, wherein, the policy prioritizes at least one of:
a direct communication link with a Source End UE,
a communication link,
wherein the communication links comprises a relay device,
wherein the communication links has a security context established,
a communication link,
wherein the communication link comprises a relay device,
wherein the communication link has the security context is to be established.

30. The apparatus of claim 28, wherein the direct communication message comprises a protected Prose Remote User Key Identification.

31. The apparatus of claim 27,
wherein an indication is checked to determine whether the Direct Communication Request message is protected,
wherein the indication is the Relay Service Code or a security indicator associated to the Relay Service Code, or the presence of a Prose Remote User Key Identification field, or the message length.

32. The apparatus of any of claims 27-31,
wherein the processor circuit is arranged to undo protection of the Direct Communication Request message if the protection indication is enabled,
wherein the processor circuit is arranged to verifies its integrity and freshness,
wherein the processor circuit is arranged to verify whether the Relay Service Code is bound to a security procedure with network assistance.

33. The apparatus of claim 27, wherein the processor circuit is arranged to:
check the Prose Remote User Key Identification it against a predefined value if the protection indication is enabled, and a Prose Remote User Key Identification field comprises the Direct Communication Request DCR message,
ignore the Prose Remote User Key Identification if the Prose Remote User Key Identification matches a predefined value if the protection indication is enabled, and a Prose Remote User Key Identification field comprises the Direct Communication Request DCR message,
an alarm if the Prose Remote User Key Identification does not match a predefined value if the protection indication is enabled, and a Prose Remote User Key Identification field comprises the Direct Communication Request DCR message.

34. The apparatus of claim 27,
wherein at least one of the Direct Communication Request messages are protected with two sets of security materials,
wherein a second set of keys is used to undo protection,
wherein the second set of keys is used to verify the integrity and freshness of the Direct Communication Request message,
wherein the second set of keys is associated to an Relay Service Code,
wherein a first set of keys is used to undo the protection,
wherein the first set of keys is used to verify the integrity and freshness of the end-to-end protected information.

35. The apparatus of claim 34,
wherein, the processing of end-to-end protected information is prioritized to determine whether the Direct Communication Request message is intended for the recipient
wherein the end-to-end information is not confidentiality protected by the second set of keys.

36. (canceled)

37. An apparatus comprising:
a processor circuit and a memory circuit, wherein the memory is arranged to store instructions for the processor circuit,
wherein the processor circuit is arranged to send a first message to connect to a second device,
wherein the first message comprises a Message Integrity Code or an encrypted identifier and/or a key identifier; and
wherein the processor circuit is arranged to receive a failure message when the integrity verification or the Relay Service Code integrity check fails at the second device and/or receive an accept message when the integrity verification succeeds at the second device.

38. The apparatus of claim 37, wherein the processor circuit is arranged to change behavior based on the reception of no message and/or a failure message, or an accept message or a failure and an accept message.

39. The apparatus of claim 37,
wherein the processor circuit is arranged to receive a failure message,
wherein the failure message comprises a failure cause,
wherein the processor circuit acts based on the received failure cause.

40. The apparatus of claim 37, wherein the processor circuit is arranged to wait for further communication from the second device when the processor circuit receives both a failure message and an accept message and the integrity verification of the accept message succeeds.

41. The apparatus of claim 37, wherein the processor circuit is arranged to verify the integrity and/or freshness of the accept and/or failure message by:
checking that a fingerprint is present and matches the fingerprint of a previously sent message; and/or
a Message Integrity Code in the accept and/or failure message is computed correctly taking as input at least a fingerprint or value from the first message, a Coordinated Universal Time Counter, or an identifier used to identify the integrity key,
wherein the integrity key is a Discovery User Integrity Key associated to the identifier,
wherein the algorithm used to compute the Message Integrity Code is a New Radio Integrity Algorithm algorithm or a Key Derivation Function based Message Integrity Code derivation algorithm.

42. The apparatus of claim 37, wherein the processor circuit is arranged to ignore the reject message if no first message has been sent.

43. (canceled)

44. A method comprising:
sending a first message to connect to a second device, wherein the first message comprises a Message Integrity Code or an encrypted identifier; and
receiving a failure message when the integrity verification fails at the second device and/or an accept message when the integrity verification succeeds at the second device.

45. The method in claim 44, changing behavior based on the reception of no message and/or a failure message, or an accept message or a failure and an accept message.

46. An apparatus comprising:
a processor circuit and a memory circuit, wherein the memory is arranged to store instructions for the processor circuit,
wherein the processor circuit is arranged to receive a first message to provide connectivity to a first device,
wherein the processor circuit is arranged to verify the integrity of the first message by checking a Message Integrity Code and/or an encrypted identifier using an integrity key,
wherein the integrity is used in a previous discovery procedure or is bound to one of the configured Relay Service Code in the apparatus or is bound to a previously exchanged message identified by a key identifier or is bound to a key identifier included in the message,
wherein the processor circuit is arranged to ignore the first message when the Message Integrity Code verification fails, and/or reply with a failure message when the integrity verification succeeds but the Relay Service Code fails, and/or reply with an accept message when the integrity verification succeeds, or verify the integrity of the first message by checking a Message Integrity Code or an encrypted identifier using an integrity key bound to one of the configured Relay Service Codes in the apparatus or bound to a previously exchanged message identified by a key identifier,
wherein the processor circuit is arranged to ignore the first message if the integrity verification fails.

47. The apparatus of claim 46,
wherein the accept and/or failure message comprises a fingerprint from the first message and/or a Message Integrity Code, a Coordinated Universal Time Counter or an identifier used to identify the integrity key,
wherein the Message Integrity Code is computed based on a fingerprint or value from the first message,
wherein the integrity key is a Discovery User Integrity Key associated to the identifier,
wherein the algorithm used to compute the Message Integrity Code is a New Radio Integrity Algorithm algorithm or a Key Derivation Function based Message Integrity Code derivation algorithm.

48. The apparatus of claim 46, wherein the processor circuit is arranged to not send a failure message if a previously received first message had been successfully verified, and/or no integrity key can be determined to integrity protect the failure message.

49. (canceled)

50. A method comprising:
receiving a first message to provide connectivity to a first device, wherein the first message comprises a Message Integrity Code and/or encrypted identifier; and
verifying the integrity of the first message by checking the Message Integrity Code and/or the encrypted identifier; and
replying with a failure message when the integrity verification of the encrypted identifier fails and/or an accept message when the integrity verification succeeds.

51. (canceled)

52. A method comprising:
receiving at least one Direct Communication Request messages,
wherein new the Direct Communication Request message comprises integrated discovery,
wherein new the Direct Communication Request message comprises a protection indication from a second device;
undoing the protection; and
performing integrity and freshness verification of the received Direct Communication Request messages if the protection indication is enabled.

53. A method comprising:
receiving a Direct Communication Request message,
wherein new the Direct Communication Request message comprises integrated discovery,
wherein new the Direct Communication Request message comprises a protection indication from a first device;
undoing the protection, and verifying the integrity and freshness of the Direct Communication Request message if the protection indication is enabled;
constructing a new Direct Communication Request message wherein new the Direct Communication Request message comprises from the Direct Communication Request message,
wherein the Direct Communication Request message comprises integrated discovery,
wherein the Direct Communication Request message comprises the protection indication;
protecting the new Direct Communication Request message with at least one set of keys, if the indication is enabled; and
broadcasting the protected new Direct Communication Request message to a third device.

54. A method comprising:
constructing a Direct Communication Request message,
wherein new the Direct Communication Request message comprises integrated discovery,
wherein new the Direct Communication Request message comprises an indication determining whether the message is protected;
protecting the Direct Communication Request message with at least a second set of keys if the indication is enabled; and
broadcasting the Direct Communication Request message.

55. The apparatus of claim 1, wherein the third discovery protected message is equal to the second discovery protected message.

56. The apparatus of claim 22,
wherein the processor circuit is arranged to construct a new Direct Communication Request message if the protection indication is enabled,
wherein new the Direct Communication Request message comprises integrated discovery,
wherein new the Direct Communication Request message comprises a Prose Remote User Key Identification field set to a pre-defined or random value,
wherein the Relay Service Code RSC is protected by XORing the Relay Service Code RSC with the output of a key derivation function whose output is truncated to the length of the Relay Service Code.

57. The apparatus of claim 22,
wherein the processor circuit is arranged to construct a new Direct Communication Request message if the protection indication is enabled,
wherein new the Direct Communication Request message comprises integrated discovery,
wherein new the Direct Communication Request message comprises a Prose Remote User Key Identification field set to a pre-defined or random value,
wherein the Prose Remote User Key Identification and Relay Service Code are protected by XORing the Prose Remote User Key Identification and Relay Service Code with the output of a key derivation function whose output is truncated to the length of the Prose Remote User Key Identification and Relay Service Code.

58. A computer program stored on a non-transitory medium, wherein the computer program when executed on a processor performs the method as claimed in claim 17.

59. A computer program stored on a non-transitory medium, wherein the computer program when executed on a processor performs the method as claimed in claim 44.

60. A computer program stored on a non-transitory medium, wherein the computer program when executed on a processor performs the method as claimed in claim 50.

61. A computer program stored on a non-transitory medium, wherein the computer program when executed on a processor performs the method as claimed in claim 52.

62. A computer program stored on a non-transitory medium, wherein the computer program when executed on a processor performs the method as claimed in claim 53.

63. A computer program stored on a non-transitory medium, wherein the computer program when executed on a processor performs the method as claimed in claim 52.
